(19) United States
(12) Patent Application Publication
(10) Pub. No.: US 2026/0370998 A1
(43) Pub. Date: Nov. 19, 2026

(54) OPEN-EAR HEADPHONES

(71) Applicant: SHENZHEN SHOKZ CO., LTD., Shenzhen (CN)

(72) Inventors: Lei ZHANG, Shenzhen (CN); Wenbing ZHOU, Shenzhen (CN); Burui GUO, Shenzhen (CN); Zhiqing LIU CHUN, Shenzhen (CN); Xin QI, Shenzhen (CN)

(73) Assignee: SHENZHEN SHOKZ CO., LTD., Shenzhen (CN)

(21) Appl. No.: 19/721,017

(22) Filed: Jun. 26, 2026

Related U.S. Application Data
(63) Continuation of application No. PCT/CN2025/095587, filed on May 16, 2025.

(30) Foreign Application Priority Data
Jul. 17, 2024 (CN) 202410966001.5

(51) Int. Cl. H04R 1/10; H04R 1/28; H04R 9/02; H04R 9/06

(52) U.S. Cl. CPC H04R 1/1083; H04R 1/1016; H04R 1/105; H04R 1/288; H04R 9/025; H04R 9/06; H04R 2460/01

(57) ABSTRACT

An open earphone, comprising a sound generation portion. The sound generation portion comprises a first housing and a sound generation assembly; a first sound outlet hole is formed in the inner side wall of the firsthousing, and a second sound outlet hole is formed in the outer side wall of the first housing; the sound generation assembly comprises a loudspeaker and a limiting assembly; the limiting assembly allows to form a first acoustic cavity communicated with the first sound outlet hole between a first diaphragm of the loudspeaker and the inner side wall; and the limiting assembly allows to form a second acoustic cavity communicated with the second sound outlet hole between a second diaphragm of the loudspeaker and the outer side wall. By outputting sound on two sides of the sound generation portion, environmental noise around a user and the ear canal can be cancelled.

### CROSS-REFERENCE TO RELATED APPLICATIONS

This application is a continuation of International Application No. PCT/CN2025/095587, filed on May 16, 2025, which claims priority to Chinese Patent Application No. 202410966001.5 filed on Jul. 17, 2024, the contents of which are incorporated herein by reference.

### TECHNICAL FIELD

The present disclosure relates to the field of acoustic technology, and in particular to an open-ear headphone.

### BACKGROUND

Open-ear headphones have become an indispensable tool in people's daily life and work. With the continuous improvement of consumers' requirements for headphones, open-ear headphones need not only to have stable output performance, but also to be able to reduce ambient noise for normal listening in noisy or even high-noise environments. Therefore, noise cancellation performance has a great impact on the user experience of open-ear headphones. Thus, it is necessary to provide an open-ear headphone to improve the noise cancellation effect of the open-ear headphone.

### SUMMARY

One or more embodiments of the present disclosure provide an open-ear headphone, comprising an sound generating unit and an ear hook, the ear hook configured to position the sound generating unit near an ear without blocking an ear canal in a wearing state, the sound generating unit including a first housing and a sound generating assembly disposed inside the first housing, wherein a housing wall of the first housing facing toward the ear canal in the wearing state is an inside wall, a housing wall opposite the inside wall and facing away from the ear canal is an outside wall, the inside wall is provided with a first sound outlet, and the outside wall is provided with a second sound outlet; wherein the sound generating assembly includes: a loudspeaker, including a first diaphragm and a second diaphragm disposed opposite each other in a vibration direction; and a limiting assembly, wherein a sound guiding hole is provided in a center of the limiting assembly and the limiting assembly is disposed between the loudspeaker and the first housing; the limiting assembly positions the first diaphragm and the inside wall opposite each other in the vibration direction, and cooperates with the first diaphragm and the inside wall to form a first acoustic cavity communicating with the first sound outlet; the limiting assembly further positions the second diaphragm and the outside wall opposite each other in the vibration direction, and cooperates with the second diaphragm and the outside wall to form a second acoustic cavity communicating with the second sound outlet.

In one embodiment, on a reference plane perpendicular to the vibration direction, a projection of the sound guiding hole, a projection of the first sound outlet, a projection of the second sound outlet, a projection of the first diaphragm, and a projection of the second diaphragm at least partially overlap.

In one embodiment, on the reference plane, the projection of the first sound outlet falls within the projection of the sound guiding hole.

In one embodiment, on the reference plane, a projected area of an overlapping region of the projection of the first sound outlet and the projection of the sound guiding hole is not less than 80% of a projected area of the projection of the sound guiding hole.

In one embodiment, an acoustic resistance mesh is disposed in each of the first acoustic cavity and the second acoustic cavity; the acoustic resistance mesh is fixedly connected to the limiting assembly and covers the sound guiding hole; wherein a specific acoustic impedance of the acoustic resistance mesh in the first acoustic cavity is less than a specific acoustic impedance of the acoustic resistance mesh in the second acoustic cavity.

In one embodiment, a rib structure is disposed in the sound guiding hole, and the rib structure is configured to support and fix the acoustic resistance meshes.

In one embodiment, the acoustic resistance mesh in the first acoustic cavity is defined as a first acoustic resistance mesh, the acoustic resistance mesh in the second acoustic cavity is defined as a second acoustic resistance mesh, and a ratio of a specific acoustic impedance of the second acoustic resistance mesh to a specific acoustic impedance of the first acoustic resistance mesh is not less than 10.

In one embodiment, the limiting assembly is connected to the loudspeaker; in the vibration direction, an end of the limiting assembly proximate to the inside wall elastically abuts against the inside wall, and an end of the limiting assembly proximate to the outside wall elastically abuts against the outside wall.

In one embodiment, the limiting assembly includes a second housing, the second housing is disposed inside the first housing; the loudspeaker is disposed inside the second housing and fixedly connected to the second housing.

In one embodiment, the limiting assembly further includes a sealing ring; the sealing ring is connected between the second housing and the first housing.

In one embodiment, the sound guiding hole is provided in at least one of the first housing or the sealing ring.

In one embodiment, the sealing ring is integrally formed with the second housing, and/or the second housing is made of a metal material, and the sealing ring is made of a silicone material.

In one embodiment, the second housing has a transverse sidewall and a longitudinal sidewall, the transverse sidewall is spaced from and opposite to the first diaphragm or the second diaphragm in the vibration direction, the longitudinal sidewall surrounds in the vibration direction and is fixedly connected to the loudspeaker; wherein the transverse sidewall includes a central portion and an arc portion surrounding and connecting the central portion, at least a portion of the sound guiding hole penetrates the central portion, and an end of the arc portion away from the central portion is connected to the longitudinal sidewall.

In one embodiment, the second housing includes a first cover and a second cover, each of the first cover and the second cover has the transverse sidewall and the longitudinal sidewall; wherein one end of the loudspeaker in the vibration direction extends into the first cover and is fixedly connected to the longitudinal sidewall of the first cover; the other end of the loudspeaker in the vibration direction extends into the second cover and is fixedly connected to the longitudinal sidewall of the second cover.

In one embodiment, in the wearing state, a housing wall of the first housing facing toward a top of the head is an upside wall, and a housing wall away from the top of the head is a downside wall; the upside wall, the inside wall, the downside wall, and the outside wall are sequentially connected to jointly enclose an accommodating cavity for accommodating the sound generating assembly and form a mounting opening communicating with the accommodating cavity, the mounting opening configured to guide the sound generating assembly in and out of the accommodating cavity.

In one embodiment, a positioning structure is disposed in the accommodating cavity; the positioning structure is configured to abut against the limiting assembly to limit a position of the sound generating assembly inside the accommodating cavity; and/or the upside wall, the inside wall, the downside wall, and the outside wall are an integrated structure made of a metal material.

In one embodiment, the loudspeaker further includes a magnetic circuit assembly and a voice coil assembly, the magnetic circuit assembly and the voice coil assembly are located between the first diaphragm and the second diaphragm, and the voice coil assembly at least partially extends into a magnetic gap of the magnetic circuit assembly; the magnetic circuit assembly cooperates with the voice coil assembly to drive the voice coil assembly to cause the first diaphragm and the second diaphragm to vibrate synchronously and in the same direction.

In one embodiment, the loudspeaker further includes a bracket assembly, the bracket assembly surrounds and is connected to an outer periphery of the magnetic circuit assembly, an outer peripheral edge of the first diaphragm and an outer peripheral edge of the second diaphragm are fixed to the bracket assembly; at least a portion of the limiting assembly surrounds the bracket assembly and is connected between the bracket assembly and the first housing.

In one embodiment, the bracket assembly, the magnetic circuit assembly, the first diaphragm, and the second diaphragm jointly enclose and form a common cavity accommodating the voice coil assembly, and the bracket assembly is provided with an air pressure balancing channel communicating the common cavity with an exterior of the loudspeaker.

In one embodiment, an adhesive receiving gap receiving a sealing adhesive is formed at a junction of the bracket assembly and the limiting assembly.

In one embodiment, the voice coil assembly includes a first voice coil and a second voice coil arranged and connected in the vibration direction, an end of the first voice coil away from the second voice coil in the vibration direction is connected to the first diaphragm, and an end of the second voice coil away from the first voice coil in the vibration direction is connected to the second diaphragm.

In the open-ear headphone provided by the foregoing embodiments, based on a connection between the sound outlet and the corresponding acoustic cavity, an acoustic channel for outputting sound can be formed on both sides opposite to the sound generating assembly. By utilizing the characteristics of sound output from both sides of the sound generating assembly, an ambient noise around the user and an ambient noise near the ear canal can be canceled, thereby forming an active noise reduction effect, which effectively ensures sound production efficiency and improves the listening effect.

### BRIEF DESCRIPTION OF THE DRAWINGS

FIG. 1 is a schematic diagram illustrating a contour of a front side of an ear according to the present disclosure.

FIG. 2 is a schematic diagram illustrating a wearing state of an open-ear headphone when worn on an ear according to some embodiments.

FIG. 3 is a schematic diagram illustrating an outer contour structure of an open-ear headphone according to some embodiments.

FIG. 4 is a schematic diagram illustrating a cross-sectional structure of a sound generating unit in a long axis direction according to some embodiments.

FIG. 5 is a schematic diagram illustrating a cross-sectional structure of a sound generating unit in a short axis direction according to some embodiments.

FIG. 6 is a schematic diagram illustrating an exploded structure of a sound generating unit according to some embodiments.

FIG. 7 is a schematic diagram illustrating a cross-sectional structure of a sound generating unit according to some embodiments.

FIG. 8 is a schematic diagram illustrating frequency response curves corresponding to sound outlets of different sizes according to some embodiments.

FIG. 9 is a schematic diagram illustrating frequency response curves corresponding to sound outlets at different positions according to some embodiments.

FIGS. 10A to 10C are schematic diagrams illustrating sound outlets at different positions according to some embodiments.

FIG. 11 is a schematic diagram illustrating frequency response curves corresponding to first and second sound outlets at different relative positions according to some embodiments.

FIGS. 12A and 12B are schematic diagrams illustrating relative positions of a first sound outlet and a second sound outlet according to some embodiments.

FIG. 13 is a schematic diagram illustrating frequency response curves corresponding to first and second sound outlets of different sizes according to some embodiments.

FIG. 14 is a schematic diagram illustrating first and second sound outlets of different sizes according to some embodiments.

FIGS. 15A and 15B are schematic diagrams illustrating sound outlets with different centroids according to some embodiments.

FIG. 16 is a schematic diagram illustrating frequency response curves corresponding to sound outlets of different shapes according to some embodiments.

FIGS. 17A and 17B are schematic diagrams illustrating sound outlets with different numbers according to some embodiments.

FIG. 18 is a schematic diagram illustrating frequency response curves corresponding to sound outlets of different shapes and numbers according to some embodiments.

FIGS. 19A to 19F are schematic diagrams illustrating sound outlets of different distribution forms according to some embodiments.

FIG. 20 is a schematic diagram illustrating frequency response curves corresponding to the sound outlets in FIGS. 19A to 19F.

FIG. 21 is a schematic diagram illustrating a relative distance between a first sound outlet and a sound tuning hole according to some embodiments.

FIG. 22 is a schematic diagram illustrating frequency response curves corresponding to different distances between any two holes, or between any hole and a boundary of an acoustic cavity in FIG. 21.

FIG. 23 is a schematic diagram illustrating frequency response curves corresponding to different area ratios of the first sound outlet to the sound tuning hole in FIG. 21.

FIG. 24 is a schematic diagram illustrating a relative position between a first sound outlet and a sound tuning hole according to some embodiments.

FIG. 25 is a schematic diagram illustrating a structure of a sound emitting assembly in a sound generating unit according to some embodiments.

FIG. 26 is a schematic diagram illustrating an exploded structure of a sound emitting assembly according to some embodiments.

FIG. 27 is a schematic diagram illustrating a cross-sectional structure of a sound emitting assembly according to some embodiments.

FIG. 28 is a schematic diagram illustrating a cross-sectional structure of a loudspeaker according to some embodiments.

FIG. 29 is a schematic diagram illustrating an exploded structure of a loudspeaker according to some embodiments.

FIG. 30 is a schematic diagram illustrating a structure of a voice coil assembly according to some embodiments.

FIG. 31 is a schematic diagram illustrating an exploded structure of the voice coil assembly in FIG. 30.

FIGS. 32A and 32B are schematic diagrams illustrating cross-sectional structures of a loudspeaker from different viewing angles according to some embodiments.

FIG. 33 is a schematic diagram illustrating a structure of a voice coil assembly according to some embodiments.

FIG. 34 is a schematic diagram illustrating a cross-sectional structure of a loudspeaker according to an embodiment.

FIG. 35 is a schematic diagram illustrating frequency response curves of the loudspeaker in FIG. 34.

FIG. 36 is a schematic diagram illustrating BL curves for a loudspeaker with inner and outer magnets of different sizes according to some embodiments.

FIG. 37 is a schematic diagram illustrating a cross-sectional structure of a loudspeaker according to some embodiments.

FIGS. 38A and 38B are schematic diagrams illustrating BL curves for a loudspeaker with magnets and magnetic conductive members of different sizes in FIG. 37.

FIGS. 39A to 39G are schematic diagrams illustrating different exemplary structures of a magnetic circuit assembly according to some embodiments.

FIG. 40 is a schematic diagram illustrating a cross-sectional structure of a loudspeaker according to some embodiments.

FIG. 41 is a schematic diagram illustrating a cross-sectional structure of the loudspeaker in FIG. 40 from another viewing angle.

FIG. 42 is a schematic diagram illustrating an exploded structure of the loudspeaker in FIG. 40.

FIG. 43 is a schematic diagram illustrating driving force coefficients of a loudspeaker corresponding to through-holes of different sizes according to some embodiments.

FIG. 44 is a schematic diagram illustrating a cross-sectional structure of a loudspeaker according to some embodiments.

FIG. 45A is a schematic diagram illustrating an exploded structure of a loudspeaker according to some embodiments.

FIG. 45B is a schematic diagram illustrating a cross-section of the loudspeaker in FIG. 45A in a short axis direction.

FIG. 45C is a schematic diagram illustrating a cross-section of the loudspeaker in FIG. 45A in a long axis direction.

FIG. 46A is a schematic diagram illustrating an exploded structure of a loudspeaker according to some embodiments.

FIG. 46B is a schematic diagram illustrating an exploded structure of a loudspeaker according to some embodiments.

FIG. 47A is a schematic structural diagram illustrating a loudspeaker having a magnetic circuit fixing ring according to some embodiments.

FIG. 47B is a schematic structural diagram illustrating the loudspeaker of FIG. 47A from another viewing angle.

FIG. 48A is a schematic structural diagram illustrating a loudspeaker having a magnetic circuit fixing ring according to some embodiments.

FIG. 48B is a schematic structural diagram illustrating the loudspeaker of FIG. 48A from another viewing angle.

FIG. 49 is a schematic structural diagram illustrating an exemplary diaphragm assembly according to some examples.

FIG. 50 is a schematic enlarged diagram illustrating a part of the diaphragm assembly of FIG. 49.

FIG. 51 is a schematic diagram illustrating a connection region between a surround and a center patch and a surround width in a diaphragm assembly according to some embodiments.

FIG. 52 is a schematic diagram illustrating a BLx curve when a loudspeaker adopts the diaphragm assembly of FIG. 50 according to some embodiments.

FIG. 53 is a schematic diagram illustrating KMs curves of a loudspeaker under different ratios of the connection region between the surround and the center patch to the surround width according to some embodiments.

FIG. 54 is a schematic diagram illustrating a surround width and a thickness of a diaphragm of a diaphragm assembly according to some embodiments.

FIG. 55 is a schematic diagram illustrating KMs curves of a loudspeaker under different ratios of the surround width to the thickness according to some embodiments.

FIG. 56 is a schematic diagram illustrating a height difference between two ends of a surround and a surround width of a diaphragm of a diaphragm assembly according to some embodiments.

FIG. 57 is a schematic diagram illustrating KMs curves of a loudspeaker under different ratios of the height difference between the two ends of the surround to the surround width according to some embodiments.

FIG. 58 is a schematic diagram illustrating a height difference between two ends of a surround and an arch height of the surround of a diaphragm of a diaphragm assembly according to some embodiments.

FIG. 59 is a schematic diagram illustrating KMs curves of a loudspeaker under different ratios of the height difference between the two ends of the surround to the arch height according to some embodiments.

FIG. 60 is a schematic diagram illustrating thickness zones of a surround of a diaphragm of a diaphragm assembly according to some embodiments.

FIG. 61 is a schematic diagram illustrating KMs curves of a loudspeaker under different ratios of the thickness zones of the surround according to some embodiments.

FIG. 62 is a schematic diagram illustrating a cross-sectional structure of a center patch of a diaphragm assembly according to some embodiments.

FIG. 63 is a schematic diagram illustrating frequency response curves for earphones with different diaphragms according to some embodiments.

### DETAILED DESCRIPTION

The present disclosure is further described in detail below with reference to the specific embodiments and the accompanying drawings. Similar elements in different embodiments are denoted by associated similar reference numerals. In the following embodiments, many details are described to provide a better understanding of the present disclosure. However, those skilled in the art may readily recognize that some features thereof may be omitted in different situations, or may be replaced by other elements, materials, or manners. In some cases, some operations related to the present disclosure are not shown or described in the present disclosure. This is to avoid submerging the core part of the present disclosure by excessive descriptions. For those skilled in the art, detailed descriptions of these related operations are not necessary, as they can fully understand the related operations based on the descriptions in the present disclosure and general technical knowledge in the art.

Furthermore, the characteristics, operations, or features described in the present disclosure may be combined in any suitable manner to form various embodiments. Meanwhile, the steps or actions in the manner descriptions may also be reordered or adjusted in manners obvious to those skilled in the art. Therefore, the various sequences in the present disclosure and the accompanying drawings are merely for clearly describing an embodiment, and do not mean to be mandatory sequences, unless it is otherwise specified that a specific sequence must be followed.

The sequence numbers assigned to components herein, e.g., “first” and “second”, or the like, are merely used to distinguish the described objects and do not have any sequential or technical meaning. Further, the terms “connection” and “coupling” as used in the present disclosure, unless otherwise specified, include both direct and indirect connection (coupling).

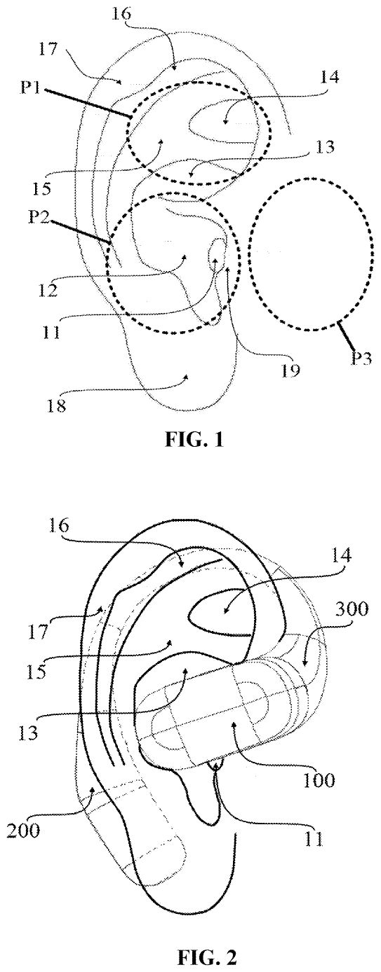

FIG. 1 is a schematic diagram illustrating a physiological structure of an exemplary ear for an open-ear headphone according to some embodiments of the present disclosure. Referring to FIG. 1, the exemplary ear may include physiological parts such as an ear canal 11, a concha cavity 12, a cymba conchae 13, a triangular fossa 14, an antihelix 15, a scapha 16, a helix 17, an earlobe 18, a crus of helix 19, or the like. Although the ear canal 11 has a certain depth and extends to an eardrum of the ear, the ear canal 11 may be understood as its entrance away from the eardrum (i.e., an ear hole or an ear canal opening) unless otherwise specified. Further, the physiological parts such as the concha cavity 12, the cymba conchae 13, the triangular fossa 14, or the like, have a certain volume and depth in a three-dimensional space. The concha cavity 12 is directly connected to the ear canal 11, which may be simply regarded as the aforementioned ear hole being located at a bottom of the concha cavity 12.

Since the physiological parts such as the ear canal 11, the concha cavity 12, the cymba conchae 13, the triangular fossa 14, or the like, have a certain depth and volume in the three-dimensional space, for a headphone provided according to some embodiments of the present disclosure, stable wearing of the headphone may be achieved by means of one or more physiological parts of the ear.

By way of example, wearing of the headphone is achieved by means of other parts of the ear except the ear canal 11 (e.g., the cymba conchae 13, the triangular fossa 14, the antihelix 15, the scapha 16, the helix 17, or the like, or a combination thereof). For example, in a wearing state, a whole or a portion of a structure of the headphone may contact an upper part of the ear canal 11 (e.g., one or more physiological parts such as the cymba conchae 13, the triangular fossa 14, the antihelix 15, the scapha 16, the helix 17, the crus of helix 19, or the like). As another example, in the wearing state, the whole or a portion of the structure of the headphone may be located in a first region P1 delimited by dashed lines in FIG. 1, which at least includes the cymba conchae 13 and the triangular fossa 14, or may be located in a second region P2 delimited by dashed lines in FIG. 1, which at least includes the concha cavity 12, or may be located in a front side of the crus of helix 19 (i.e., in a third region P3 delimited by dashed lines in FIG. 1).

By means of other parts of the ear except the ear canal 11, wearing of the headphone and transmission of sound are achieved, which not only can “liberate the ear canal” and reduce the influence of the headphone on the ear health of the user, but also can effectively improve the user experience of the headphone. For example, when the user wears the headphone on a road, the headphone does not block the ear canal 11, thereby allowing the user to receive sound from the headphone and also receive ambient sound (e.g., a horn sound, a bicycle bell sound, surrounding human voices, traffic command sounds, or the like), thereby being capable of effectively reducing an occurrence of traffic accidents.

Since different users may have individual differences, the ear may have dimensional differences such as different shapes, sizes, or the like. To facilitate description and understanding, and to reduce or even eliminate individual differences among different users, unless otherwise specified, the present disclosure primarily uses an ear model with a “standard” shape and size as a reference to describe structures of open-ear headphones in different embodiments and wearing manners thereof on the ear model. For example, a simulator (e.g., GRAS 45BC KEMAR) including a head and its (left and right) ears may be prepared based on ANSI: S3.36, S3.25, and IEC:60318-7 standards, as a reference object for wearing the open-ear headphone, thereby presenting a scenario where most users normally wear the open-ear headphone.

Therefore, descriptions in the present disclosure, such as “user wearing”, “in the wearing state”, “under the wearing state”, or the like, may refer to the open-ear headphone described in the present disclosure being worn on the ear of the aforementioned simulator. Of course, considering that different users have individual differences, the structures, shapes, sizes, thicknesses, or the like, of one or more parts of the ear may be designed differently according to ears with different shapes and sizes. These differential designs may be manifested as characteristic parameters of one or more parts in the open-ear headphone, having values in different ranges to adapt to different ears.

It should be noted that, in fields such as medicine and anatomy, three basic cutting planes, namely a sagittal plane, a coronal plane, and a horizontal plane, and three basic axes, namely a sagittal axis, a coronal axis, and a vertical axis, of a human body may be defined.

The sagittal plane refers to a cutting plane perpendicular to the ground along an anterior-posterior direction of the body, dividing the human body into left and right parts. The coronal plane refers to a cutting plane perpendicular to the ground along a left-right direction of the body, dividing the human body into anterior and posterior parts. The horizontal plane refers to a cutting plane parallel to the ground along an up-down direction of the body, dividing the human body into upper and lower parts. Correspondingly, the sagittal axis refers to an axis along the anterior-posterior direction of the body and perpendicular to the coronal plane. The coronal axis refers to an axis along the left-right direction of the body and perpendicular to the sagittal plane. The vertical axis refers to an axis along the up-down direction of the body and perpendicular to the horizontal plane.

Further, the “front side of the ear” as described in the present disclosure is a concept relative to the “rear side of the ear”, wherein the former refers to a side of the ear deviating from a head, and the latter refers to a side of the ear facing the head. Both of them are directed to the ear of the user. Observing the ear of the aforementioned simulator along a direction of the coronal axis of the human body, a schematic diagram of a front side profile of the ear shown in FIG. 1 may be obtained.

It should be noted that, the above description regarding the ear is merely for illustrative purposes, and is not intended to limit the scope of the present disclosure. For those skilled in the art, various changes and modifications may be made according to the descriptions of the present disclosure (e.g., a partial structure of the open-ear headphone may partially or completely cover the ear canal 11), and these changes and modifications still fall within the protection scope of the present disclosure.

For an open-ear headphone, in the wearing state, a sound generating unit of the open-ear headphone typically cannot form a relatively closed sound transmission channel with the ear canal 11. This may cause environmental noise to enter the ear canal 11, thereby causing a significant impact on listening sensation of the user.

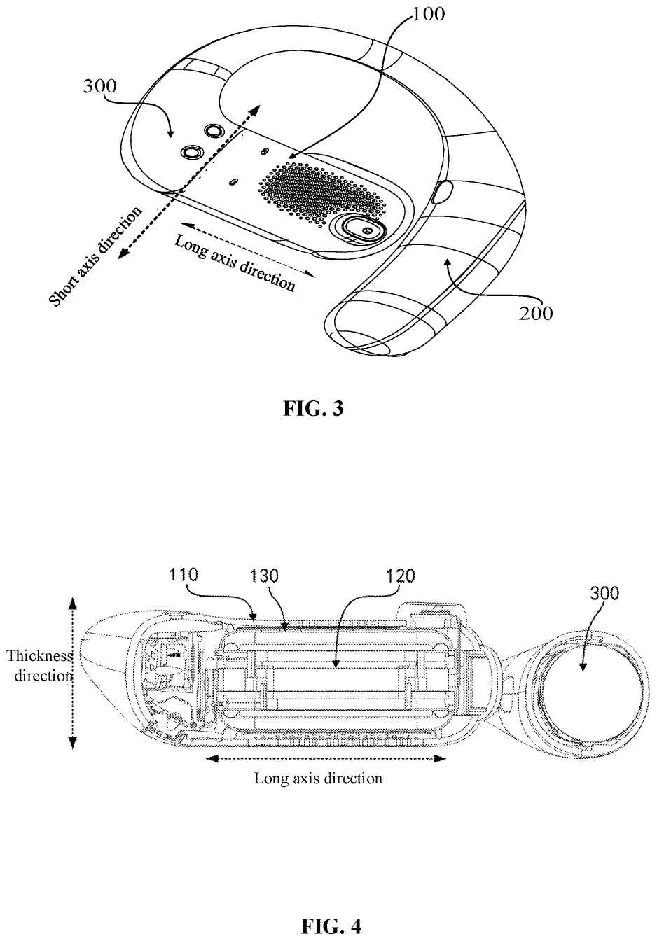

To reduce or cancel environmental noise in noisy or even high-noise environments, thereby achieving an active noise reduction function of the open-ear headphone and improving a listening effect of the open-ear headphone, referring to FIG. 2 and FIG. 3, some embodiments of the present disclosure provide an open-ear headphone (hereinafter referred to as the headphone), including a sound generating unit 100 and an ear hook. The ear hook is configured to place the sound generating unit 100 near an ear without blocking the ear canal 11 in the wearing state. It should be noted that, due to individual differences among different users, when the open-ear headphone is worn by different users, the sound generating unit 100 may partially cover the ear canal 11, but the ear canal 11 is still not sealed. This will be described in detail below.

In some embodiments, referring to FIG. 4 to FIG. 6, the sound generating unit 100 includes a first housing 110, a sound generating assembly, a microphone assembly, or the like. The sound generating assembly is disposed inside the first housing 110. The sound generating assembly may include a loudspeaker 120 and a limiting assembly 130. The loudspeaker 120 can convert an electrical signal into corresponding mechanical vibrations, thereby generating a sound output (e.g., a noise reduction sound, an audio played by the open-ear headphone, or the like). Exemplarily, the sound generated by the loudspeaker 120 may include the noise reduction sound. The noise reduction sound output to the outside of the first housing 110 may have an amplitude that is the same as an amplitude of the environmental noise near the ear canal 11 and a phase that is opposite to the phase of the environmental noise, to eliminate the environmental noise near the ear canal 11 and achieve active noise reduction. The sound generated by the loudspeaker 120 may also include other sounds such as a call sound, a played audio, a reminder sound, or the like. After these sounds are output to the outside of the first housing 110, they may be directed to the ear canal 11 to ensure a listening effect for the user.

The limiting assembly 130 is configured to position and limit the loudspeaker 120 inside the first housing 110. On one hand, by positioning the loudspeaker 120 inside the first housing 110, it may be ensured that the sound generated by the loudspeaker 120 is stably output to the outside of the first housing 110 through an acoustic hole disposed in the first housing 110. On the other hand, by limiting the loudspeaker 120, it may be avoided that the loudspeaker 120 shakes relative to the first housing 110 during vibration, thereby ensuring a sound output performance of the sound generating unit 100.

Further, based on the microphone assembly, sound signals, such as a user speech and environmental sounds, may be collected. Exemplarily, based on the environmental noise collected by a microphone, an output of the loudspeaker 120 may be adjusted so that the sound output by the loudspeaker 120 includes a sound signal that cancels out the environmental noise, thereby achieving active noise reduction of the open-ear headphone against the environmental noise.

In some embodiments, referring to FIG. 2 and FIG. 3, the ear hook may include an ear hook housing and a battery assembly, a circuit board assembly, or the like, disposed inside the ear hook housing. The structures, such as the battery assembly, the loudspeaker 120, and the microphone assembly, are electrically connected to the circuit board assembly. The circuit board assembly may be understood as a collection of a main control board or the main control board and related components of the open-ear headphone. The circuit board assembly serves a regulating and managing role for all or some functional components in the open-ear headphone. For example, it is configured to convert and process electrical signals in the open-ear headphone to support the implementation of various functions of the open-ear headphone (e.g., supporting the open-ear headphone to achieve power on/off, playback content switching, volume increase/decrease, or the like).

Exemplarily, referring to FIG. 3, the ear hook may be divided along its length direction into two parts, namely a battery section 200 and an adapter section 300. The adapter section 300 is connected between the battery section 200 and the sound generating unit 100. In the wearing state, a portion of the battery section 200 (e.g., a portion occupied by the battery assembly and the circuit board assembly) is hung between the auricle and the head. Another portion of the battery section 200 extends towards a side of the auricle deviating from the head and is connected to the adapter section 300, placing the sound generating unit 100 at a position near the ear canal 11 but not blocking the ear canal 11, thereby allowing the headphone to function as an open-ear headphone. Further, the battery assembly and the circuit board assembly may be disposed in the battery section 200. The adapter section 300 may be provided with a headphone button and components such as an adapter board configured to electrically connect the circuit board assembly to the loudspeaker 120, the microphone assembly, or the like.

In some embodiments, to improve a stability of the headphone in the wearing state, the headphone may adopt any one or a combination of the following manners. Firstly, at least a portion of the ear hook is configured as a contoured structure (e.g., an arc-shaped barb-like structure) that fits at least one of the rear side of the ear or the head, to increase a contact area between the ear hook and the ear or the head, thereby increasing a resistance of the headphone from falling off the ear. Secondly, at least a portion of the ear hook is configured as an elastic structure, thereby allowing the ear hook to have a certain elastic deformation amount in the wearing state, to increase a pressure of the ear hook on the ear or the head, thereby increasing the resistance of the headphone from falling off the ear. Thirdly, at least a portion of the ear hook is configured to abut against the head in the wearing state, thereby allowing the ear hook to form a reaction force pressing against the ear, such that the sound generating unit 100 is pressed against the front side of the ear, thereby increasing the resistance of the headphone from falling off the ear. Fourthly, the sound generating unit 100 and the ear hook are configured to clamp physiological parts such as a region where the helix 17 is located, a region where the concha cavity 12 is located, or the like, respectively, from the front and rear sides of the ear in the wearing state, thereby increasing the resistance of the headphone from falling off the ear. Fifthly, the sound generating unit 100 is configured to at least partially extend into physiological parts such as the concha cavity 12, the cymba conchae 13, the triangular fossa 14, the scapha 16, or the like, in the wearing state, thereby increasing the resistance of the headphone from falling off the ear.

In some embodiments, the headphone may be combined with products such as glasses, head-mounted headphones, head-mounted display devices, Augmented Reality/Virtual Reality (AR/VR) helmets, or the like. For example, the ear hook may be omitted or retained, and the sound generating unit 100 is worn near the ear of the user in manners such as hanging and clamping, or the like.

In view of that, some existing headphones configured to achieve active noise cancellation mostly only support active noise cancellation within a relatively narrow frequency band range. To enable the headphone to have a flatter output within a relatively wide frequency band range, thereby effectively enhancing the active noise cancellation effect of the headphone in open-ear application scenarios, the sound generating unit 100 is mainly introduced below.

Referring to FIG. 3 to FIG. 6, the sound generating unit 100 may have a long axis direction and a short axis direction that are perpendicular to a thickness direction and mutually orthogonal. The long axis direction may be defined as a direction having a maximum extension dimension in a shape of a two-dimensional projection plane of the sound generating unit 100 (e.g., a projection of the sound generating unit 100 on a plane where an outside surface thereof is located, or a projection of the sound generating unit 100 on a sagittal plane). The short axis direction may be defined as a direction perpendicular to the long axis direction in a shape of the projection of the sound generating unit 100 on the sagittal plane. For example, when the shape of the projection is rectangular or approximately rectangular, the long axis direction refers to a length direction of the rectangular or approximately rectangular shape, and the short axis direction refers to a width direction of the rectangular or approximately rectangular shape. The thickness direction refers to a direction perpendicular to the two-dimensional projection plane. For example, the thickness direction may be consistent with a direction of the coronal axis, both pointing to the left-right direction of the body. In some embodiments, the thickness direction may also be defined as a direction of the housing approaching or moving away from the ear in the wearing state. In some embodiments, when the sound generating unit 100 is in a tilted state in the wearing state, the long axis direction and the short axis direction may still be parallel or approximately parallel to the sagittal plane. The long axis direction may have a certain angle with a direction of the sagittal axis, meaning that the long axis direction is also set obliquely accordingly. The short axis direction may have a certain angle with a direction of the vertical axis, meaning that the short axis direction is also set obliquely. In some embodiments, at least a portion of a structure of the housing of the sound generating unit 100 may extend into the concha cavity 102. That is to say, a projection of the housing of the sound generating unit 100 on the sagittal plane and a projection of the concha cavity 102 on the sagittal plane have an overlapping region.

Meanwhile, referring to FIG. 6, the first housing 110 of the sound generating unit 100 may include a plurality of different housing walls, such as an inside wall 110a, an outside wall 110b, an upside wall 110c, and a lowside wall 110d. The inside wall 110a is a housing sidewall of the first housing 110 on a side facing the ear (e.g., the ear canal 11) in the thickness direction in the wearing state. The outside wall 110b is a housing sidewall of the first housing 110 on a side moving away from the ear (e.g., the ear canal 11) in the thickness direction in the wearing state. The upside wall 110c is a housing sidewall of the first housing 110 on a side closer to a top of the head in the short axis direction in the wearing state. The lowside wall 110d is a housing sidewall of the first housing 110 on a side farther from the top of the head in the short axis direction in the wearing state. It may be understood that the plurality of different housing walls may cooperatively enclose an accommodating cavity of the sound generating unit 100, and the sound generating assembly (e.g., the loudspeaker 120, or the like) is accommodated and disposed within the accommodating cavity.

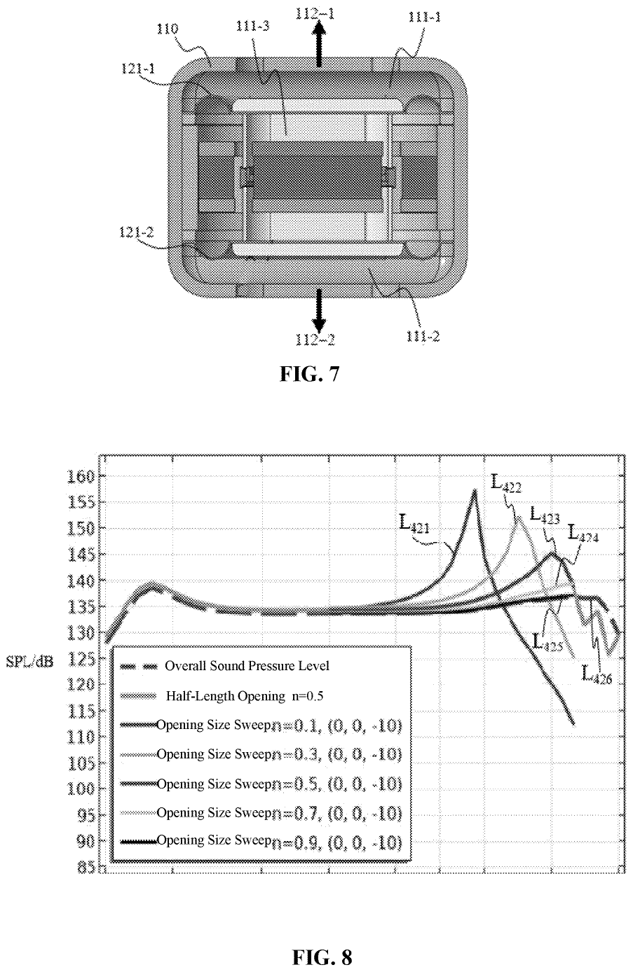

In some embodiments, referring to FIG. 4 to FIG. 24, inside the first housing 110, a first acoustic cavity 111-1 is formed between the loudspeaker 120 and the inside wall 110a, and a second acoustic cavity 111-2 is formed between the loudspeaker 120 and the outside wall 110b. Correspondingly, the inside wall 110a is provided therethrough with a first sound outlet 112-1 acoustically connected to the loudspeaker 120 through the first acoustic cavity 111-1, and the outside wall 110b is provided therethrough with a second sound outlet 112-2 acoustically connected to the loudspeaker 120 through the second acoustic cavity 111-2.

In some embodiments, the loudspeaker 120 may employ a dual-diaphragm loudspeaker, which includes a first diaphragm 121-1 and a second diaphragm 121-2 that are disposed opposite to each other in a vibration direction. The first diaphragm 121-1 and the inside wall 110a are spaced apart and opposite to each other in the vibration direction (i.e., the thickness direction) to form the first acoustic cavity 111-1. The second diaphragm 121-2 and the outside wall 110b are spaced apart and opposite to each other in the vibration direction to form the second acoustic cavity 111-2.

Firstly, by utilizing a communication relationship between the first acoustic cavity 111-1 and the first sound outlet 112-1, a first Helmholtz resonator model may be formed. By utilizing a communication relationship between the second acoustic cavity 111-2 and the second sound outlet 112-2, a second Helmholtz resonator model may be formed. The first sound outlet 112-1 and the second sound outlet 112-2 serve as respective necks of the corresponding Helmholtz resonator models. When the loudspeaker 120 vibrates and outputs a sound, by adjusting a pressure inside the sound generating unit 100 based on the second Helmholtz resonator model, adjustment of the frequency response curve of the sound output from the first sound outlet 112-1 may be achieved, for example, allowing the sound output from the first sound outlet 112-1 to have a flat frequency response curve and a phase curve with a small variation range within a relatively wide frequency band range, thereby facilitating the headphone to achieve active noise cancellation within a wider frequency band range.

By way of example, in some embodiments, the frequency response curve of the sound output from the first sound outlet 111-1 may have a first resonance peak and second resonance peak adjacent to each other. A peak resonance frequency of the first resonance peak is less than a peak resonance frequency of the second resonance peak, and with cooperation of the second Helmholtz resonator, a ratio of the peak resonance frequency of the second resonance peak to the peak resonance frequency of the first resonance peak may be set to be not less than 3, thereby effectively increasing the width of the flat region of the frequency response curve of the sound output from the first sound outlet 112-1, to provide support for the headphone to perform active noise cancellation within a wider frequency band range.

Secondly, in a case where the dual-diaphragm loudspeaker is employed, based on characteristics such as relatively stable vibration of the dual-diaphragm loudspeaker and good consistency of vibration between the first diaphragm 121-1 and the second diaphragm 121-2, with cooperation of corresponding sound outlets and acoustic cavities, the first resonance peak may be moved as far as possible to a low-frequency band, and the second resonance peak may be moved as far as possible to a high-frequency band, which is helpful for increasing the width of the flat region of the frequency response curve of sound output from the headphone, thereby providing support for the headphone to perform active noise cancellation within a wider frequency band range. Meanwhile, when the first diaphragm 121-1 and the second diaphragm 121-2 maintain synchronous vibration and in the same direction, with cooperation of the first sound outlet 112-1 and the second sound outlet 112-2, an effective area of sound output may also be significantly increased, and the sound output efficiency may be improved.

Thirdly, in the wearing state, at least a portion of the first housing 110 may be located within the concha cavity 12. The inside wall 110a cooperates with the concha cavity 12 to form an auxiliary cavity communicating with the ear canal 11. The auxiliary cavity is usually in a semi-open state, and the first sound outlet 112-1 is located within the auxiliary cavity. In this manner, the sound output from the first sound outlet 112-1 may be restricted and gathered by the auxiliary cavity. A majority of the sound may propagate into the ear canal 11, while a small portion of the sound propagating outside the ear canal 11 (e.g., the noise cancellation sound) may be anti-phase cancelled with the ambient noise near the ear canal 11, thereby being beneficial for both improving a listening effect and enhancing the active noise cancellation effect, and also beneficial for reducing a sound leakage problem.

In some embodiments, the ratio of the peak resonance frequency of the second resonance peak to the peak resonance frequency of the first resonance peak may be set to be not less than 13, to further increase the width of the flat region of the frequency response curve of sound output from the headphone, thereby allowing the headphone to perform active noise cancellation within a wider frequency band range. In some embodiments, the ratio of the peak resonance frequency of the second resonance peak to the peak resonance frequency of the first resonance peak may be set to be not less than 20, to allow the sound output from the headphone to have a flatter frequency response curve and a phase curve with a smaller variation range within a wider frequency band range, thereby further enhancing the active noise cancellation effect of the headphone.

In some embodiments, the peak resonance frequency of the first resonance peak of the sound output from the first sound outlet 112-1 may be set to be not greater than 300 Hz; and the peak resonance frequency of the second resonance peak may be set to be not less than 1 kHz, e.g., not less than 3.65 kHz, not less than 4.5 kHz, not less than 5.8 kHz, not less than 6.7 kHz, not less than 7.5 kHz, not less than 7.75 kHz, not less than 8.75 kHz, not less than 9.25 kHz, not less than 9.5 kHz, or the like). In this way, the sound output from the headphone (specifically, the sound output from the first sound outlet 112-1) may finally have a flat frequency response curve and a phase curve with a small variation range within a relatively wide frequency band range, thereby facilitating the headphone to achieve the active noise cancellation effect within a wider frequency band range.

A peak value of a high-frequency resonance peak of the frequency response curve of the sound output from the headphone is mainly affected by a high-frequency peak of the loudspeaker 120 itself and a high-frequency peak formed in the acoustic cavity. Therefore, in some embodiments, by designing the loudspeaker 120 (e.g., the magnetic circuit, the voice coil, the diaphragm, and structural relationships between them) and one or more acoustic structures (e.g., the sound outlets and acoustic cavities) in terms of quantity, shape, size, position, or the like, the frequency response curve of the sound output from the headphone (specifically, the first sound outlet 112-1) may be optimized, to make the flat region of the frequency response curve wider, thereby supporting the headphone to perform active noise cancellation within a wider frequency band range; which will be specifically described below.

As mentioned above, the sound generating unit 100 provided in some embodiments of the present disclosure will be further described below, mainly from perspectives such as size, shape, position, and quantity of sound outlets. It should be noted that the high-frequency resonance peak, the high-frequency peak, or the like described below may be understood as the second resonance peak of the sound output from the first sound outlet 112-1 in some embodiments.

Referring to FIG. 8, FIG. 8 is a schematic diagram illustrating frequency response curves of the sound generating unit 100 corresponding to the first sound outlet 112-1 and the second sound outlet 112-2 of different sizes according to some embodiments of the present disclosure. It should be noted that the data measured in FIG. 8 is obtained under a condition where the first sound outlet 112-1 and the second sound outlet 112-2 are single holes with consistent shapes (e.g., a short side dimension is half of a long side dimension). It may be understood that an area of a side wall of the first housing 110 remains unchanged, a width dimension of the sound outlets remains unchanged, and a ratio of length dimensions of the sound outlets represents a size change of the sound outlets.

In FIG. 8, the curve L421 represents a frequency response when a ratio of a long side dimension of a sound outlet to a long side dimension of the first housing 110 is 0.1; the curve L422 represents a frequency response when the ratio of the long side dimension of the sound outlet to the long side dimension of the first housing 110 is 0.3; the curve L423 represents a frequency response when the ratio of the long side dimension of the sound outlet to the long side dimension of the first housing 110 is 0.5; the curve L424 represents a frequency response when the ratio of the long side dimension of the sound outlet to the long side dimension of the first housing 110 is 0.7; the curve L425 represents a frequency response when the ratio of the long side dimension of the sound outlet to the long side dimension of the first housing 110 is 0.9; and the curve L426 represents a total sound pressure level of the loudspeaker 120, which may be regarded as an output sound pressure level when the loudspeaker 120 is not enclosed by the first housing 110. The sound outlets with different long side dimensions have the same width dimension, and are disposed at a center position of the corresponding inside wall 110a and outside wall 110b.

As shown in FIG. 8, as the size of the sound outlets gradually decreases, a resonance peak of the sound generating unit 100 at a high frequency (e.g., above 4.5 kHz) gradually shifts forward, and a peak resonance frequency of the high-frequency resonance peak of the curve L422 is about 10 kHz.

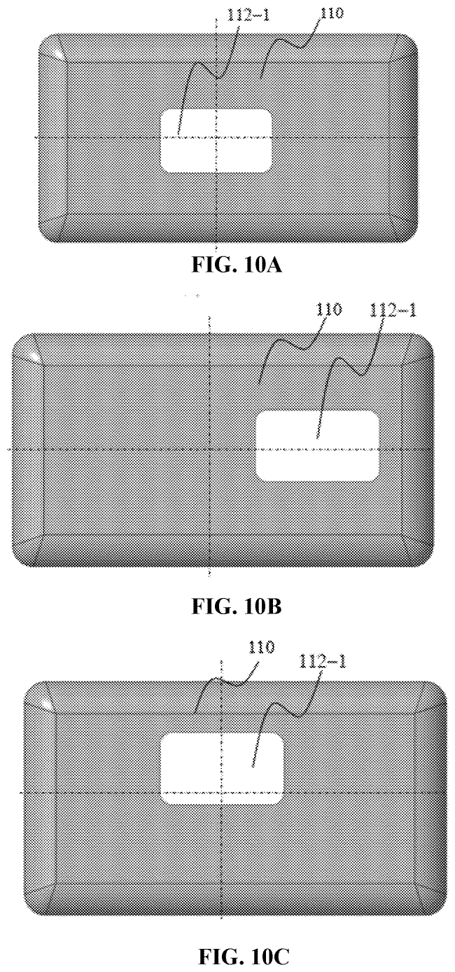

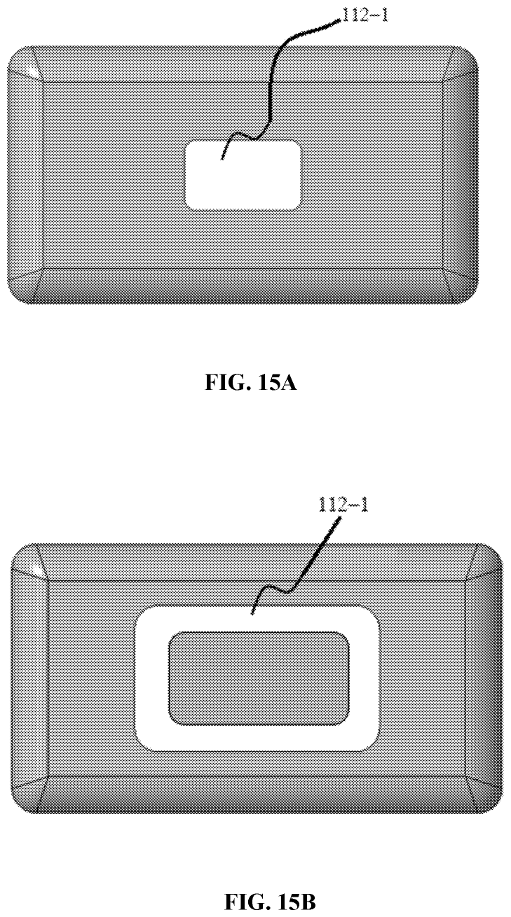

Based on this, in some embodiments, referring to FIG. 10A to FIG. 10C, and FIG. 15A and FIG. 15B, the first sound outlet 112-1 and the second sound outlet 112-2 may employ a single-hole structure. In a case where a length of the first housing 110 and a length of the sound outlets in the long axis direction are respectively greater than a width of the first housing 110 and a width of the sound outlets in the short axis direction, the ratio of the long side dimension of the sound outlets to the long side dimension of the first housing 110 may be not less than 0.3. For example, a ratio of the length of the first sound outlet 112-1 in the long axis direction to a length of the inside wall 110a in the long axis direction may be not less than 0.3, and a ratio of the length of the first sound outlet 112-1 in the long axis direction to a length of the outside wall 110b in the long axis direction may be not less than 0.3. In a case where a contour shape of the sound generating unit 100 is a central symmetric geometric shape (e.g., a circle, or the like), a ratio of a radius of the sound outlets to a radius of a corresponding side wall of the first housing 110 may be not less than 0.3. In this way, a resonance frequency of corresponding acoustic cavities may be not less than 1 kHz, ensuring that the second resonance peak of the sound output from the sound outlets moves to a high-frequency band, thereby ultimately allowing the headphone to have a relatively flat output within a relatively wide frequency band range, and improving the active noise cancellation effect of the headphone against relatively large ambient noise in an open-ear scenario.

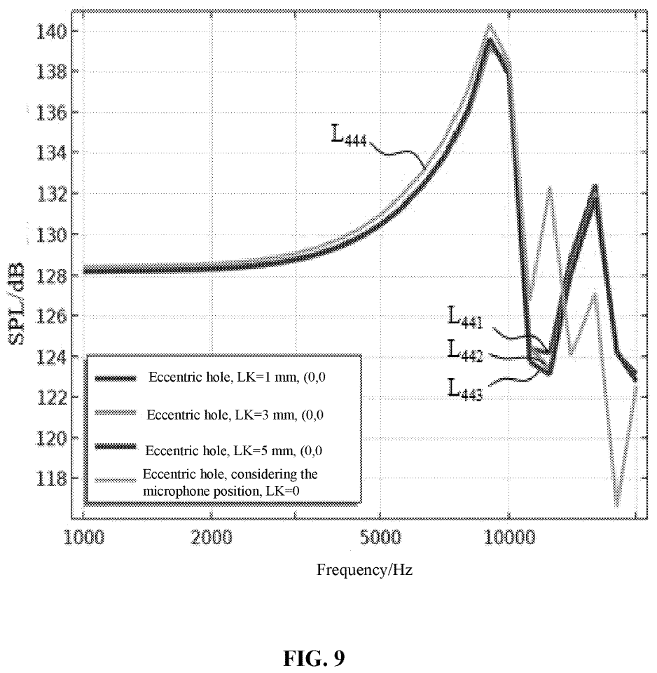

Referring to FIG. 9, FIG. 9 is a schematic diagram illustrating frequency response curves corresponding to sound outlets at different positions according to some embodiments of the present disclosure. It should be noted that the data measured in FIG. 9 is obtained under a condition where the first sound outlet 112-1 and the second sound outlet 112-2 are single holes with consistent shapes, and both have the same size and position.

In FIG. 9, sound outlets corresponding to the curve L441, curve L442, curve L443, and curve L444 are all eccentrically disposed with respect to the surface of the first housing 110 in the long side direction. The curve L441 represents that a distance between a center of a sound outlet and a center of a corresponding side wall in the length direction is 1 mm. The curve L442 represents that the distance between the center of the sound outlet and the center of the corresponding side wall in the length direction is 3 mm. The curve L443 represents that the distance between the center of the sound outlet and the center of the corresponding side wall in the length direction is 5 mm. The curve L444 represents that the distance between the center of the sound outlet and the center of the corresponding side wall in the length direction is 0 mm, that is, the sound outlet is not eccentrically disposed and is disposed at the center of the corresponding side wall of the first housing 110.

As shown in FIG. 9, within a range of 1 kHz to 10 kHz, a sound pressure level corresponding to a resonance peak of the curve L444 is higher than that of other curves, indicating that when the sound outlet is located at the center of the corresponding side wall of the first housing 110, the sound pressure level of the sound output from the sound generating unit 100 will be slightly larger.

Based on this, in some embodiments, referring to FIG. 10A, the first sound outlet 112-1 and the second sound outlet 112-2 may employ a single-hole structure, and a centroid of the first sound outlet 112-1 may coincide with a center of the inside wall 110a, and a centroid of the second sound outlet 112-2 may coincide with a center of the outside wall 110b, thereby allowing the sound outlets to be located at the center position of the corresponding side walls of the first housing 110. This may increase the sound pressure level of the sound output from the headphone, improve the sensitivity of output of the headphone, and enhance the listening effect for a user.

As shown in FIG. 9, by comparing the curve L441, the curve L442, the curve L443, and the curve L444, the resonance frequencies corresponding to the high-frequency resonance peak of the four curves are substantially the same, indicating that different positions of sound outlets in a large-area concentrated opening form (i.e., a large-area single-hole form) do not affect the position of the high-frequency peak of the headphone.

Based on this, in some embodiments, considering a structure of the headphone and other components, when the sound outlets may not be disposed at the center position of the corresponding side wall of the first housing 110, an eccentric adjustment may be made to the first sound outlet 112-1 or the second sound outlet 112-2. Taking the position of the first sound outlet 112-1 as an example, referring to FIG. 10B, the first sound outlet 112-1 may be eccentrically disposed with respect to the center of the inside wall 110a in the length direction; referring to FIG. 10C, the first sound outlet 112-1 may be eccentrically disposed with respect to the center of the inside wall 110a in the width direction; and the first sound outlet 112-1 may also be eccentrically disposed with respect to the center of the inside wall 110a in both the length direction and the width direction.

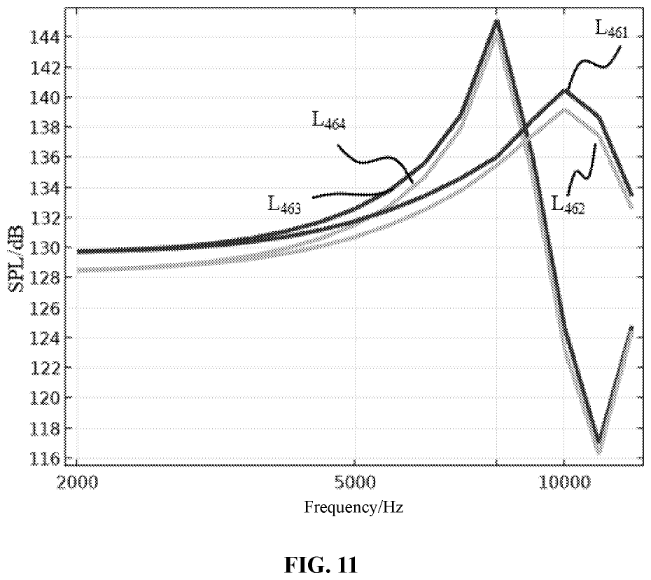

Referring to FIG. 11, FIG. 11 is a schematic diagram illustrating frequency response curves of the sound generating unit 100 corresponding to the first sound outlet 112-1 and the second sound outlet 112-2 disposed at different positions according to some embodiments of the present disclosure. It should be noted that the data measured in FIG. 11 is obtained under a condition where the first sound outlet 112-1 and the second sound outlet 112-2 are single holes with consistent shapes (e.g., the short side dimension is half of the long side dimension), and have the same size.

In FIG. 11, the curve L461 represents a frequency response curve at the first sound outlet 112-1 when the first sound outlet 112-1 and the second sound outlet 112-2 are disposed coaxially; the curve L462 represents a frequency response curve at the second sound outlet 112-2 when the first sound outlet 112-1 and the second sound outlet 112-2 are disposed coaxially; the curve L463 represents a frequency response curve at the first sound outlet 112-1 when the first sound outlet 112-1 and the second sound outlet 112-2 are staggered; and the curve L464 represents a frequency response curve at the second sound outlet 112-2 when the first sound outlet 112-1 and the second sound outlet 112-2 are staggered. The area of the first sound outlet 112-1 and the second sound outlet 112-2 is the same for conditions corresponding to the curve L461, the curve L462, the curve L463, and the curve L464. As shown in FIG. 11, compared with the curve L461 and the curve L462, the high-frequency resonance peak of the curve L463 and the curve L464 significantly shifts forward, moving from approximately 10 kHz to approximately 8 kHz.

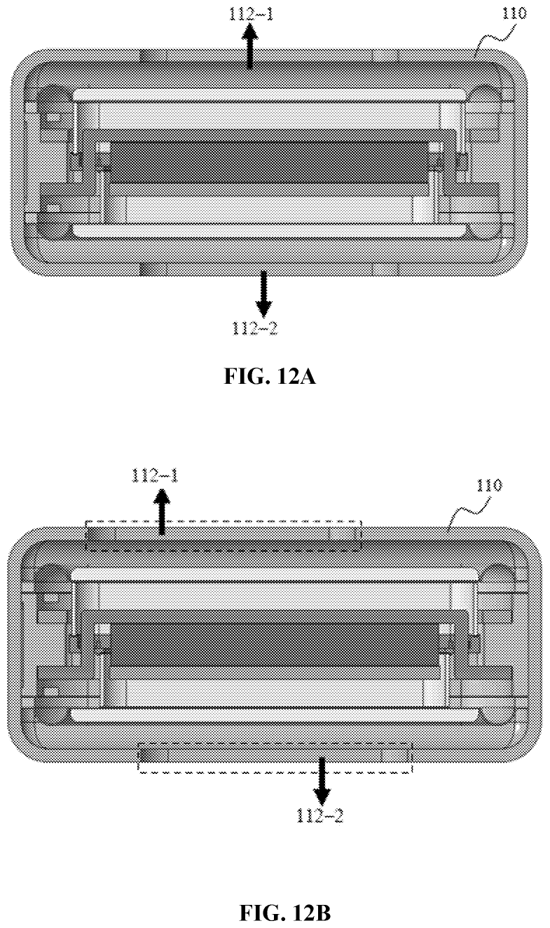

Based on this, in some embodiments, referring to FIG. 12A, the first sound outlet 112-1 and the second sound outlet 112-2 may employ a single-hole structure, and the first sound outlet 112-1 and the second sound outlet 112-2 may be disposed coaxially. This may allow the sound generating unit 100 or the headphone to have a relatively flat output within a relatively wide frequency band range, thereby improving the active noise cancellation effect of the headphone. In other embodiments, referring to FIG. 12B, the first sound outlet 112-1 and the second sound outlet 112-2 may also be staggered, to meet an appearance requirement of the headphone or the sound generating unit 100, or structural design requirements of various components.

In a case where the first sound outlet 112-1 and the second sound outlet 112-2 are staggered, by designing a size, a shape, a specific acoustic impedance, or the like of the first sound outlet 112-1 and the second sound outlet 112-2, it may be ensured that the peak resonance frequency of the second resonance peak of the frequency response curve of the sound output from the first sound outlet 112-1 is located in a relatively high-frequency band, and the peak resonance frequency of the resonance peak of sound output from the second sound outlet 112-2 is lower than the peak resonance frequency of the second resonance peak of the sound output from the first sound outlet 112-1, thereby allowing the headphone to have a relatively flat output within a relatively wide frequency band range.

By way of example, an acoustic resistance mesh (e.g., one or more forms of acoustic resistance mesh among a steel mesh, a gauze mesh, and a waterproof and breathable membrane) may be disposed at the second sound outlet 112-2. The acoustic resistance mesh may be disposed in the second acoustic cavity 111-2 and cover the second sound outlet 112-2. By reducing the sound pressure level of the sound output from the second sound outlet 112-2 through the acoustic resistance mesh, a peak-valley suppression for the second resonance peak is formed, which may both ensure a relatively large output in a low-frequency band and avoid the sound output from the second sound outlet 112-2 from affecting the sound output from the first sound outlet 112-1, thereby ensuring the active noise cancellation effect.

Due to process limitations in an actual processing and production process, and component design or appearance design requirements of the headphone, a size of the first sound outlet 112-1 and the second sound outlet 112-2 may be different, which may affect the output of the headphone, thereby further affecting the active noise cancellation effect of the headphone against relatively large ambient noise in an open-ear scenario.

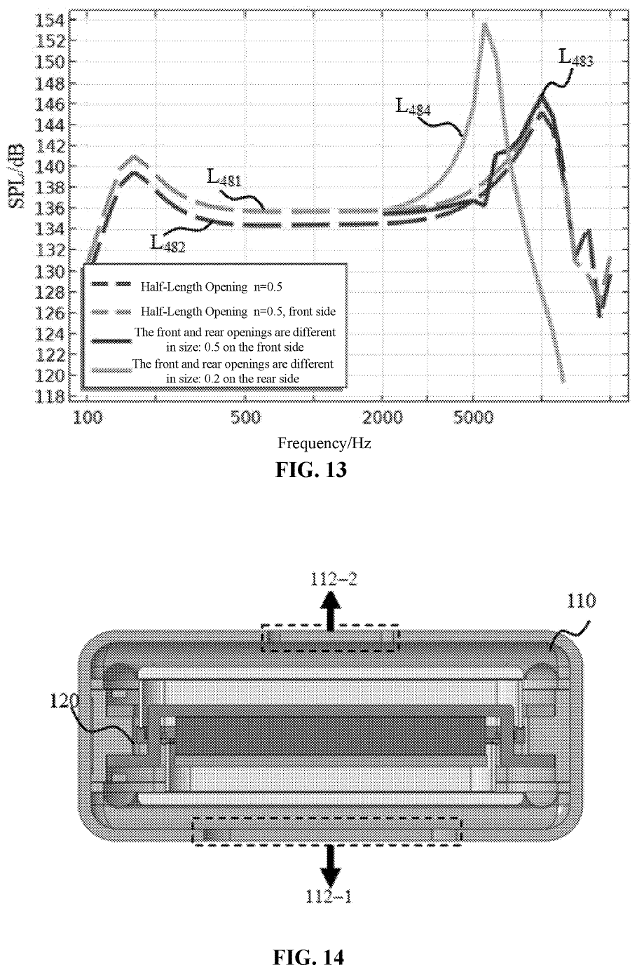

FIG. 13 is a schematic diagram illustrating frequency response curves of the sound generating unit 100 corresponding to the first sound outlet 112-1 and the second sound outlet 112-2 of different sizes according to some embodiments of the present disclosure. It should be noted that the data measured in FIG. 13 is obtained under a condition where the first sound outlet 112-1 and the second sound outlet 112-2 are single holes with the same shape (e.g., a short side dimension of a sound outlet is half of a long side dimension), and are disposed coaxially.

In FIG. 13, the curve L481 represents a frequency response curve at the first sound outlet 112-1 when a ratio of a long side dimension of the first sound outlet 112-1 and the second sound outlet 112-2 to a long side dimension of a corresponding surface of the first housing 110 is 0.5; the curve L482 represents a frequency response curve at the second sound outlet 112-2 when a ratio of the long side dimension of the first sound outlet 112-1 and the second sound outlet 112-2 to a long side dimension of a corresponding surface of the first housing 110 is 0.5; the curve L483 represents a frequency response curve at the first sound outlet 112-1 when a ratio of the long side dimension of the first sound outlet 112-1 to the long side dimension of the corresponding surface of the first housing 110 is 0.5, and a ratio of the long side dimension of the second sound outlet 112-2 to the long side dimension of the corresponding surface of the first housing 110 is 0.2; and the curve L484 represents a frequency response curve at the second sound outlet 112-2 when a ratio of the long side dimension of the first sound outlet 112-1 to the long side dimension of the corresponding surface of the first housing 110 is 0.5, and a ratio of the long side dimension of the second sound outlet 112-2 to the long side dimension of the corresponding surface of the first housing 110 is 0.2. The sound outlets with different long side dimensions have the same width dimension.

As shown in FIG. 13, compared to the curve L481 and the curve L482, when the size of the first sound outlet 112-1 is greater than the size of the second sound outlet 112-2, the high-frequency resonance peak of the curve L484 significantly shifts to a lower frequency, while the high-frequency resonance peaks of the curve L481, the curve L482, and the curve L483 are located near 10 kHz, and the high-frequency resonance peak of the curve L484 is located near 5 kHz; the curve L483 has a trough near 6 kHz, affecting the output of the sound generating unit 100. When the size of the first sound outlet 112-1 is equal to the size of the second sound outlet 112-2, the trends of the curve L481 and the curve L482 are substantially the same, and the consistency is good, indicating that the output effect of the sound generating unit 100 is improved.

Based on this, in some embodiments, the sizes of the first sound outlet 112-1 and the second sound outlet 112-2 are set to be the same, which facilitates ensuring that the sound generating unit 100 has a flat frequency response curve and the phase curve with small variations within a wide frequency band range, thereby enhancing the effect of the open-ear headphone in performing active noise cancellation within a wider frequency band range.

In other embodiments, referring to FIG. 14, in order to meet the design needs, appearance requirements, or the like, of the various components of the open-ear headphone, when it is necessary to set the sizes of the first sound outlet 112-1 and the second sound outlet 112-2 to be different, the size of the first sound outlet 112-1 may be set to be greater than the size of the second sound outlet 112-2, so as to allow the peak resonance frequency of the resonance peak of the sound output from the first sound outlet 112-1 to be located in a higher frequency band. In this case, the peak resonance frequency of the resonance peak of the sound output from the second sound outlet 112-2 may be less than the peak resonance frequency of the resonance peak of the sound output from the first sound outlet 112-1.

When the size of the first sound outlet 112-1 is different from the size of the second sound outlet 112-2, an acoustic resistance mesh may also be disposed at the second sound outlet 112-2. The acoustic resistance mesh may be disposed in the second acoustic cavity 111-2 and cover the second sound outlet 112-2. By means of the acoustic resistance mesh, the sound pressure level of the sound output from the second sound outlet 112-2 is reduced, thereby forming a trough suppression for the high-frequency resonance peak of the sound. This can not only ensure a larger output in a low-frequency band, but also avoid the sound output from the second sound outlet 112-2 affecting the sound output from the first sound outlet 112-1, thereby ensuring the active noise cancellation effect.

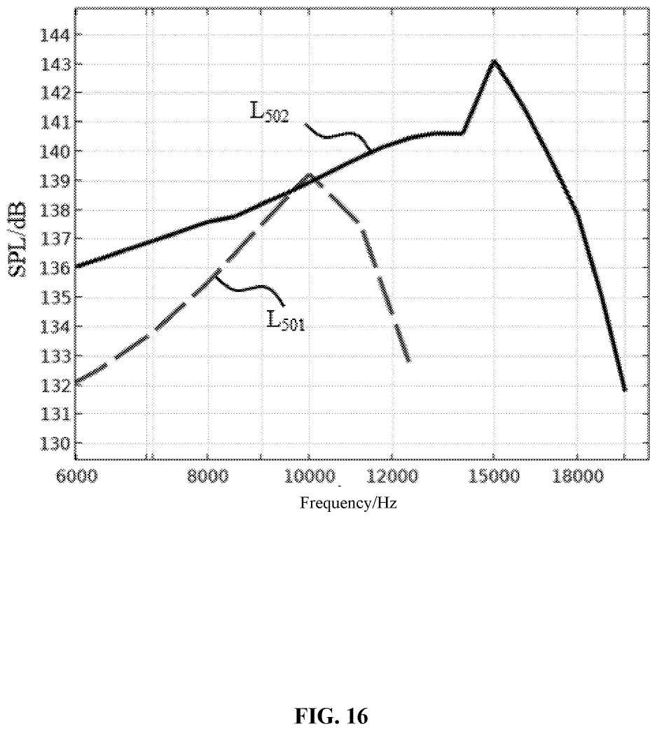

Referring to FIG. 15A, FIG. 15B, and FIG. 16; FIG. 15A and FIG. 15B are schematic diagrams illustrating sound outlets with different centroids according to some embodiments of the present disclosure, and FIG. 16 is a schematic diagram illustrating frequency response curves of a loudspeaker corresponding to sound outlets with different shapes according to some embodiments of the present disclosure. In FIG. 16, the curve L501 represents the frequency response curve of the sound generating unit 100 corresponding to the sound outlet with the single concentrated opening as shown in FIG. 15A, and the curve L502 represents the frequency response curve of the sound generating unit 100 corresponding to the sound outlet with a single non-concentrated opening (e.g., an annular opening) as shown in FIG. 15B.

It should be noted that the opening areas of the sound outlet represented by the curve L501 and the sound outlet represented by the curve L502 are the same (that is, the opening ratios are the same), and the opening positions are the same (that is, the positions of the centers of the corresponding equivalent hole portions are the same). The calculation formula for the opening ratio is a ratio of the opening area of the sound outlet to the area of the corresponding housing sidewall of the first housing 110 (e.g., the area ratio of the first sound outlet 112-1 to the inside wall 110a). The single concentrated opening and the single non-concentrated opening may both be understood as adopting a single-hole structure for the corresponding sound outlet.

As shown in FIG. 16, compared to the curve L501, the high-frequency resonance peak of the curve L502 shifts to a higher frequency, indicating that the design of the single non-concentrated opening can make the resonance frequency of the corresponding acoustic cavity be located at a higher frequency. Therefore, in some embodiments, referring to FIG. 15B, the first sound outlet 112-1 or the second sound outlet 112-2 may adopt the single-hole structure in the form of the single non-concentrated opening. Compared to the sound outlet in the form of the single concentrated opening, this may cause the position of the peak resonance frequency of the resonance peak of the sound output from the sound outlet to be located in a higher frequency band, thereby being more beneficial for the headphone to have a flatter acoustic output within a wider frequency band range, and improving the active noise cancellation effect of the open-ear headphone.

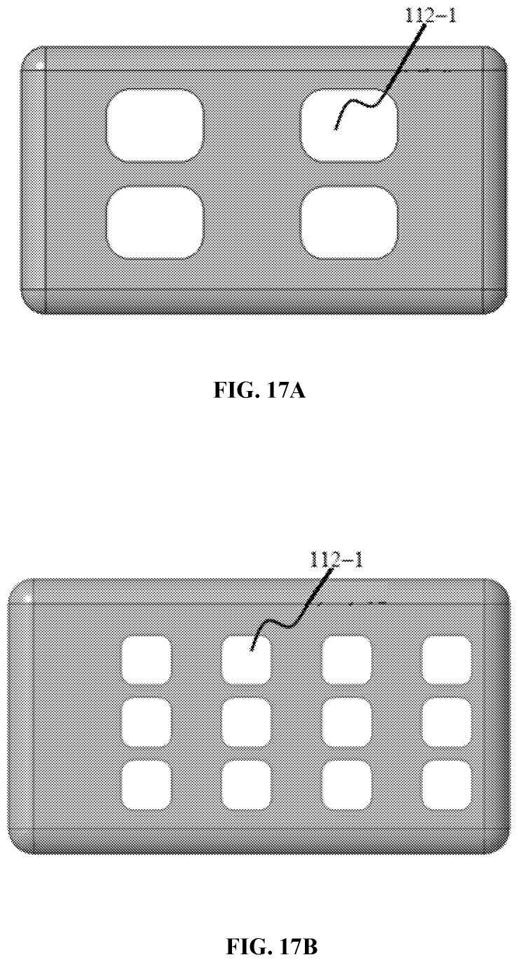

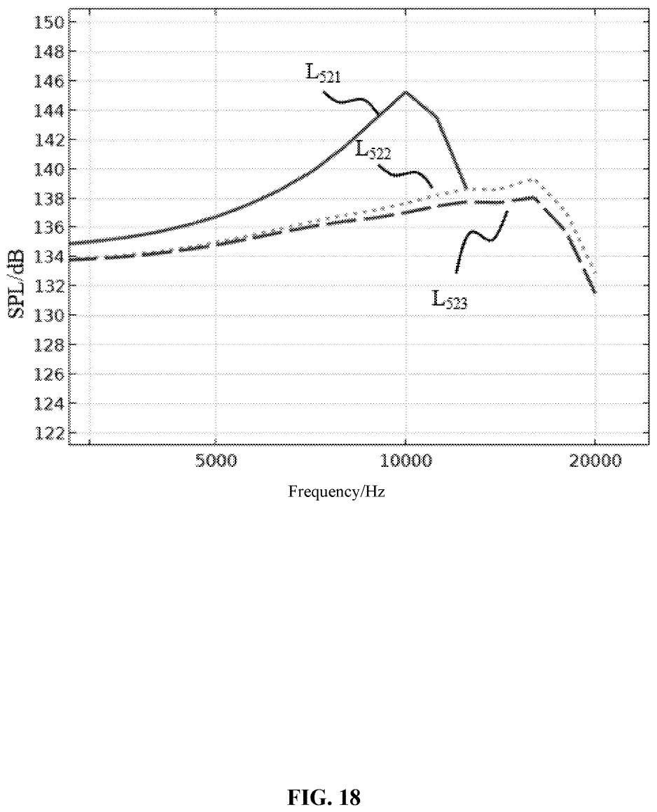

Referring to FIG. 17A, FIG. 17B, and FIG. 18; FIG. 17A and FIG. 17B are schematic diagrams illustrating sound outlets with different numbers according to some embodiments of the present disclosure. The total opening areas of the sound outlets shown in FIG. 17A and FIG. 17B are the same, that is, the opening ratios are the same. FIG. 18 is a schematic diagram illustrating frequency response curves of a loudspeaker corresponding to sound outlets with different opening shapes and different numbers according to some embodiments of the present disclosure. In FIG. 18, the curve L521 represents a frequency response of the sound generating unit 100 corresponding to the sound outlet being the single concentrated opening, with an opening ratio of 0.25; the curve L522 represents a frequency response of the sound generating unit 100 corresponding to the sound outlet being the non-single concentrated opening and a large mesh opening as shown in FIG. 17A, with an opening ratio of 0.2178; the curve L523 represents a frequency response of the sound generating unit 100 corresponding to the sound outlet being the non-single concentrated opening and a small mesh opening as shown in FIG. 17B, with an opening ratio of 0.1657.

Referring to FIG. 18, comparing curves L521, L522, and L523, as the size of a single sound outlet decreases and the number of sound outlets increases, the high-frequency resonance peak of the corresponding curves gradually increases. Therefore, in some embodiments, the sound outlet (e.g., the first sound outlet 112-1) may be non-single concentrated opening as shown in FIG. 17A and FIG. 17B, that is the sound outlet may adopt the porous structure composed of a plurality of micro-holes arranged in an array. This can not only make the position of the high-frequency peak of the loudspeaker 120 higher, but also significantly increase the effective area of sound output, ensuring the active noise cancellation effect, while also being capable of meeting the appearance design requirements of the sound generating unit 100 or the open-ear headphone.

Referring to FIG. 18, comparing curves L521, L522, and L523, as the size of a single sound outlet decreases and the number of sound outlets increases, the output sound pressure level of a corresponding curve in a high frequency band decreases. When the opening ratio is certain, if the size of a single sound outlet is too small, although it can increase the total number of sound outlets, allowing the high-frequency resonance peak to increase, it will also increase the acoustic resistance of the sound outlet, thereby affecting the output sound pressure level. Therefore, to ensure the output sound pressure level of the open-ear headphone, when the sound outlet (e.g., the first sound outlet 112-1) adopts a porous structure in the form of non-single concentrated opening, that is, when the sound outlet is a porous structure composed of a plurality of micro-holes arranged in an array, the diameter of a single micro-hole may be no less than 0.2 mm.

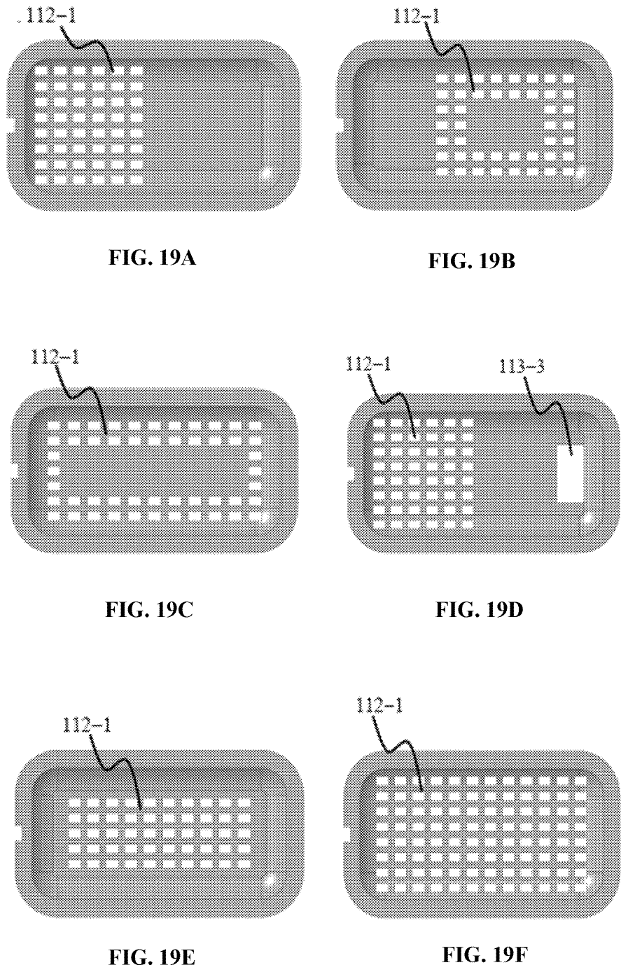

Referring to FIG. 19A to FIG. 19F, FIG. 19A to FIG. 19F are schematic diagrams illustrating sound outlets with different distributions of non-single concentrated opening according to some embodiments of the present disclosure. FIG. 19A represents the sound outlets with the non-single concentrated opening distributed on one side of the housing sidewall corresponding to the first housing 110 in the long axis direction, with an opening ratio of 0.15; FIG. 19B represents the sound outlets with the non-single concentrated opening annularly distributed on one side of the housing sidewall corresponding to the first housing 110 in the long axis direction, with an opening ratio of 0.15; FIG. 19C represents the sound outlets with the non-single concentrated opening annularly distributed on the entire surface of the housing sidewall corresponding to the first housing 110, with an opening ratio of 0.15; FIG. 19D represents the sound outlets with the non-single concentrated opening annularly distributed on one side of the housing sidewall corresponding to the first housing 110 in the long axis direction, and the other side of the corresponding housing sidewall in the long axis direction is provided with a pressure relief hole, the opening ratio of the sound outlet is 0.15, and the opening ratio of the pressure relief hole is 0.0375; FIG. 19E represents the sound outlets with the non-single concentrated opening distributed in the central region of the housing sidewall corresponding to the first housing 110, with an opening ratio of 0.15; and FIG. 19F represents the sound outlets with the non-single concentrated opening distributed on the entire surface of the housing sidewall corresponding to the first housing 110, with an opening ratio of 0.30. In this case, the first sound outlet 112-1 and the second sound outlet 112-2 may be designed to be aligned, or may be designed to be staggered.

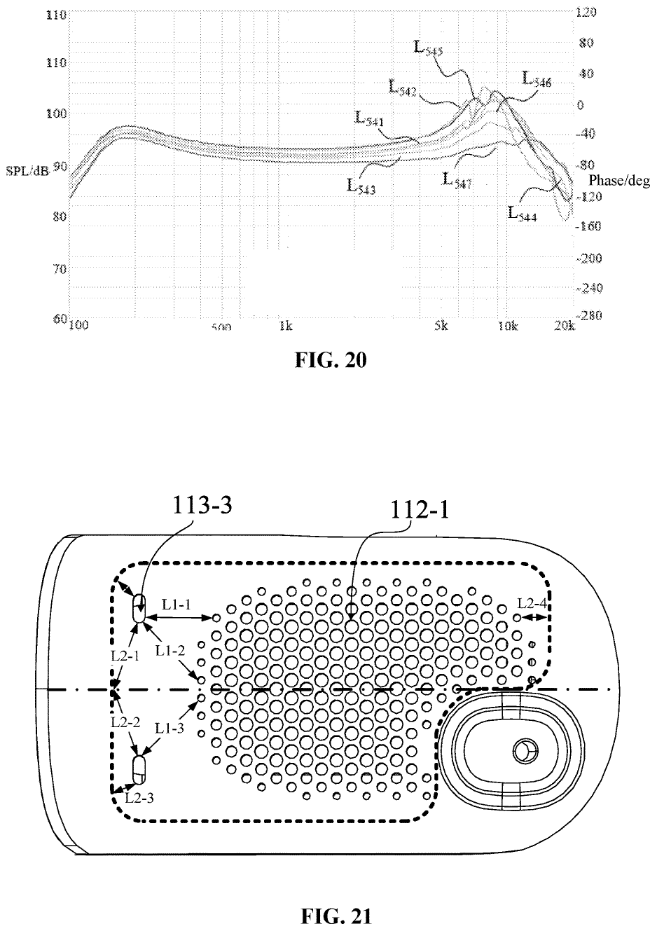

Referring to FIG. 20, FIG. 20 is a schematic diagram illustrating frequency response curves of the sound generating unit 100 corresponding to sound outlets with different distributions of the non-single concentrated openings according to some embodiments of the present disclosure. The curve L541 corresponds to the sound outlets with the non-single concentrated opening annularly distributed on the entire surface of the housing sidewall corresponding to the first housing 110, with an opening ratio of 0.15. The curve L542 corresponds to the sound outlets shown in FIG. 19B. The curve L543 corresponds to a full opening of the corresponding housing sidewall of the first housing 110, with an opening ratio of 1. The curve L544 corresponds to the sound outlets shown in FIG. 19D. The curve L545 corresponds to the sound outlets shown in FIG. 19E. The curve L546 corresponds to the sound outlets shown in FIG. 19F. The curve L547 corresponds to the loudspeaker 120 without the first housing 110.

Referring to FIG. 20, comparing the curve L546 and the curve L543, the positions of the high-frequency peaks are substantially the same, both being approximately at 8.3 kHz. Comparing the curves L541, L542, L544, L545, and the curve L543, the corresponding frequencies of the high-frequency peaks of the curves L541, L542, L544, and L545 with an opening ratio of 0.15 are all lower than the corresponding frequency of the high-frequency peak of the curve L546 with an opening ratio of 0.3. Comparing the curves L541, L542, L544, and L545, all having an opening ratio of 0.15, the high-frequency peak of the curve L544 is located near 8.3 kHz and has an additional resonance peak near 6.5 kHz; the high-frequency peak of the curve L541 is located near 8.3 kHz and has an additional resonance peak near 6.1 kHz; the high-frequency peak of the curve L545 is located near 7.1 kHz; and the high-frequency peak of the curve L542 is located near 6.5 kHz. When the opening ratio of the sound outlet is 0.15, the corresponding high-frequency peaks of the curves L541, L542, L544, and L545 are all higher than 6 kHz.

Based on this, in some embodiments, when the sound outlet is the porous structure composed of the plurality of micro-holes arranged in an array (that is, when the sound outlet adopts the non-single concentrated opening structure), in order to make the open-ear headphone have a flatter output within a wider frequency band range, the opening ratio of the sound outlet may be no less than 0.1. It may also be understood that, on the reference plane perpendicular to the thickness direction, an area ratio of a projection of the first sound outlet 112-1 or the second sound outlet 112-2 in a projection of the inside wall 110a is no less than 10%.

For example, when the opening ratio of the sound outlet is 0.15, the corresponding high-frequency peaks of the curves L541, L542, L544, and L545 are all higher than 6 kHz. In this case, the open-ear headphone has a flatter output within a wider frequency band range, allowing the open-ear headphone to have a better active noise cancellation effect. Furthermore, the opening ratio of the sound outlet may be no less than 0.3. This may further cause the open-ear headphone to have a flatter output within an even wider frequency band range, causing the high-frequency peak of frequency response output from the sound outlet to be higher than 8 kHz.

In the wearing state, because the first sound outlet 112-1 is located on a side close to the ear canal 11, and is limited by factors such as an opening size of the first sound outlet 112-1 and a covering area relative to the first acoustic cavity 111-1, a portion of sounds generated by the loudspeaker 120 (specifically, the first diaphragm 121-1) in the first acoustic cavity 111-1 may be obstructed by a housing sidewall of the first housing 110 (e.g., a portion of the inside wall 110a not provided with the first sound outlet 112-1) and cannot be directly output through the first sound outlet 112-1. This may cause standing waves to be formed in the first acoustic cavity 111-1, which may lead to a forward shift of the peak resonant frequency of the second resonant peak (i.e., a shift to a low-frequency band), thereby affecting the active noise cancellation performance of the headphone within a wide frequency range.

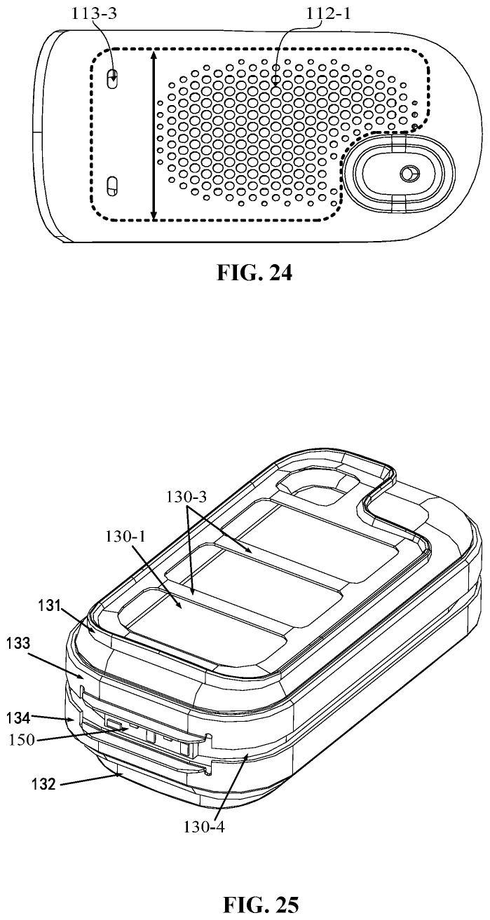

Therefore, in some embodiments, referring to FIG. 6, FIG. 19D, FIG. 21, and FIG. 24, the inside wall 110a is also provided therethrough with a sound tuning hole 113-3, which communicates with the first acoustic cavity 111-1. Based on the communication relationship between the first sound outlet 112-1, the sound tuning hole 113-3, and the first acoustic cavity 111-1, the peak resonance frequency of the second resonance peak of the sound output from the first sound outlet 112-1 to the outside of the first housing 110 may be adjusted by means of the sound tuning hole 113-3 (e.g., the peak resonance frequency of the second resonance peak is no less than 1 kHz). In this case, the first sound outlet 112-1 may be a single-hole structure (e.g., a single concentrated opening structure), or the first sound outlet 112-1 may be the porous structure (that is, a non-single concentrated opening structure).

Specifically, a majority of the sound generated by the loudspeaker 120 in the first acoustic cavity 111-1 is output through the first sound outlet 112-1, while a minority of the sound may be output through the sound tuning hole 113-3, thereby minimizing the formation of standing waves in the first acoustic cavity 111-1. This allows the peak resonant frequency of the second resonant peak of the frequency response curve of the sound output through the first sound outlet 112-1 to shift as much as possible to a high-frequency band, achieving an adjustment of the peak resonant frequency of the resonant peak, and ultimately allowing the headphone to have a relatively flat output within a wider frequency range, which facilitates the active noise cancellation of the headphone within the wide frequency range. Meanwhile, it is also beneficial for enhancing the sound pressure level of the sound output from the first sound outlet 112-1, ensuring the user's listening effect.

Considering that different relative positions between the sound tuning hole 113-3 and the first sound outlet 112-1 may affect the output of the loudspeaker 120 or the position of the peak resonance frequency of the resonance peak, referring to FIG. 21, taking the case where both the first sound outlet 112-1 and the sound tuning hole 113-3 adopt the porous structure as an example, L1-X is defined as the minimum distance between any two holes, and L2-X is defined as the minimum distance between the boundary of the first acoustic cavity 111-1 and any hole. It should be noted that the minimum distance here refers to the distance between the contour edges of any two holes, or the distance from the contour edge of any hole to the boundary of the acoustic cavity.

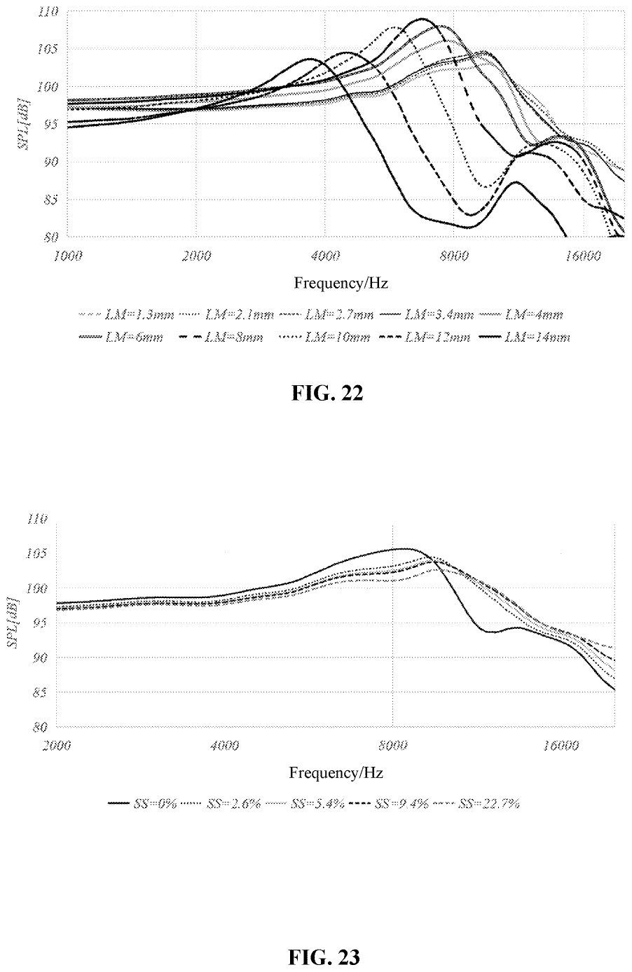

Referring to FIG. 22, FIG. 22 is a schematic diagram illustrating frequency response curves of the sound generating unit 100 corresponding to different L1-X and L2-X according to some embodiments of the present disclosure. In FIG. 6, LM is L1-X or L2-X (that is, LM is the minimum distance between any two holes or the minimum distance from the boundary of the first acoustic cavity 111-1 to any hole).

As shown in FIG. 22, when LM=1.3 mm, the corresponding high-frequency peak is 9.5 kHz; when LM=2.1 mm, the corresponding high-frequency peak is 9.25 kHz; when LM=2.7 mm, the corresponding high-frequency peak is 9 kHz; when LM=3.4 mm, the corresponding high-frequency peak is 8.75 kHz; when LM=4 mm, the corresponding high-frequency peak is 7.75 kHz; when LM=6 mm, the corresponding high-frequency peak is 7.5 kHz; when LM=8 mm, the corresponding high-frequency peak is 6.7 kHz; when LM=10 mm, the corresponding high-frequency peak is 5.8 kHz; when LM=12 mm, the corresponding high-frequency peak is 4.5 kHz; and when LM=14 mm, the corresponding high-frequency peak is 3.65 kHz. As can be seen from FIG. 6 in combination, as LM increases, the corresponding high-frequency peaks sequentially shift to a lower frequency. This also means that the opening area correspondingly decreases, thereby causing the sound pressure level of the sound output from a side of the inside wall 110a to decrease. When LM=14 mm, compared to other smaller LMs, the sound pressure level at 1 kHz decreases by 3 dB, which is an acceptable state.

Therefore, in some embodiments, the minimum distance between any two holes or the minimum distance from the boundary of the first acoustic cavity 111-1 to any hole may be set to be less than or equal to 14 mm. It may also be understood that the minimum distance between the first sound outlet 112-1 and the sound tuning hole 113-3 is less than or equal to 14 mm; the minimum distance from the boundary of the first acoustic cavity 111-1 to the first sound outlet 112-1 is less than or equal to 14 mm; and the minimum distance from the boundary of the first acoustic cavity 111-1 to the sound tuning hole 113-3 is less than or equal to 14 mm. It may also be understood that, when the first sound outlet 112-1 and/or the sound tuning hole 113-3 is the porous structure composed of the plurality of micro-holes arranged in an array, the minimum distance between any two adjacent micro-holes is less than or equal to 14 mm.

In this way, the sound output from the first sound outlet 112-1 can have a relatively flat phase curve at least within a frequency band range before 1 kHz, thereby ensuring that the open-ear headphone has a relatively flat output within a wider frequency band range, so as to facilitate the open-ear headphone in performing active noise cancellation within a wider frequency band range. In addition, as described in the foregoing embodiments, the aperture diameter of the micro-holes may be set to be no less than 0.2 mm.

Further, in some embodiments, any one of the above-mentioned minimum distances may be set to be less than or equal to 10 mm, less than or equal to 8 mm, less than or equal to 6 mm, or less than or equal to 3.4 mm. For example, when the minimum distance is 10 mm, the peak resonance frequency of the second resonance peak may be adjusted to 5.8 kHz; when the minimum distance is 8 mm, the peak resonance frequency of the second resonance peak may be adjusted to 6.7 kHz; when the minimum distance is 6 mm, the peak resonance frequency of the second resonance peak may be adjusted to 7.5 kHz; and when the minimum distance is 3.4 mm, the peak resonance frequency of the second resonance peak may be adjusted to 8.75 kHz. In this way, by means of selecting and setting the minimum distance, the peak resonance frequency of the second resonance peak can be caused to move to a high-frequency band as much as possible, further widening the width of the flat region of the frequency response curve, allowing the open-ear headphone to achieve active noise cancellation within a wider frequency band range.

In some embodiments, the ratio of the total area of the sound tuning hole 113-3 to the total area of the first sound outlet 112-1 may be set to be less than 23%. Specifically, referring to FIG. 23, FIG. 23 is a schematic diagram illustrating frequency response curves of the sound generating unit 100 under different area ratios of the sound tuning hole 113-3 to the first sound outlet 112-1 according to some embodiments of the present disclosure. On a reference plane perpendicular to the thickness direction, the total projection area of the first sound outlet 112-1 on the reference plane is defined as S1; the total projection area of the sound tuning hole 113-3 on the reference plane is defined as S2; and the ratio of the total projection area S2 of the sound tuning hole 113-3 to the total projection area S1 of the first sound outlet 112-1 is defined as SS.

As shown in FIG. 23, as SS gradually increases, the high frequency peak gradually shifts backward, and the sound pressure level of the output sound gradually decreases; an increase in SS means that the opening area of the sound tuning hole 113-3 increases, which may effectively achieve a pressure relief effect, thereby causing the high frequency peak to shift backward. However, at the same time, due to the increase in the total opening area of the sound tuning hole 113-3, the sound leaked through the sound tuning hole 113-3 also increases, thereby causing a decrease in the sound pressure level of the sound output through the first sound outlet 112-1. It can be seen from FIG. 23 that, when SS is from 0% (i.e., the sound tuning hole 113-3 is not provided) to 22.7%, the high frequency peak shifts backward from 8.5 kHz to 9.75 kHz, and at the same time, the sound pressure level of the output sound decreases by 1 dB, which is within an acceptable range.

Therefore, setting the ratio of the total area of the sound tuning hole 113-3 to the total area of the first sound outlet 112-1 to be less than 23% may effectively avoid too much sound leaking from the sound tuning hole 113-3 due to an excessive opening or an excessive area proportion of the sound tuning hole 113-3, thereby causing problems of a decrease in the sound pressure level or a reduction in the volume of the first sound outlet 112-1.

In some embodiments, the ratio of the total area of the sound tuning hole 113-3 to the total area of the first sound outlet 112-1 is set to 22.7%, thereby allowing the peak resonant frequency of the second resonant peak to be adjusted to around 9.75 kHz, further widening the width of the flat region of the frequency response curve of the sound output through the first sound outlet 112-1, so that the headphone may perform active noise cancellation within a wider frequency range.

In some embodiments, referring to FIG. 24, in the wearing state, the sound tuning hole 113-3 is located at a position farther from the ear canal 11 compared to the first sound outlet 112-1. In an open-ear application scenario, because the ambient noise received by the user's ear canal 11 is relatively large, improving the output performance of the headphone helps the headphone perform active noise cancellation for the relatively large ambient noise. Therefore, by configuring the sound tuning hole 113-3 to be at a position farther from the ear canal 11 compared to the first sound outlet 112-1, the sound output through the sound tuning hole 113-3 and the sound output through the first sound outlet 112-1 may undergo far-field destructive interference, to reduce sound leakage of the headphone and ensure a listening effect for the user.

For example, on a reference plane perpendicular to the thickness direction, a length of a projection of the first acoustic cavity 111-1 in the long axis direction is not less than a width thereof in the short axis direction. For example, the projection shape of the first acoustic cavity 111-1 may be a rectangle where the length is greater than the width, or the projection shape of the first acoustic cavity 111-1 may be a square where the length is equal to the width or a circle. The projection of the first acoustic cavity 111-1 on the reference plane is divided into a first region and a second region along a length direction. A ratio of a length of the first region in the long axis direction to a length of the projection of the first acoustic cavity 111-1 in the long axis direction may be set to be less than 40%, e.g., 38.3%. A projection of the sound tuning hole 113-3 on the reference plane is located in the first region, and a projection of the first sound outlet 112-1 on the reference plane is located in the second region.

In this manner, by configuring the sound tuning hole 113-3 and the first sound outlet 112-1 in different regions of the inside wall 110a corresponding to the first acoustic cavity 111-1, it is possible to both ensure that the sound tuning hole 113-3 is located at a position farther from the ear canal compared to the first sound outlet 112-1 in the wearing state, and distinguish between the sound tuning hole 113-3 and the first sound outlet 112-1 when the sound tuning hole 113-3 adopts an array of micro-holes or a large-area concentrated opening and is relatively close to the first sound outlet 112-1. For example, in the length direction or a diameter direction of the first acoustic cavity 111-1, holes within a region with a proportion of 38.3% from the boundary of the first acoustic cavity 111-1 may be regarded as the sound tuning hole 113-3.

It should be noted that a bold dashed line in FIG. 21 and FIG. 24 represents a projection boundary of the first acoustic cavity 111-1 on the reference plane. A bold solid line with an arrow in FIG. 24 represents an approximate boundary between the first region and the second region in the projection shape of the first acoustic cavity 111-1, wherein a region located to a left side of the bold solid line represents the first region, and a region located to a right side of the bold solid line represents the second region.

In some embodiments, referring to FIG. 21 and FIG. 24, when the first sound outlet 112-1 is a porous structure composed of a plurality of micro-holes arranged in an array, an aperture diameter of a micro-hole located in a region of the inside wall 110a directly facing the ear canal 11 in the wearing state is set to be larger than an aperture diameter of a micro-hole located in other regions of the inside wall 110a. Illustratively, among the plurality of micro-holes of the sound outlet 112-1, the aperture diameter of the micro-holes close to the boundary of the first acoustic cavity 111-1 and the sound tuning hole 113-3 is less than the aperture diameter of the micro-holes at other positions. In this manner, by differentially setting the aperture diameters of the plurality of micro-holes in the first sound outlet 112-1, the sound pressure level of the sound output by the headphone from a portion directly facing the ear canal 11 may be increased, thereby ensuring the user's listening effect.

As provided in some preceding embodiments, by disposing an acoustic resistance mesh at the second sound outlet 112-2, the sound pressure level of the sound output from the second sound outlet 112-2 may be reduced, thereby forming peak-valley suppression for the high-frequency resonance peaks. While ensuring that the headphone has a large output in a low-frequency band, it may also avoid the sound output from the second sound outlet 112-2 affecting the sound output from the first sound outlet 112-1, thereby improving the active noise reduction effect. In some embodiments, an acoustic resistance mesh may also be disposed at the first sound outlet 112-1. For example, the acoustic resistance mesh may be disposed in the first acoustic cavity 111-1 and configured to cover the first sound outlet 112-1 and the sound tuning hole 113-3. For ease of differentiation and description, the acoustic resistance mesh at the second sound outlet 112-2 refers to the second acoustic resistance mesh, and the acoustic resistance mesh at the first sound outlet 112-1 refers to the first acoustic resistance mesh. The specific acoustic impedance of the first acoustic resistance mesh is less than the specific acoustic impedance of the second acoustic resistance mesh. For example, the ratio of the specific acoustic impedance of the second acoustic resistance mesh to the specific acoustic impedance of the first acoustic resistance mesh is more than or equal to 10 (e.g., the specific acoustic impedance of the first acoustic resistance mesh is less than 10 Rayl, and the specific acoustic impedance of the second acoustic resistance mesh is greater than 700 Rayl).

Thus, based on the characteristic of the smaller specific acoustic impedance of the first acoustic resistance mesh, the influence on the sound output from the first sound outlet 112-1 may be minimized, thereby ensuring the sound output effect of the sound generating unit 100 on the side close to the ear canal 11. Furthermore, based on the first acoustic resistance mesh and the second acoustic resistance mesh, good dustproof, waterproof, or the like effects may be provided in the sound generating unit 100.

As described in some preceding embodiments, the sound generating assembly may include the loudspeaker 120 and a limiting assembly 130. The limiting assembly 130 is configured to position and limit the loudspeaker 120 within the first housing 110. In addition, the limiting assembly 130 may also be configured to cooperate with the loudspeaker 120 and corresponding housing sidewalls of the first housing 110 to form an acoustic cavity. Specifically, the loudspeaker 120 is spaced apart from the inside wall 110a and the outside wall 110b along the vibration direction. The limiting assembly 130 positions and limits the loudspeaker 120 between the inside wall 110a and the outside wall 110b, thereby cooperating with the loudspeaker 120 and the inside wall 110a to form the first acoustic cavity 111-1, and cooperating with the loudspeaker 120 and the outside wall 110b to form the second acoustic cavity 111-2.

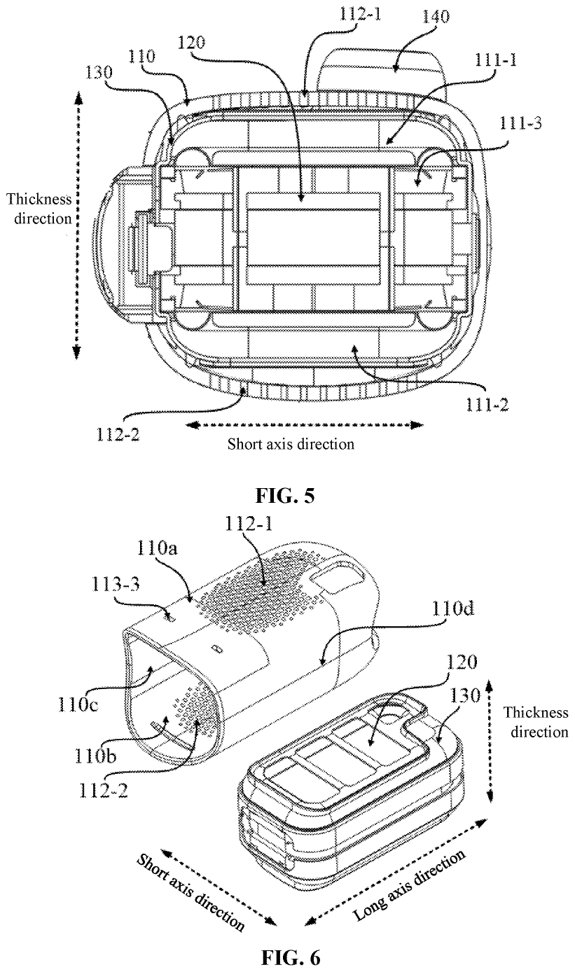

The limiting assembly 130 not only affects the structural relationship between the loudspeaker 120 and the first housing 110, but also affects the structure of the acoustic cavity, thereby further affecting the active noise reduction of the headphone in a wider frequency band range. Therefore, descriptions are mainly provided below for the limiting assembly 130 and related structures thereof with reference to FIGS. 5 to 6 and FIGS. 25 to 27.

In some embodiments, with reference to FIG. 5, the loudspeaker 120 includes the first diaphragm 121-1 and the second diaphragm 121-2 which are vertically spaced apart in the vibration direction. The limiting assembly 130 is connected between the loudspeaker 120 and the first housing 110. Exemplarily, a portion of the limiting assembly 130 connects the loudspeaker 120 and the inside wall 110a of the first housing 110, and another portion of the limiting assembly 130 connects the loudspeaker 120 and the outside wall 110b of the first housing 110.

When the loudspeaker 120, together with the limiting assembly 130, is installed within the first housing 110, the connection relationship between the limiting assembly 130 and the housing sidewalls of the first housing 110 may be utilized (it should be noted that the connection may refer to adhesion, snap fit, elastic abutment, or the like), thereby causing the first diaphragm 121-1 and the inside wall 110a to be relatively disposed in the vibration direction, and cooperating with the loudspeaker 120 and the inside wall 110a to form the first acoustic cavity 111-1 which communicates with the first sound outlet 112-1 and the sound tuning hole 113-3. The limiting assembly 130 is also configured to cause the second diaphragm 121-2 and the outside wall 110b to be relatively disposed in the vibration direction, and cooperate with the loudspeaker 120 and the outside wall 110b to form the second acoustic cavity 111-2 which communicates with the second sound outlet 112-2.

Based on this, with the aid of the limiting assembly 130, the loudspeaker 120 may be firmly limited at a predetermined position within the first housing 110, thereby allowing the loudspeaker 120 and the first housing 110 to form corresponding acoustic cavities, which creates conditions for improving the output performance of the headphone. At the same time, the limiting assembly 130 may also be combined with the loudspeaker 120 to form a functionally complete standalone unit with a relatively complete structure (namely, the sound generating assembly). This is conducive to both the disassembly and maintenance of the sound generating unit 100 and the design of related structures of the first housing 110 (e.g., the sound outlets, the sound tuning hole 113-3, or the like), to meet the need for the headphone to perform active noise reduction in a wider frequency band range.

In some embodiments, the limiting assembly 130 may be sealingly connected between the loudspeaker 120 and the first housing 110. Specifically, a portion of the limiting assembly 130 is sealingly connected to the loudspeaker 120, and another portion of the limiting assembly 130 is sealingly connected to the first housing 110. At the same time, a sealed enclosed structure is formed between the inside wall 110a and the first diaphragm 121-1, and a sealed enclosed structure is formed between the outside wall 110b and the second diaphragm 121-2. Illustratively, the limiting assembly 130 is an annular structure with sound guiding holes provided at a center. Along the vibration direction, the sound guiding holes of the limiting assembly 130, the first sound outlet 112-1, the second sound outlet 112-2, the first diaphragm 121-1, and the second diaphragm 121-2 may at least partially overlap.

In some embodiments, the limiting assembly 130 and the loudspeaker 120 are fixedly connected to form an integral structure. One end of the limiting assembly 130 close to the inside wall 110a along the vibration direction elastically abuts against the inside wall 110a, and another end close to the outside wall 110b elastically abuts against the outside wall 110b. As a result, the limiting assembly 130 may be combined with the loudspeaker 120 to form a functional structural body relatively independent of the first housing 110, which is beneficial for reducing the difficulty of disassembly and assembly of the sound generating unit 100.

In some embodiments, with reference to FIGS. 25 to 27, the limiting assembly 130 includes a second housing, a first sealing ring 131, and a second sealing ring 132. The loudspeaker 120 is disposed inside the second housing and sealingly cooperates with the second housing to connect. For convenience of distinction and description, a housing wall of the second housing that is spaced apart from the inside wall 110a along the vibration direction refers to a first transverse sidewall, a housing wall of the second housing that is spaced apart from the outside wall 110b along the vibration direction refers to a second transverse sidewall, and a housing wall of the second housing that encloses around the vibration direction refers to a longitudinal sidewall. It may also be understood that the first transverse sidewall faces the inside wall 110a (or the loudspeaker 120) and is disposed inside the first acoustic cavity 111-1, the second transverse sidewall faces the outside wall 110b (or the loudspeaker 120) and is disposed inside the second acoustic cavity 111-2, and the loudspeaker 120 is located between the first transverse sidewall and the second transverse sidewall along the vibration direction. In addition, one end of the first sealing ring 131 in the vibration direction is fixed to the first transverse sidewall, and another end abuts against the inside wall 110a. One end of the second sealing ring 132 in the vibration direction is fixed to the second transverse sidewall, and another end abuts against the outside wall 110b.

The sound guiding hole of the limiting assembly 130 includes a first sound guiding hole 130-1 disposed through the first transverse sidewall and the first sealing ring 131, and a second sound guiding hole 130-2 disposed through the second transverse sidewall and the second sealing ring 132. The first sound guiding hole 130-1 communicates the first acoustic cavity 111-1. That is, it may be understood that the first acoustic cavity 111-1 includes a cavity space between the first transverse sidewall and the inside wall 110a, and a cavity space between the first transverse sidewall and the loudspeaker 120 (e.g., the first diaphragm 121-1). The two cavity spaces located on both sides of the first transverse sidewall are connected through the first sound guiding hole 130-1 to form the complete first acoustic cavity 111-1. Similarly, the second sound guiding hole 130-2 communicates the second acoustic cavity 111-2.

Based on this, by utilizing the second housing as a peripheral protection structural component for the loudspeaker 120, a relatively stable structural assembly space may be provided for the loudspeaker, which not only facilitates building and forming the sound generating assembly as a complete functional standalone unit, but also is conducive to the miniaturization and lightweight configuration of the sound generating assembly or the sound generating unit 100. For example, the second housing may be made of a metal material, thereby allowing the housing wall of the second housing to be thinner and lighter in weight while ensuring the mechanical strength of the second housing. Concurrently, it is also conducive to designing the internal acoustic structure of the sound generating unit 100, and providing support for active noise reduction or the like.

In some embodiments, on the reference plane perpendicular to the vibration direction, the projections of the sound guiding hole of the limiting assembly 130, the first sound outlet 112-1, the second sound outlet 112-2, the first diaphragm 121-1, and the second diaphragm 121-2 at least partially overlap, to ensure the sound output from the loudspeaker 120 to the outside of the first housing 110.

Exemplarily, in some embodiments, on the reference plane perpendicular to the vibration direction, the projection of the first sound outlet 112-1 falls within the projection of the first sound guiding hole 130-1. Alternatively, in some embodiments, on the reference plane perpendicular to the vibration direction, a projection area of an overlapping region between the projection of the first sound outlet 112-1 and the projection of the first sound guiding hole 130-1 is more than or equal to 80% of the projection area of the projection of the first sound guiding hole 130-1. Such a configuration may cause the air pushed by the diaphragm in the sound guiding hole of the limiting assembly 130 to be smoothly pushed out from the first sound outlet 112-1, thereby ensuring the acoustic output of the loudspeaker 120, and providing support for the peak resonance frequency of the first resonance peak of the sound output from the first sound outlet 112-1 to shift towards a low-frequency band as much as possible, and for the peak resonance frequency of the second resonance peak to shift towards a high-frequency band as much as possible. Preferably, in some embodiments, on the reference plane perpendicular to the vibration direction, a projection of the second sound outlet 112-2 falls within the projection of the second sound guiding hole 130-2. Alternatively, in some embodiments, on the reference plane perpendicular to the vibration direction, a projection area of an overlapping region between the projection of the second sound outlet 112-2 and the projection of the second sound guiding hole 130-2 is more than or equal to 80% of the projection area of the projection of the second sound guiding hole 130-2. Such a configuration may cause the air pushed by the diaphragm in the sound guiding hole of the limiting assembly 130 to be smoothly pushed out from the second sound outlet 112-2, thereby ensuring the acoustic output of the loudspeaker 120.

Similarly, in some embodiments, on the reference plane perpendicular to the vibration direction, the projection of the first diaphragm 121-1 falls within the projection of the first sound guiding hole 130-1. Alternatively, in some embodiments, on the reference plane perpendicular to the vibration direction, a projection area of an overlapping region between the projection of the first diaphragm 121-1 and the projection of the first sound guiding hole 130-1 is more than or equal to 80% of the projection area of the projection of the first diaphragm 121-1. Such a configuration may cause the air pushed by the first diaphragm 121-1 to smoothly enter the sound guiding hole of the limiting assembly 130 when the first diaphragm 121-1 vibrates, thereby ensuring the acoustic output of the loudspeaker 120 with maximum efficiency. Preferably, in some embodiments, on the reference plane perpendicular to the vibration direction, the projection of the second diaphragm 121-2 falls within the projection of the second sound guiding hole 130-2. Alternatively, in some embodiments, on the reference plane perpendicular to the vibration direction, a projection area of an overlapping region between the projection of the second diaphragm 121-2 and the projection of the second sound guiding hole 130-2 is more than or equal to 80% of the projection area of the projection of the second diaphragm 121-2. Such a configuration may cause the air pushed by the second diaphragm 121-2 to smoothly enter the sound guiding hole of the limiting assembly 130 when the second diaphragm 121-2 vibrates, thereby ensuring the acoustic output of the loudspeaker 120 with maximum efficiency.

In addition, with reference to FIG. 5, based on the first sealing ring 131 and the second sealing ring 132, the sound generating assembly may be sealingly fixed in an interior of the first housing 110 (i.e., an accommodating cavity) by means of an interference fit or the like. For example, the first sealing ring 131 elastically abuts against the inside wall 110a, and the second sealing ring 132 elastically abuts against the outside wall 110b. In this way, by utilizing the first sealing ring 131 and the second sealing ring 132, the loudspeaker 120 is sealingly fixed within the first housing 110 from both sides in the vibration direction, thereby sealingly forming the first acoustic cavity 111-1 and the second acoustic cavity 111-2.

It should be noted that the “boundary of the first acoustic cavity 111-1” as described in the preceding embodiments refers to the first sealing ring 131. That is, it may be understood that on a reference plane perpendicular to the vibration direction, a projection of the first sealing ring 131 on the reference plane is the boundary of the first acoustic cavity 111-1.

In some embodiments, a deformation resistance capability of the first sealing ring 131 and the second sealing ring 132 is less than a deformation resistance capability of the second housing. For example, the first sealing ring 131 and the second sealing ring 132 may be made of elastic materials such as silicone rubber, or the like, and the second housing may be made of metal materials such as aluminum alloy, or the like, or other materials such as plastics, or the like, having a material hardness greater than a material hardness of the sealing rings.

Illustratively, the first sealing ring 131 and the second sealing ring 132 are made of elastic materials such as silicone rubber, or the like, and the first sealing ring 131 and the second sealing ring 132 may be integrally formed on the second housing by means of injection molding, overmolding, or the like. In this way, the limiting assembly 130 may be constructed as a relatively independent and complete structural component, which is beneficial for reducing the difficulty of disassembly and assembly of the sound generating assembly and the sound generating unit 100, and enhancing a structural stability of the sound generating assembly and even the sound generating unit 100.

In some embodiments, a joint of the second housing and the first sealing ring 131 (and the second sealing ring 132) is provided with a reinforcing structure. The reinforcing structure may be a sawtooth structure, a hole structure, or the like, disposed on the first transverse sidewall or the second transverse sidewall. By means of the reinforcing structure, a robustness of the connection between the first sealing ring 131 (and the second sealing ring 132) and the second housing is enhanced, to prevent the sealing rings from detaching during disassembly and assembly of the sound generating unit 100.

In some embodiments, with reference to FIGS. 25 to 27, the second housing is a split-type structure, which includes a first cover 133 and a second cover 134. One end of the loudspeaker 120 extends into the first cover 133 along the vibration direction, and another end extends into the second cover 134 along the vibration direction. It may also be understood that the first cover 133 and the second cover 134, respectively, cover or shield two opposite ends of the loudspeaker 120 in the vibration direction. The sidewall of the first cover 133 disposed between the loudspeaker 120 and the inside wall 110a is the first transverse sidewall. The sidewall of the second cover 134 disposed between the loudspeaker 120 and the outside wall 110b is the second transverse sidewall. A sidewall of the first cover 133 and the second cover 134, which surrounds the vibration direction and is fixedly connected to the loudspeaker 120, is a respective longitudinal sidewall.

In one aspect, by utilizing a relative positional relationship among the first cover 133, the second cover 134, and the loudspeaker 120, an accommodating gap 130-4 surrounding the loudspeaker 120 may be formed between the first cover 133 and the second cover 134. The accommodating gap 130-4 may provide a structural assembly space for a circuit board 150, or the like, electrically connected to the loudspeaker 120 and a microphone assembly. For example, a wire, a ribbon cable, a flexible printed circuit (FPC), or the like, may be received and fixed in the accommodating gap 130-4, thereby allowing for full utilization of the structural space, effectively improving the structural compactness of the sound generating assembly, and facilitating miniaturization of the sound generating unit 100 or even the open-ear headphone.

In another aspect, by configuring the first cover 133 and the first seal ring 131 as independent and complete structural components, and configuring the second cover 134 and the second seal ring 132 as independent and complete structural components, the disassembly and assembly of the loudspeaker 120 and the limiting assembly 130 are also facilitated, thereby reducing the difficulty of disassembling and assembling the sound generating assembly.

In some embodiments, the limiting assembly 130 may also omit the second housing, and use the first sealing ring 131 and the second sealing ring 132 to directly establish a sealing connection relationship between the loudspeaker 120 and the first housing 110. For example, the first sealing ring 131 is clamped and fixed between the loudspeaker 120 and the inside wall 110a, and cooperates with the loudspeaker 120 and the inside wall 110a to form the first acoustic cavity 111-1. The second sealing ring 132 is clamped and fixed between the loudspeaker 120 and the outside wall 110b, and cooperates with the loudspeaker 120 and the outside wall 110b to form the second acoustic cavity 111-2. In this case, the first sealing ring 131 and the second sealing ring 132 may be of an annular structure, and the corresponding sound guiding holes may also be formed by providing openings on the first sealing ring 131 and the second sealing ring 132.

In other embodiments, the limiting assembly 130 may also omit the first sealing ring 131 and the second sealing ring 132. The first acoustic cavity 111-1 and the second acoustic cavity 111-2 may be formed by using an interference fit abutment relationship between the second housing (e.g., the first cover 133 and the second cover 134) and the first housing 110 (e.g., the inside wall 110a and the outside wall 110b).

In other embodiments, the limiting assembly 130 may also adopt other suitable structures, as long as it can stably fix the loudspeaker 120 inside the first housing 110, or can cause the loudspeaker 120 to divide the accommodating cavity into the first acoustic cavity 111-1 and the second acoustic cavity 111-2. The details thereof will not be described again herein.

In some embodiments, with reference to FIG. 6, the first housing 110 is provided with an opening structure and a positioning structure (wherein, for ease of distinction and description, the positioning structure refers to the third positioning structure). The opening structure may be formed by the inside wall 110a, an outside wall 110b, an upside wall 110c, and a lowside wall 110d. The opening structure may also be configured to penetrate a lowside wall or a upside wall of the first housing 110 in the short axis direction. That is, the first housing 110 may be formed by splicing and enclosing a plurality of housing sidewalls. For example, the inside wall 110a, the outside wall 110b, the upside wall 110c, and the lowside wall 110d are integrally formed, and the lowside wall and the upside wall are configured to cover the opening structure and jointly form the accommodating cavity of the first housing 110 with the other sidewalls.

The opening structure communicates with the accommodating cavity, and is primarily configured to guide the sound generating assembly into and out of the accommodating cavity, thereby allowing for disassembly and assembly of the sound generating assembly and the first housing 110. The third positioning structure may be disposed in the accommodating cavity. For example, the third positioning structure may include a protrusion structure, a step structure, or the like, disposed on the housing sidewalls (e.g., the inside wall 110a, the outside wall 110b, the upside wall 110c, and the lowside wall 110d), and is primarily configured to abut the limiting assembly 130 to restrict a position of the sound generating assembly within the accommodating cavity, thereby providing support for achieving precise and rapid assembly of the sound generating assembly.

In some embodiments, based on the first transverse sidewall and the first sound guiding hole 130-1, and the second transverse sidewall and the second sound guiding hole 130-2, support may be provided for adjusting acoustic characteristics of corresponding acoustic cavities, such as a resonance frequency, a specific acoustic impedance, and a sound pressure level of sound output from corresponding sound outlets, or the like, to enhance an active noise reduction effect.

Illustratively, the first sound guiding hole 130-1 includes an opening of the first seal ring 131 and an opening of the first transverse sidewall. On a reference plane perpendicular to the vibration direction, a projection of the opening of the first transverse sidewall, a projection of the first sound outlet 112-1, and a projection of the opening of the first seal ring 131 are configured to form a first overlapping region. A proportion of the projection of the opening of the first transverse sidewall in the first overlapping region is greater than a proportion of the projection of the first sound outlet 112-1. For example, on the reference plane, within the first overlapping region, a proportion of a projected area of the opening of the first transverse sidewall may be greater than 30% (e.g., greater than 80%), while a proportion of a projected area of the first sound outlet 112-1 may be between 20% and 30%. Thus, the impact on the sound output due to excessively small opening areas of the first sound guiding hole 130-1 and the second sound guiding hole 130-2 may be minimized.

Preferably, the second sound guiding hole 130-2 includes an opening of the second seal ring 132 and an opening of the second transverse sidewall. On the reference plane perpendicular to the vibration direction, a projection of the opening of the second transverse sidewall, a projection of the second sound outlet 112-2, and a projection of the opening of the second seal ring 132 are configured to form a second overlapping region. A proportion of the projection of the opening of the second transverse sidewall in the second overlapping region is greater than a proportion of the projection of the second sound outlet 112-2. For example, on the reference plane, within the second overlapping region, a proportion of a projected area of the opening of the second transverse sidewall may be greater than 30% (e.g., greater than 80%), while a proportion of a projected area of the second sound outlet 112-2 may be between 20% and 30%. Thus, the impact on sound output due to excessively small opening areas of the first sound guiding hole 130-1 and the second sound guiding hole 130-2 may be minimized.

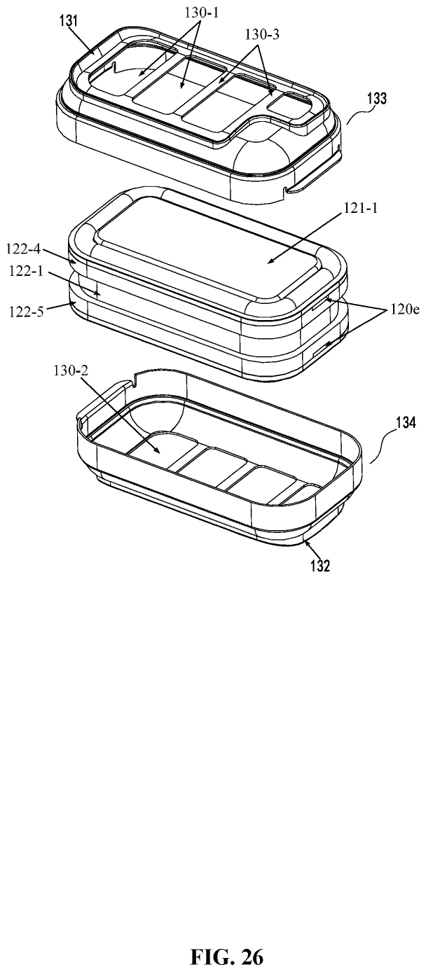

In some embodiments, with reference to FIGS. 25 and 26, the second housing has a rib structure 130-3. The rib structure 130-3 is disposed on the first transverse sidewall and the second transverse sidewall. For ease of distinction and description, the rib structure 130-3 of the first transverse sidewall is defined as a first rib structure, and the rib structure 130-3 of the second transverse sidewall is defined as a second rib structure. The first rib structure is located in the first sound guiding hole 130-1, and the second rib structure is located in the second sound guiding hole 130-2.

The first rib structure may be configured to support and fix the first acoustic resistance mesh in the first acoustic cavity 111-1. For example, the first acoustic resistance mesh covers the first sound guiding hole 130-1 through the first rib structure and is fixed on a side of the first transverse sidewall facing the inside wall 110a. The second rib structure may be configured to support and fix the second acoustic resistance mesh in the second acoustic cavity 111-1. For example, the second acoustic resistance mesh covers the second sound guiding hole 130-2 through the second rib structure and is fixed on a side of the second transverse sidewall facing the outside wall 110b.

In one aspect, the rib structure 130-3 may be utilized to adjust an opening area, a shape, a distribution, or the like, of a corresponding sound guiding hole, to achieve adjustment of acoustic characteristics or sound output of a corresponding acoustic cavity. For example, the rib structure 130-3 may be utilized to configure the corresponding sound guiding hole as a grid hole structure. In another aspect, the acoustic resistance mesh may be fixed on corresponding sidewalls of the rib structure 130-3 and the limiting assembly 130 by means of bonding, welding, or the like, thereby preventing vibration of the acoustic resistance mesh due to air vibration when the loudspeaker 120 is operating, thereby further preventing adverse effects on sound output (e.g., a frequency response curve, or the like), and ensuring the active noise reduction effect.

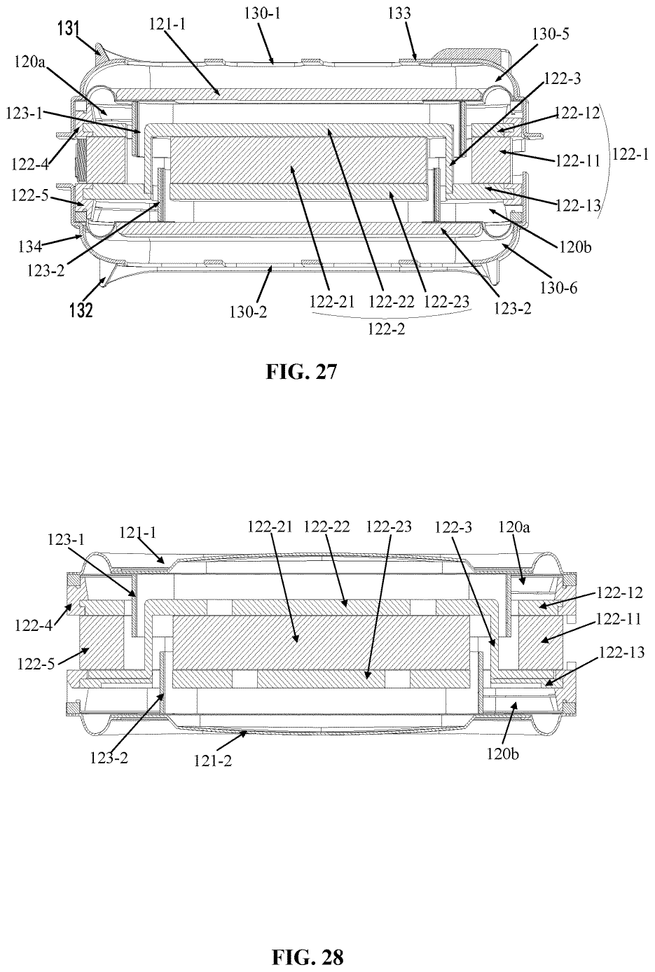

In some embodiments, with reference to FIG. 27, in a case where the second housing has the first transverse sidewall and the second transverse sidewall, the minimum distance between the first transverse sidewall and the center of the main region of the first diaphragm 121-1 is greater than the maximum amplitude of the main region vibrating towards the inside wall 110a, and the minimum distance between the second transverse sidewall and the center of the main region of the second diaphragm 121-2 is greater than the maximum amplitude of the main region vibrating towards the outside wall 110b.

Thus, based on the limitation of the distance between the amplitude of the diaphragm and the corresponding sidewall, it may prevent the diaphragm from colliding with the limiting assembly 130 during vibration, thereby ensuring the sound output effect.

It should be noted that a diaphragm generally includes a main region and a surround region surrounding the main region. The main region is capable of moving in the vibration direction under a driving force generated by the cooperation of a magnetic circuit assembly and a voice coil assembly in the loudspeaker 120, thereby generating sound by pushing or compressing air inside the first housing 110 or the loudspeaker 120. The surround region can undergo elastic deformation as the main region moves, thereby providing an elastic restoring force to the main region.

In addition, in some embodiments where the second housing is omitted or the second housing does not have the first transverse sidewall or the second transverse sidewall, to prevent the diaphragm from colliding with the corresponding housing sidewall in the first housing 110 during vibration, the minimum distance between the center of the main region of the first diaphragm 121-1 and the inside wall 110a along the vibration direction is set to be greater than the maximum amplitude of the main region vibrating towards the inside wall 110a, and the minimum distance between the center of the main region of the second diaphragm 121-2 and the outside wall 110b along the vibration direction is set to be greater than the maximum amplitude of the main region vibrating towards the outside wall 110b.

In some embodiments, referring to FIG. 27, the first transverse sidewall and the second transverse sidewall each have a central portion and an arc portion surrounding the central portion, and an end of the arc portion away from the central portion is connected to the longitudinal sidewall of the second housing. In the vibration direction, the central portion of the first transverse sidewall faces the main region of the first diaphragm 121-1 (in this case, the first sound guiding hole 130-1 may be disposed in the central portion of the first transverse sidewall), and the arc portion of the first transverse sidewall faces the surround region of the first diaphragm 121-1. The central portion of the second transverse sidewall faces the main region of the second diaphragm 121-2 (in this case, the second sound guiding hole 130-2 may be disposed in the central portion of the second transverse sidewall), and the arc portion of the second transverse sidewall faces the surround region of the second diaphragm 121-2.

On one hand, a first avoidance space 130-5 may be formed between the surround region of the first diaphragm 121-1 and the arc portion of the first transverse sidewall. When the first diaphragm 121-1 vibrates, the first avoidance space 130-5 is utilized to avoid the surround region of the first diaphragm 121-1. At the same time, a second avoidance space 130-6 may also be formed between the surround region of the second diaphragm 121-2 and the arc portion of the second transverse sidewall. When the second diaphragm 121-2 vibrates, the second avoidance space 130-6 is utilized to avoid the surround region of the second diaphragm 121-2. In summary, by means of the avoidance space, collision of the surround region of the diaphragm with the limiting assembly 130 during vibration may be prevented, to ensure the sound output effect.

On the other hand, compared to an approach of right-angle connection transition between the transverse sidewall and the longitudinal sidewall, based on the arc portion forming an arc-shaped transition structure between the transverse sidewall and the longitudinal sidewall, the first housing may be configured into a compatible structural form with the second housing, thereby causing the corner region between the adjacent sidewalls of the first housing to tend to be curved and smooth, and avoiding prominent edges and corners. Thus, without affecting the vibration of the diaphragm, it can not only improve the wearing comfort of the sound generating unit 100 or the open-ear headphone, but also improve the appearance of the sound generating unit 100. At the same time, it also facilitates the adaptive design of the outer contour structure of the longitudinal sidewall and the loudspeaker 120. For example, by structurally adapting and fixing the longitudinal sidewall with a bracket in the loudspeaker 120, the loudspeaker 120 is stably positioned and fixed inside the second housing.

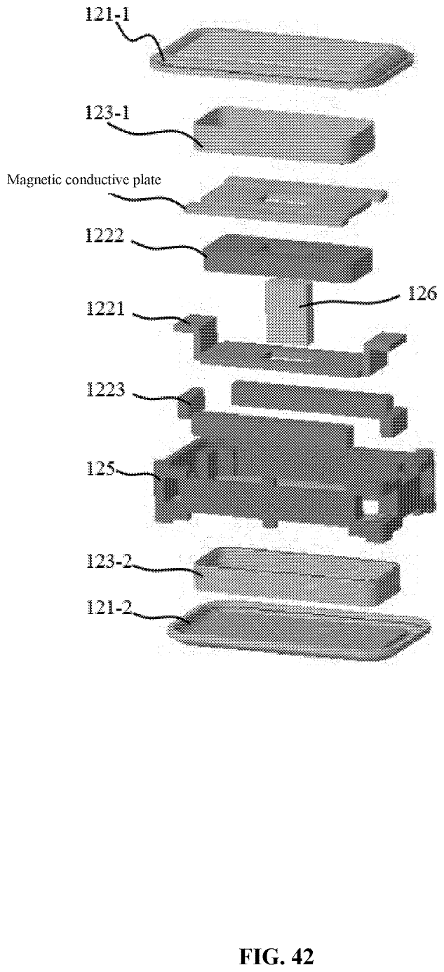

As in some of the foregoing embodiments, the loudspeaker 120 may adopt dual diaphragms. With reference to FIGS. 27, 29, 34, 50 to 51B, 40 to 42, and 45A to 47B, the loudspeaker 120 includes the first diaphragm 121-1, the second diaphragm 121-2, the magnetic circuit assembly, the voice coil assembly, or the like. The first diaphragm 121-1 and the second diaphragm 121-2 are spaced apart and opposite in the vibration direction, and the voice coil assembly and the magnetic circuit assembly are disposed between the first diaphragm 121-1 and the second diaphragm 121-2. At least a portion of the voice coil assembly extends into a magnetic gap of the magnetic circuit assembly, and at least one of the first diaphragm 121-1 and the second diaphragm 121-2 is connected to the voice coil assembly, to drive the voice coil assembly to move the first diaphragm 121-1 and the second diaphragm 121-2 to vibrate synchronously and in the same direction and generate a sound through the cooperation of the magnetic circuit assembly and the voice coil assembly.

Thus, the synchronous and same-direction vibration of the first diaphragm 121-1 and the second diaphragm 121-2 improves the consistency and stability of vibration of the loudspeaker 120, thereby facilitating a shift of a peak resonant frequency of a low-frequency resonant peak (e.g., a first resonant peak) of the sound output from the headphone towards a lower-frequency band, and a shift of a peak resonant frequency of a high-frequency resonant peak (e.g., a second resonant peak) towards a high-frequency band, allowing the headphone to have a relatively flat output over a wider frequency range, and further enhancing the active noise cancellation effect.

Considering that in addition to structural features such as the sound outlet, the sound tuning hole, or the like, the structure and performance of the loudspeaker 120 itself also has a crucial impact on the open-ear headphone in achieving active noise reduction. For example, the first diaphragm 121-1 and the second diaphragm 121-2 may be indirectly connected through the voice coil assembly, or the first diaphragm 121-1 and the second diaphragm 121-2 may be directly connected while being connected through the voice coil assembly. Both approaches can ensure consistency in synchronous and unidirectional vibration of the two diaphragms, thereby providing support for enhancing the active noise reduction effect.

Hereinafter, the related structure of the dual-diaphragm loudspeaker 120 will be mainly described in a case where the first diaphragm 121-1 and the second diaphragm 121-2 are indirectly connected by the voice coil assembly.

In some embodiments, with reference to FIGS. 30 to 38B and FIGS. 44 to 46B, the voice coil assembly includes a first voice coil 123-1 and a second voice coil 123-2, wherein the first voice coil 123-1 and the second voice coil 123-2 are arranged in the vibration direction; one end of the first voice coil 123-1 away from the second voice coil 123-2 is connected to the first diaphragm 121-1, and one end of the second voice coil 123-2 away from the first voice coil 123-1 is connected to the second diaphragm 121-2. The first voice coil 123-1 drives the first diaphragm 121-1 to vibrate, and the second voice coil 123-2 drives the second diaphragm 121-2 to vibrate, thereby causing the first diaphragm 121-1 and the second diaphragm 121-2 to vibrate synchronously and in the same direction.

By way of example, in some embodiments, the first voice coil 123-1 and the second voice coil 123-2 are connected at ends thereof closer to each other in the vibration direction. The voice coil assembly further includes a connection component (for ease of distinction and description, the connection component is defined as a first connection component 127), wherein the first connection component 127 is connected between the first voice coil 123-1 and the second voice coil 123-2. Further, the first voice coil 123-1 and the second voice coil 123-2 may be directly adhered using adhesive, or the like. In this case, the structural connection relationship between the first voice coil 123-1 and the second voice coil 123-2 is equivalent to constructing the integral voice coil assembly, thereby achieving an indirect connection between the first diaphragm 121-1 and the second diaphragm 121-2.

Firstly, by connecting the first diaphragm 121-1 and the second diaphragm 121-2 together using the integral voice coil assembly, the first voice coil 123-1 and the second voice coil 123-2 can share the magnetic circuit assembly. This arrangement, with the cooperation of the magnetic circuit assembly, can not only ensure the consistency of vibration of the first diaphragm 121-1 and the second diaphragm 121-2 (i.e., synchronous and same-direction vibration) but also enhance the driving force of the voice coil assembly, thereby being beneficial for the headphone to have a relatively flat output over a wider frequency range, and ensuring the active noise cancellation effect.

Secondly, when the first diaphragm 121-1 and the second diaphragm 121-2 vibrate synchronously and in the same direction, the volume of a common cavity 111-3 formed between the two does not change with the vibration of the diaphragms. The gas inside the common cavity 111-3 will not only not hinder the vibration of the first diaphragm 121-1 and the second diaphragm 121-2, but can instead act as an associated mass, moving back and forth with the vibration of the two diaphragms. This is beneficial for improving the consistency of vibration of the first diaphragm 121-1 and the second diaphragm 121-2, thereby enhancing the output performance of the headphone, and ensuring the active noise cancellation effect of the headphone.

Thirdly, the connection of the first voice coil 123-1 and the second voice coil 123-2 can not only ensure the consistency of vibration of the first diaphragm 121-1 and the second diaphragm 121-2 but also flexibly adjust a coil winding direction and an operating current direction of the voice coils, so that the voice coil assembly can utilize a magnetic field distribution of the magnetic circuit assembly.

Fourthly, in some scenarios where the waterproof requirements of the headphone are relatively high, for example, when the headphone is a headphone worn during swimming, the first housing 110 often needs to be completely sealed. In this case, if the first diaphragm 121-1 and the second diaphragm 121-2 vibrate in opposite directions, the air inside the common cavity 111-3 formed between the first diaphragm 121-1 and the second diaphragm 121-2 may be difficult to discharge. This may interfere with the vibration of the first diaphragm 121-1 and the second diaphragm 121-2, thereby affecting the output performance of the headphone. Therefore, driving the first diaphragm 121-1 and the second diaphragm 121-2 to vibrate synchronously and in the same direction using the first voice coil 123-1 and the second voice coil 123-2 can provide support for the completely sealed treatment of the first housing 110 or the loudspeaker.

In some embodiments, with reference to FIGS. 27, 29, and 37, the magnetic circuit assembly includes an outer magnetic circuit component 122-1, an inner magnetic circuit component 122-2, and a magnetic circuit connection component 122-3. The outer magnetic circuit component 122-1 surrounds an outer periphery of the inner magnetic circuit component 122-2, and connects the inner magnetic circuit component 122-2 through the magnetic circuit connection component 122-3, thereby forming a magnetic gap of the magnetic circuit assembly enclosed between the outer magnetic circuit component 122-1 and the inner magnetic circuit component 122-2.

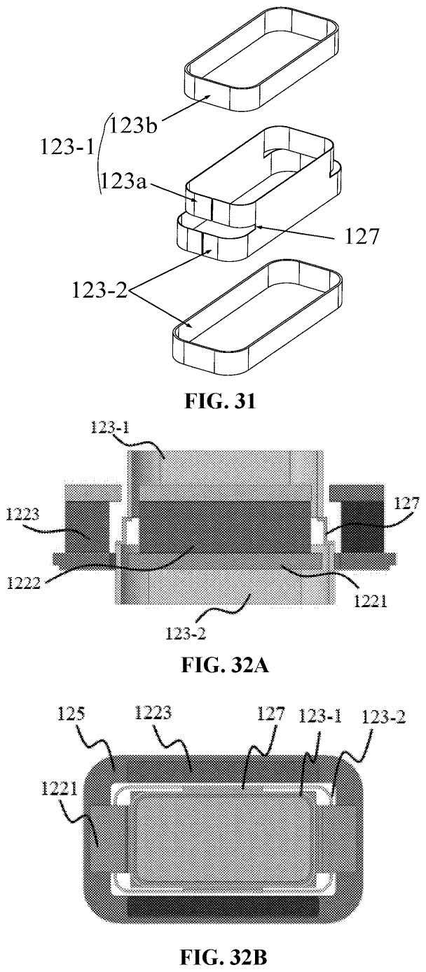

Correspondingly, with reference to FIGS. 30 and 31, the first voice coil 123-1 and the second voice coil 123-2 may adopt an unequal diameter structure. For example, on the reference plane perpendicular to the vibration direction, a gap exists between an orthographic projection of the first voice coil 123-1 and an orthographic projection of the second voice coil 123-2 in the long axis direction or in the short axis direction, thereby causing the first voice coil 123-1 and the second voice coil 123-2 to have a connected portion and a separated portion. Thus, based on the existence of the gap between the two, a bypass channel 123-3 is formed between the first voice coil 123-1 and the second voice coil 123-2, allowing the magnetic circuit connection component 122-3 to pass through the voice coil assembly. It may also be understood that, based on the reference plane perpendicular to the vibration direction, the orthographic projection of the first voice coil 123-1 in the reference plane and the orthographic projection of the second voice coil 123-2 in the reference plane may partially connect or partially overlap, thereby forming the bypass channel 123-3 at a separated region of the first voice coil 123-1 and the second voice coil 123-2.

Illustratively, with reference to FIG. 30, the profile shape of the loudspeaker 120 is non-circular, for example, rectangular, elliptical, or the like. In this case, the sidewalls of the first voice coil 123-1 and the second voice coil 123-2 in the long axis direction may be defined as long side walls, and the sidewalls in the short axis direction may be defined as short side walls. The orthographic projection of the long side wall of the first voice coil 123-1 on the reference plane and the orthographic projection of the long side wall of the second voice coil 123-2 on the reference plane are connected or at least partially overlap, whereas the orthographic projection of the short side wall of the first voice coil 123-1 on the reference plane and the orthographic projection of the short side wall of the second voice coil 123-2 on the reference plane are separated from each other. In this way, the bypass channel 123-3 can be formed between the short side wall of the first voice coil 123-1 and the short side wall of the second voice coil 123-2.

By way of example, the profile shape of the sound generating unit 100 or the loudspeaker 120 is substantially circular. In this case, the first voice coil 123-1 and the second voice coil 123-2 may be connected by the first connection component 127, to achieve partial connection and partial separation between the first voice coil 123-1 and the second voice coil 123-2 by means of a third connection component, in a case where an orthographic projection of the first voice coil 123-1 on the reference plane is a first annular ring, an orthographic projection of the second voice coil 123-2 on the reference plane is a second annular ring, and the first annular ring and the second annular ring have different diameters, thereby forming the bypass channel 123-3.

In this way, by setting the first voice coil 123-1 and the second voice coil 123-2 as an unequal diameter structure with locally unequal sizes, the bypass channel 123-3 formed between the first voice coil 123-1 and the second voice coil 123-2 can provide a bypass space for the magnetic circuit connection component 122-3. This is equivalent to placing the voice coil assembly within the same magnetic gap of the magnetic circuit assembly. This can not only enhance the structural stability of the magnetic circuit assembly itself, and provide support for a rapid combined assembly of the loudspeaker 120, but also be beneficial for reducing assembly difficulty and cost, and avoid the voice coil assembly from contacting the magnetic circuit assembly during movement, which affects the sound output. Meanwhile, the outer magnetic circuit component 122-1 adopting an annular structure surrounding an outer periphery of the inner magnetic circuit component 122-2 can cause the magnetic circuit assembly to have a larger design size, thereby, by increasing the volume of the magnet, the driving force of the voice coil assembly can be increased, improving the sound output performance of the loudspeaker 120.

In some embodiments, with reference to FIG. 30, the overall profile shape of the loudspeaker 120 is configured to be rectangular, racetrack-shaped, or elliptical, or the like, adapted to the profile shape of the first housing 110 or the sound generating unit 100. In this case, the length of the long side wall of the first voice coil 123-1 in the long axis direction is greater than the width of the short side wall of the first voice coil 123-1 in the short axis direction, and the length of the long side wall of the second voice coil 123-2 in the long axis direction is greater than the width of the short side wall of the second voice coil 123-2 in the short axis direction. Meanwhile, the length of the long side wall of the first voice coil 123-1 in the long axis direction may be set to be less than the length of the long side wall of the second voice coil 123-2 in the long axis direction. In this case, the long side wall of the first voice coil 123-1 and the short side wall of the second voice coil 123-2 may be connected by the first connection component 127. In this way, the bypass channel 123-3 may be naturally formed between the short side walls of the two voice coils.

Correspondingly, the length of the magnetic circuit assembly in the long axis direction is greater than the width in the short axis direction, whereas a short side of the outer magnetic circuit component 122-1 and a short side of the inner magnetic circuit component 122-2 are connected via the magnetic circuit connection component 122-3, to configure the magnetic circuit assembly into a structural form with unconnected long sides and connected short sides. That is, the magnetic circuit connection component 122-3 passes through the magnetic gap between the short side of the inner magnetic circuit component 122-2 and the short side of the outer magnetic circuit component 122-1.

On one hand, on the premise of ensuring an integral structural form of the voice coil assembly, by connecting the long side walls of the two voice coils, it can not only enhance the structural stability of the voice coil assembly itself but also improve the consistency of vibration of the first diaphragm 121-1 and the second diaphragm 121-2, creating conditions for ensuring the active noise cancellation effect. On the other hand, the structural form of the magnetic circuit assembly with unconnected long sides and connected short sides is beneficial for forming a strong and uniform magnetic field between the long side of the inner magnetic circuit component 122-2 and the long side of the outer magnetic circuit component 122-1, allowing the magnetic field to pass through the magnetic gap as much as possible, achieving full utilization of the magnetic field, and effectively enhancing the driving force of the voice coil assembly.

In other embodiments, the first voice coil 123-1 and the second voice coil 123-2 may also adopt an equal diameter size. Specifically, on the reference plane perpendicular to the vibration direction, the orthographic projection of the first voice coil 123-1 and the orthographic projection of the second voice coil 123-2 overlap. In this case, on the reference plane parallel to the vibration direction, a gap exists between the orthographic projection of the first voice coil 123-1 and the orthographic projection of the second voice coil 123-2 in the vibration direction, thereby also forming the bypass channel 123-3 between the two based on the existence of the gap. In this case, after the magnetic circuit connection component 122-3 passes through the bypass channel 123-3 along a direction perpendicular to the vibration direction, the two ends of the magnetic circuit connection component 122-3 are respectively connected to the inner magnetic circuit component 122-2 and the outer magnetic circuit component 122-1.

As previously described, the first voice coil 123-1 and the second voice coil 123-2 may be connected by the first connection component 127. In some embodiments, referring to FIG. 31, the first voice coil 123-1 and the second voice coil 123-2 each include a voice coil former 123a and a coil 123b wound around an outer periphery of the voice coil former. For ease of distinction and description, the voice coil former 123a and the coil 123b of the first voice coil 123-1 are respectively defined as a first former and a first coil, and the voice coil former and the coil of the second voice coil 123-2 are respectively defined as a second former and a second coil. The first former and the second former are respectively disposed surrounding the inner magnetic circuit component 122-2 between the inner magnetic circuit component 122-2 and the outer magnetic circuit component 122-1. The first connection component 127 is connected between the first former and the second former, thereby not only achieving a separation of the coils of the two voice coils but also forming the bypass channel 123-3 between the two formers.

Based on the connection relationship between the first former, the second former, and the first connection component 127, the former structure of the voice coil is formed. Due to a higher structural strength and a stronger connection stability of the former structure, the vibration consistency between the first diaphragm 121-1 and the second diaphragm 121-2 can be further ensured, and is applicable to the first voice coil 123-1 and the second voice coil 123-2 of different sizes.

In some embodiments, the voice coil assembly may adopt an integrated former structure. Specifically, referring to FIG. 31, the first connection component 127, the first former, and the second former form the integrated structure, which can effectively prevent the coil from detaching from the former during a vibration process of the voice coil assembly, thereby enhancing the structural stability and integrity of the voice coil assembly itself.

In some embodiments, the voice coil assembly may adopt a split former structure. Specifically, the first former has an extended portion extending beyond the first coil (e.g., the extended portion of the first former is located at a long side of the first voice coil 123-1), and the second former has an extended portion extending beyond the second coil (e.g., the extended portion of the second former is located at a long side of the second voice coil 123-2). The extended portion of the first former and the extended portion of the second former are fixedly connected (e.g., adhered). This can not only achieve the connection of the first voice coil 123-1 and the second voice coil 123-2 and form the former structure, but also be adapted to a size difference between the first voice coil 123-1 and the second voice coil 123-2 to form the bypass channel 123-3. In this case, it may be understood that this is equivalent to constructing the voice coil assembly with the former structure by omitting the first connection component 127. It may also be understood that an extended portion of the first voice coil 123-1 and an extended portion of the second voice coil 123-2 are connected to form the first connection component 127.

In other embodiments, the first former and the second former may also not have an extended portion. In this case, the first connection component 127 may adopt a patch structure, wherein the first connection component 127 is adhered and fixed on the same side of the first former and the second former, thereby also constructing the voice coil assembly with the former structure.

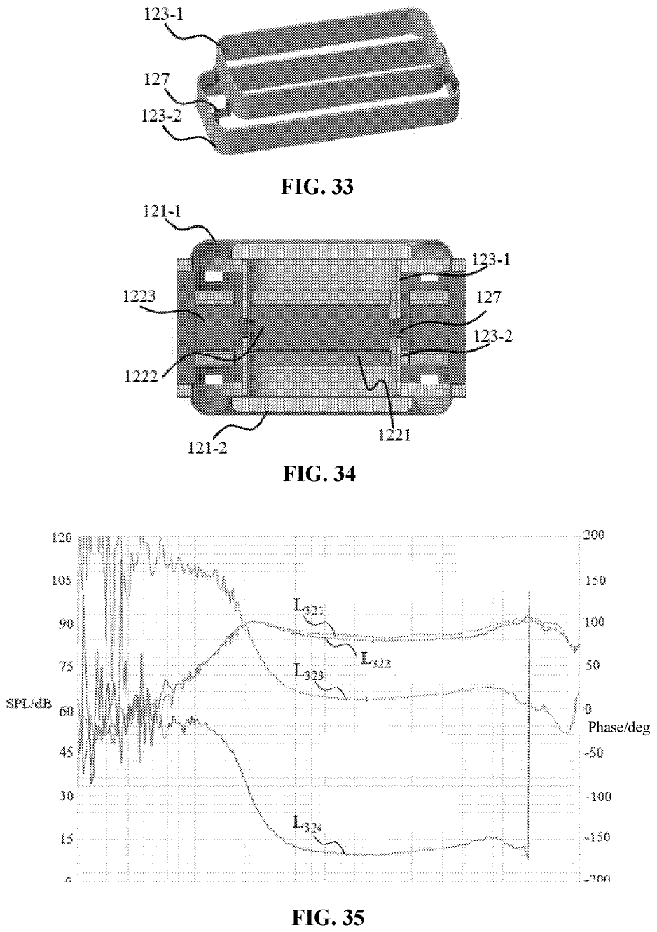

In voice coil assemblies adopting the former structure or adopting a non-former structure, as for the first connection component 127 itself, referring to FIG. 32A, FIG. 32B, and FIG. 33, the first connection component 127 may adopt a bent structure. The first connection component 127 with the bent structure may be connected between the first voice coil 123-1 and the second voice coil 123-2 in the long axis direction, or may be connected between the first voice coil 123-1 and the second voice coil 123-2 in the short axis direction. Due to a small mass of the bent structure, loads on the first voice coil 123-1 and the second voice coil 123-2 can be reduced, thereby improving the output of the loudspeaker 120 and further improving the active noise reduction effect of the headphone against larger ambient noise in the open-ear wearing manner. Meanwhile, it can also be applicable to the first voice coil 123-1 and the second voice coil 123-2 of different sizes.

Of course, the first connection component 127 may also adopt other suitable structural forms. For example, the first connection component 127 may also adopt a spacer structure, in which case the first voice coil 123-1 and the second voice coil 123-2 may be adhesively fixed to the first connection component 127 by clamping the first connection component 127. The first connection component 127 may also adopt a patch structure, and the first connection component 127 may also be adhesively fixed on the same side of the first voice coil 123-1 and the second voice coil 123-2. Various such configurations will not be reiterated herein.

In some embodiments, when the voice coil assembly adopts the former structure, a material of the first former, the second former, and the first connection component 127 may include aluminum alloy, or may also include a lower density material such as Polymethacrylimide (PMI) or Polycarbonate (PC). Furthermore, a hybrid material may also be adopted (e.g., a PC material with added glass fibers or carbon fibers, or the like). This can reduce the load on the first voice coil 123-1 and the second voice coil 123-2, which is conducive to improving a driving force coefficient of the loudspeaker 120.

FIG. 35 is a schematic diagram illustrating frequency response curves of the loudspeaker shown in FIG. 34. Taking a size of the first voice coil 123-1 being smaller than a size of the second voice coil 123-2 as an example, the curve L321 represents an output sound pressure level of the first diaphragm 121-1 corresponding to the small voice coil (the first voice coil 123-1) when the first voice coil 123-1 and the second voice coil 123-2 are simultaneously driven; the curve L322 represents an output sound pressure level of the second diaphragm 121-2 corresponding to the large voice coil (the second voice coil 123-2) when the first voice coil 123-1 and the second voice coil 123-2 are simultaneously driven; the curve L323 represents an output phase of the first diaphragm 121-1 corresponding to the small voice coil (the first voice coil 123-1) when the first voice coil 123-1 and the second voice coil 123-2 are simultaneously driven; and the curve L324 represents an output phase of the second diaphragm 121-2 corresponding to the large voice coil (the second voice coil 123-2) when the first voice coil 123-1 and the second voice coil 123-2 are simultaneously driven.

It should be noted that a data acquisition environment for the data shown in FIG. 35 may be: fixing the loudspeaker 120 (e.g., handheld, directly fixed by a fixed platform, fixed by a handheld fixing device, or the like), adopting 0.5 Vrms voltage excitation, and measuring the frequency response and the phase of the corresponding diaphragm by a test microphone located 5 mm away from the corresponding diaphragm. When fixing the loudspeaker 120, it is necessary to prevent the loudspeaker 120 from being blocked, thereby preventing affecting an acquisition effect.

As shown in FIG. 35, the curve L321 and the curve L322 are both relatively flat in the 200 Hz-10 kHz range, and no peaks or valleys appear, indicating that the vibration consistency and the output consistency of the first diaphragm 121-1 and the second diaphragm 121-2 are relatively good. The phase differences between the curve L323 and the curve L324 in the 200-10 kHz range are all around 180°, indicating that the vibration phases of the first diaphragm 121-1 and the second diaphragm 121-2 are opposite, and the vibration consistency of the first diaphragm 121-1 and the second diaphragm 121-2 is relatively good. In the frequency range of 200 Hz-10 kHz, the phase variations of the curve L323 or the curve L324 are both not greater than 20°, indicating that the vibration phase consistency of the first diaphragm 121-1 and the second diaphragm 121-2 is relatively good.

In summary, by using the first connection component 127 to connect the first voice coil 123-1 and the second voice coil 123-2, and enabling the first voice coil 123-1 to be correspondingly connected to the first diaphragm 121-1 and the second voice coil 123-2 to be correspondingly connected to the second diaphragm 121-2, a synchronous and in-phase vibration of the first diaphragm 121-1 and the second diaphragm 121-2 can be achieved, and the vibration consistency is relatively good.

It should be noted that, as in some preceding embodiments, the sound pressure level of the sound output from the first sound outlet 112-1 being set to be greater than the sound pressure level of the sound output from the second sound outlet 112-2 refers to the sound pressure level of the corresponding sound in the frequency range from the peak resonance frequency of the first resonance peak to the peak resonance frequency of the second resonance peak.

In some embodiments, referring to FIG. 27 and FIG. 37, the inner magnetic circuit component 122-2 includes an inner magnet (for ease of distinction, the inner magnet is defined as a first inner magnet 122-21), a first magnetic conductive plate 122-22, and a third magnetic conductive plate 122-23. The outer magnetic circuit component 122-1 includes an outer magnet (for ease of distinction, the outer magnet is defined as a first outer magnet 122-11), a fourth magnetic conductive plate 122-12, and a second magnetic conductive plate 122-13. The first outer magnet 122-11 surrounds an outer periphery of the first inner magnet 122-21 to enclose and form a magnetic gap with the first inner magnet 122-21. For example, the first outer magnet 122-11 may be an integrated annular magnet disposed surrounding the first outer magnet 122-11. The first magnetic conductive plate 122-22 is stacked on the first inner magnet 122-21 and faces the first diaphragm 121-1, and the third magnetic conductive plate 122-23 is stacked on the first inner magnet 122-21 and faces the second diaphragm 121-2. The fourth magnetic conductive plate 122-12 is stacked on the first outer magnet 122-11 and faces the first diaphragm 121-1, and the second magnetic conductive plate 122-13 is stacked on the first outer magnet 122-11 and faces the second diaphragm 121-2. For example, the fourth magnetic conductive plate 122-12 and the second magnetic conductive plate 122-13 each may be an integrated annular magnetic conductive member stacked on two sides of the first outer magnet 122-11. The magnetic circuit connection component 122-3 passes through the magnetic gap and the bypass channel 123-3 along the vibration direction and is disposed such that one end of the magnetic circuit connection component 122-3 is connected to the first magnetic conductive plate 122-22 and the other end is connected to the second magnetic conductive plate 122-13.

Firstly, through a cooperation of the first inner magnet 122-21 and the first outer magnet 122-11, a magnetic field strength near the voice coil assembly can be effectively increased, thereby making a magnetic field distribution more uniform, improving the driving force of the voice coil assembly, and ensuring the vibration consistency of the first diaphragm 121-1 and the second diaphragm 121-2. This further provides support for increasing a width of the flat region of the frequency response curve of the sound output from the first sound outlet 112-1, allowing the headphone to perform active noise reduction on larger ambient noise in a wider frequency band range. Secondly, based on the stacked arrangement relationship among the first inner magnet 122-21, the first outer magnet 122-11, and the related magnetic conductive members, a structural stability of the magnetic circuit assembly can be further improved, which further improves a vibration stability of the loudspeaker 120, and is conducive to reducing a processing and manufacturing difficulty of the magnetic circuit assembly, thereby facilitating the assembly and forming of the loudspeaker 120. Thirdly, based on the annular structure of the first outer magnet 122-11, the first outer magnet 122-11 can be enabled to have a larger volume to enhance a magnetic flux, thereby enhancing the driving force of the loudspeaker 120. Furthermore, the annular structure of the first outer magnet 122-11 can also reduce an assembly difficulty and improve an assembly efficiency.

In some embodiments, referring to FIG. 27 and FIG. 37, at least one of the first magnetic conductive plate 122-22 and the second magnetic conductive plate 122-13 is the integrated structure with the magnetic circuit connection component 122-3. This can reduce the number of constituent parts of the magnetic circuit assembly, further enhancing the structural stability of the magnetic circuit assembly and reducing the manufacturing difficulty of the magnetic circuit assembly. By way of example, the first magnetic conductive plate 122-22 and the magnetic circuit connection component 122-3 are an integrated structure. The magnetic circuit connection component 122-3 is bent and formed from an outer periphery edge of the first magnetic conductive plate 122-22 along the vibration direction towards the side where the second magnetic conductive plate 122-13 is located. Correspondingly, the second magnetic conductive plate 122-13 is provided with a fixing structure (e.g., a groove structure, a notch structure, or the like), by virtue of which the end of the magnetic circuit connection component 122-3 away from the first magnetic conductive plate 122-22 is fixed to the second magnetic conductive plate 122-13. This is conducive to reducing the processing and manufacturing difficulty of the magnetic circuit assembly and even the loudspeaker 120.

In some embodiments, the magnetic circuit connection component 122-3 and the corresponding magnetic conductive plate may also adopt a split combination structure. For example, a side of the first magnetic conductive plate 122-22 facing the first inner magnet 122-21 is provided with an accommodation slot configured to accommodate the magnetic circuit connection component 122-3. The magnetic circuit connection component 122-3 is inserted into the accommodation slot in a stacked manner, and an end portion of the magnetic circuit connection component 122-3 extends out from the accommodation slot to connect to the second magnetic conductive plate 122-13. Alternatively, the magnetic circuit connection component 122-3 is stacked and fixed on the side of the first magnetic conductive plate 122-22 facing the first inner magnet 122-21, and the two ends of the magnetic circuit connection component 122-3 in the long axis direction extend out from between the first magnetic conductive plate 122-22 and the first inner magnet 122-21 and connect to the second magnetic conductive plate 122-13.

Thus, a structural connection area between the magnetic circuit connection component 122-3 and the corresponding magnetic conductive plate can be effectively increased, enhancing a structural connection strength between the magnetic circuit connection component 122-3 and the corresponding magnetic conductive plate, thereby enabling the magnetic circuit connection component 122-3 to establish a stable structural connection relationship between the outer magnetic circuit component 122-1 and the inner magnetic circuit component 122-2.

In other embodiments, the magnetic circuit connection component 122-3 may also adopt an integrated structure or a split combination structural form, connected between the third magnetic conductive plate 122-23 and the fourth magnetic conductive plate 122-12. Details will not be reiterated herein.

In some embodiments, the outer magnetic circuit component 122-1 may omit the first outer magnet 122-11. The outer magnetic circuit component 122-1 includes a magnetic conductive ring, which is equivalent to a magnetic conductive ring constructed as an integrated annular structure based on the fourth magnetic conductive plate 122-12 and the second magnetic conductive plate 122-13. The magnetic conductive ring surrounds an outer periphery of the inner magnetic circuit component 122-2, thereby enclosing and forming the magnetic gap between the two. The magnetic circuit connection component 122-3 passes through the bypass channel 123-3 and the magnetic gap along the vibration direction and is connected between the first magnetic conductive plate 122-22 and the magnetic conductive ring. At least one of the first magnetic conductive plate 122-22 and the magnetic conductive ring may be an integrated structure with the magnetic circuit connection component 122-3, or may also be a split combination structure. Thus, a number of constituent parts of the magnetic circuit assembly can be reduced, thereby enhancing the structural stability of the magnetic circuit assembly.

In some embodiments, the magnetic circuit connection component 122-3 may be made of a weakly magnetic material or a non-magnetic material. For example, the magnetic circuit connection component 122-3 is made of spring steel material with high rigidity and weak permeability. Thus, a magnetic circuit short circuit between the inner magnetic circuit component 122-2 and the outer magnetic circuit component 122-1 can be prevented, or the magnetic circuit connection component 122-3 from generating a shunting effect on the magnetic field can be prevented, to cause the magnetic field to pass through the magnetic gap as much as possible, thereby improving the driving force on the voice coil assembly. Meanwhile, on the premise of ensuring a structural strength of the magnetic circuit assembly, a thickness of the magnetic circuit connection component 122-3 may be thinned (e.g., by punching holes or reducing weight). This can improve the electromagnetic conversion efficiency (i.e., the BL value) of the loudspeaker 120 and ensure a vibration effect by increasing a size of the outer magnetic circuit component 122-1 (e.g., the first outer magnet 122-11).

In some embodiments, all or some magnetic conductive plates may also be omitted in the magnetic circuit assembly. For example, when the first magnetic conductive plate 122-22, the third magnetic conductive plate 122-23, the fourth magnetic conductive plate 122-12, and the second magnetic conductive plate 122-13 are omitted, the magnetic circuit connection component 122-3 is directly connected between the first outer magnet 122-11 and the first inner magnet 122-21. Specifically, the magnetic circuit connection component 122-3 may be made of a weakly permeable material or a non-magnetic material (e.g., spring steel material), and the two ends of the magnetic circuit connection component 122-3 in the vibration direction are respectively connected to the first outer magnet 122-11 and the first inner magnet 122-21. Alternatively, the third magnetic conductive plate 122-23 and the fourth magnetic conductive plate 122-12 may be omitted, and the two ends of the magnetic circuit connection component 122-3 in the vibration direction are respectively connected to the first magnetic conductive plate 122-22 and the second magnetic conductive plate 122-13 (e.g., the magnetic circuit connection component 122-3 may be an integrated structure with at least one of the first magnetic conductive plate 122-22 and the second magnetic conductive plate 122-13). Various such configurations will not be reiterated herein.

Considering that the magnetic circuit assembly will affect the electromagnetic conversion efficiency of the loudspeaker 120, thereby affecting the output performance of the loudspeaker 120, and will also affect the active noise reduction effect of the headphone, designing the size and relationship of the related parts in the magnetic circuit assembly can therefore provide support for improving the performance of the loudspeaker 120 and the active noise reduction effect of the headphone.

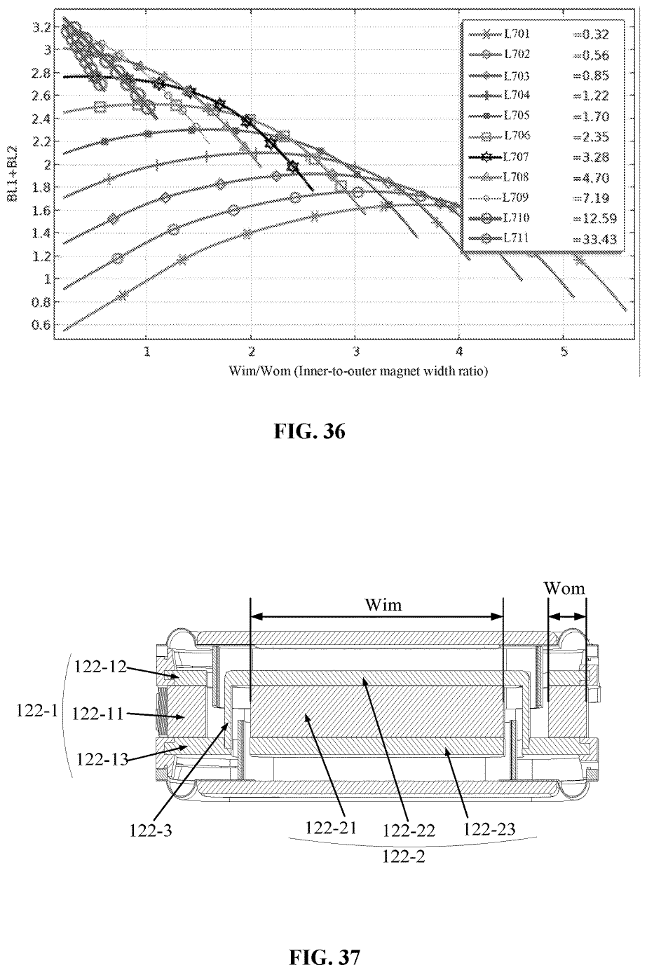

Referring to FIG. 36 and FIG. 41, FIG. 36 is a schematic diagram illustrating electromagnetic conversion efficiency (i.e., the BL values) of a loudspeaker with an inner magnetic circuit component 122-2 and an outer magnetic circuit component 122-1 of different sizes according to some embodiments of the present disclosure. The data in FIG. 36 is the data measured under the conditions that a width of the magnetic gap is 1.1 mm and a width of the magnetic circuit connection component 122-3 is 0.7 mm.

Referring to FIG. 37, the ratio of the width Wim of the inner magnetic circuit component 122-2 to the width Wom of the outer magnetic circuit component 122-1 is defined as Wim/Wom. In FIG. 36, L701 represents the BL value of the loudspeaker 120 when Wim/Wom is 0.32; L702 represents the BL value of the loudspeaker 120 when Wim/Wom is 0.56; L703 represents the BL value of the loudspeaker 120 when Wim/Wom is 0.85; L704 represents the BL value of the loudspeaker 120 when Wim/Wom is 1.22; L705 represents the BL value of the loudspeaker 120 when Wim/Wom is 1.70; L706 represents the BL value of the loudspeaker 120 when Wim/Wom is 2.35; L707 represents the BL value of the loudspeaker 120 when Wim/Wom is 3.28; L708 represents the BL value of the loudspeaker 120 when Wim/Wom is 4.70; L709 represents the BL value of the loudspeaker 120 when Wim/Wom is 7.19; L710 represents the BL value of the loudspeaker 120 when Wim/Wom is 15.59; and L711 represents the BL value of the loudspeaker 120 when Wim/Wom is 33.43.

Referring to FIG. 37, the width refers to a size parameter of the related parts in a direction perpendicular to the vibration direction. For example, the width of the outer magnetic circuit component 122-1 refers to the distance between the outer surface and the inner surface of the outer magnetic circuit component 122-1, and the width of the inner magnetic circuit component 122-2 refers to the width of a cross section of the inner magnetic circuit component 122-2.

As shown in FIG. 36, the BL value of the loudspeaker 120 is optimal when the ratio of the width of the inner magnetic circuit component 122-2 to the width of the outer magnetic circuit component 122-1 is 7.19. Continuing to increase the ratio of the width of the inner magnetic circuit component 122-2 to the width of the outer magnetic circuit component 122-1 will cause the BL value of the loudspeaker 120 to decrease.

In view of this, by designing dimensional ratios of the outer magnetic circuit component 122-1 and the inner magnetic circuit component 122-2, the BL value of the loudspeaker 120 may be ensured, and the driving force of the voice coil assembly may be enhanced.

Merely by way of example, the dimension of the loudspeaker 120 in the long axis direction is greater than the dimension thereof in the short axis direction. In this case, the ratio of the length of the inner magnetic circuit component 122-2 (e.g., the first inner magnet 122-21) in the long axis direction to the thickness of the side wall of the outer magnetic circuit component 122-1 (e.g., the first outer magnet 122-11 or the magnetic conductive ring) in the long axis direction may be between 1.7 and 33; and the ratio of the width of the inner magnetic circuit component 122-2 in the short axis direction to the thickness of the side wall of the outer magnetic circuit component 122-1 in the short axis direction may be between 1.7 and 33.

Further, in some embodiments, the ratio of the length of the first inner magnet 122-21 in the long axis direction to the thickness of the side wall of the first outer magnet 122-11 in the long axis direction may be not greater than 6.7; and the ratio of the width of the first inner magnet 122-21 in the short axis direction to the thickness of the side wall of the first outer magnet 122-11 in the short axis direction may be not greater than 2.7. This may significantly enhance the BL value of the loudspeaker 120, thereby further improving the sound output performance of the loudspeaker 120.

Merely by way of example, the profile shape of the loudspeaker 120 is circular, and the ratio of the thickness of the inner magnetic circuit component 122-2 (e.g., the first inner magnet 122-21) in the radial direction (i.e., which is equivalent to the long axis direction or the short axis direction) to the thickness of the side wall of the outer magnetic circuit component 122-1 (e.g., the first outer magnet 122-11 or the magnetic conductive ring) in the radial direction is between 1.7 and 33.

It should be noted that the thickness of the side wall of the outer magnetic circuit component 122-1 refers to a distance between an outer circumferential surface and an inner circumferential surface of the outer magnetic circuit component 122-1.

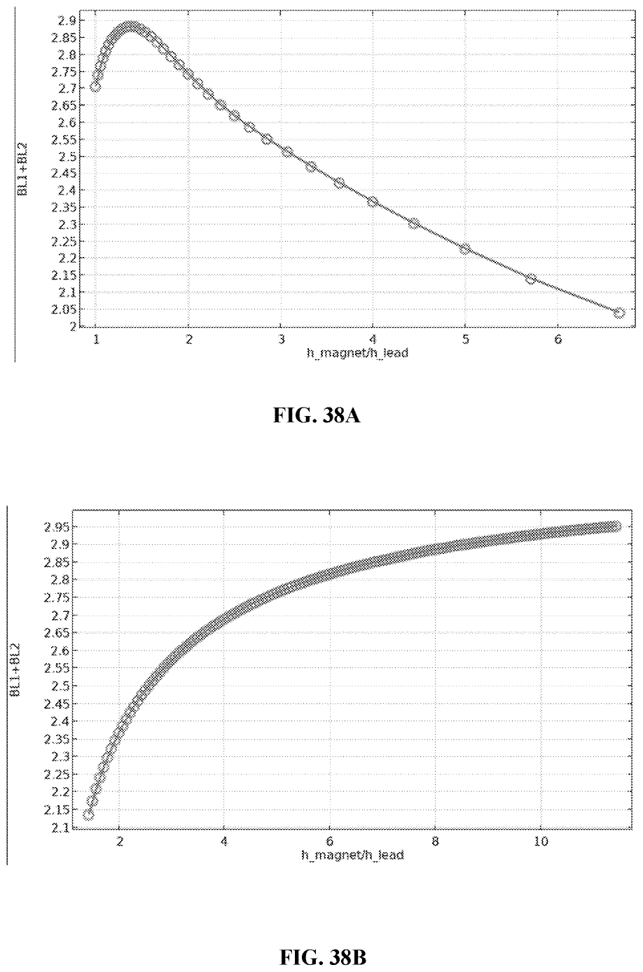

FIGS. 38A and 38B are schematic diagrams illustrating electromagnetic conversion efficiency of a loudspeaker with magnets and magnetic conductive plates of different sizes according to some embodiments of the present disclosure. FIG. 38A illustrates the variation trend of the electromagnetic conversion efficiency of the loudspeaker 120 when the thickness of a magnet (e.g., the first inner magnet 122-21) is fixed (e.g., 2 mm) and the thickness of a magnetic conductive plate (e.g., the first magnetic conductive plate 122-22) is varied. FIG. 38B illustrates the variation trend of the electromagnetic conversion efficiency of the loudspeaker 120 when the thickness of a magnetic conductive plate (e.g., the first magnetic conductive plate 122-22) is fixed (e.g., 0.7 mm) and the thickness of a magnet (e.g., the first inner magnet 122-21) is varied.

As shown in FIG. 38A, with an increase in the thickness of the magnetic conductive plate (i.e., a decrease in a ratio of the thickness of the magnet to the thickness of the magnetic conductive plate, h_magnet/h_lead), the BL value of the loudspeaker 120 shows an increasing trend. However, when the thickness of the magnetic conductive plate increases to a certain value, the BL value may reach a maximum value. Excessively increasing the thickness of the magnetic conductive plate may cause magnetic field lines to disperse, preventing them from being effectively concentrated near the voice coil, thereby reducing the magnetic field near the voice coil. When the thickness of the magnetic conductive plate decreases (i.e., an increase in the ratio of the thickness of the magnet to the thickness of the magnetic conductive plate), a magnetic saturation amount of the magnetic conductive plate may be reduced, thereby reducing a magnetic conduction capability thereof, and further reducing a magnetic field strength passing through the voice coil. The BL value may reach a maximum value when the ratio of the thickness of the magnet to the thickness of the magnetic conductive plate is 1.4, but a large BL value is achieved when the ratio of the thickness of the magnet to the thickness of the magnetic conductive plate is between 1 and 4.

As shown in FIG. 38B, with an increase in the thickness of the magnet (i.e., a decrease in the ratio of the thickness of the magnet to the thickness of the magnetic conductive plate, h_magnet/h_lead), the BL value of the loudspeaker 120 shows an increasing trend, but the rate of increase of the BL value may decrease. The reason may be that, with the increase in the thickness of the magnet, the magnetic conductive plate may experience magnetic saturation. If the thickness of the magnet continues to increase, the increase in the magnetic field passing through the voice coil that can be converged by the magnetic conductive plate may not be obvious. A large BL value increase rate is achieved when the ratio of the thickness of the magnet to the thickness of the magnetic conductive plate is between 1 and 4. When the ratio of the thickness of the magnet to the thickness of the magnetic conductive plate is greater than 4, the rate of increase significantly slows down, the magnetic conductive plate begins to experience magnetic saturation, thereby reducing the overall BL value of the loudspeaker 120.

Therefore, to enhance the electromagnetic conversion efficiency of the loudspeaker 120, in some embodiments, the ratio of the thickness of the first inner magnet 122-21 to the thickness of the first magnetic conductive plate 122-22 (and the third magnetic conductive plate 122-23) may be between 1 and 4; and the ratio of the thickness of the first outer magnet 122-11 to the thickness of the fourth magnetic conductive plate 122-12 (and the second magnetic conductive plate 122-13) may be between 1 and 4.

In some embodiments, referring to FIGS. 26 to 29, the magnetic circuit assembly further includes a bracket assembly. The bracket assembly may include a first bracket 122-4 and a second bracket 122-5. The first bracket 122-4 is connected around an outer periphery of the fourth magnetic conductive plate 122-12, and the second bracket 122-5 is connected around an outer periphery of the second magnetic conductive plate 122-13. The first bracket 122-4 and the fourth magnetic conductive plate 122-12, and the second bracket 122-5 and the second magnetic conductive plate 122-13 may be connected by means of injection molding, adhesive bonding, bolts, snap fasteners, or the like. An outer peripheral edge of the first diaphragm 121-1 is fixed to the first bracket 122-4 (e.g., by adhesive bonding), and an outer peripheral edge of the second diaphragm 121-2 is fixed to the second bracket 122-5 (e.g., by adhesive bonding).

On one hand, through the cooperation of the first bracket 122-4, the second bracket 122-5, and the outer magnetic circuit component 122-1, a speaker basket in some existing loudspeakers or the frame 125 described in the preceding related descriptions may be replaced. This may allow the first outer magnet 122-11 to have a larger volume size, enhance the magnetic flux, and thereby enhance the driving force of the voice coil assembly. Meanwhile, this may also make the structure of the loudspeaker 120 more compact, reduce assembly difficulty, and improve the assembly effect thereof.

On the other hand, through the cooperation of the first bracket 122-4, the second bracket 122-5, the magnetic conductive plate, and the diaphragm, the internal space of the loudspeaker 120 may be enclosed to form a relatively enclosed cavity (i.e., the common cavity 111-3). Furthermore, the first bracket 122-4 and the second bracket 122-5 may serve as structural connection carriers between the loudspeaker 120 and the first housing 110 or between the loudspeaker 120 and the limiting assembly 130, allowing the loudspeaker 120 to be stably limited inside the first housing 110, and forming the first acoustic cavity 111-1 and the second acoustic cavity 111-2 that are relatively independent of the common cavity 111-3.

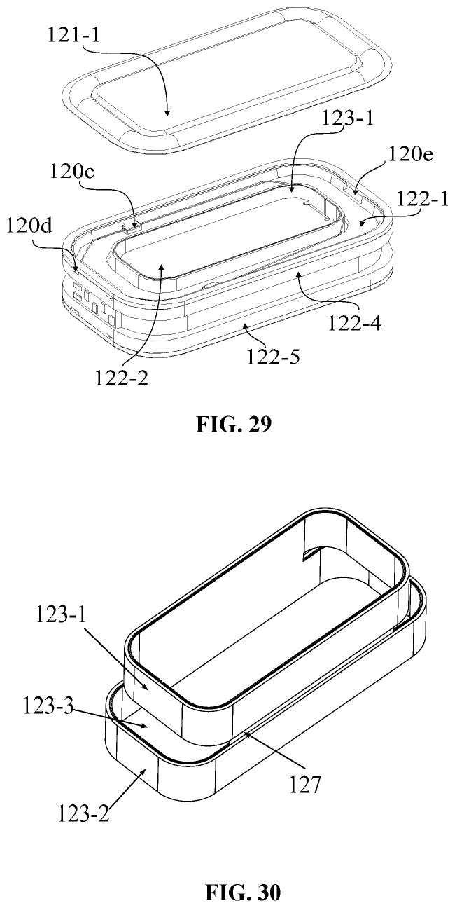

In some embodiments, referring to FIG. 29, the first bracket 122-4 has a first accommodating groove enclosed around the fourth magnetic conductive plate 122-12, and the second bracket 122-5 has a second accommodating groove enclosed around the second magnetic conductive plate 122-13. The outer peripheral edge of the fourth magnetic conductive plate 122-12 is inserted into the first accommodating groove, and the outer peripheral edge of the second magnetic conductive plate 122-13 is inserted into the second accommodating groove. Merely by way of example, the first bracket 122-4 may be integrally formed with the fourth magnetic conductive plate 122-12 by means of injection molding, overmolding, or the like, and the first bracket 122-4 covers the outer peripheral edge of the fourth magnetic conductive plate 122-12. In this case, the first accommodating groove is equivalent to being naturally formed in the first bracket 122-4.

Based on the arranged accommodating groove, the structural connection area between the bracket and the corresponding magnetic conductive plate is effectively increased, thereby allowing the bracket and the corresponding magnetic conductive plate to be integrally combined (e.g., the bracket and the corresponding magnetic conductive plate are integrally injection-molded). This is conducive to reducing the number of components of the loudspeaker 120 and reducing the assembly difficulty of the loudspeaker 120.

In some embodiments, referring to FIGS. 27 and 29, the first bracket 122-4, the fourth magnetic conductive plate 122-12, and the first diaphragm 121-1 collectively form a first chamber 120a inside the loudspeaker 120. The second bracket 122-5, the second magnetic conductive plate 122-13, and the second diaphragm 121-2 collectively form a second chamber 120b inside the loudspeaker 120. It may be understood that the first chamber 120a and the second chamber 120b are equivalent to a portion of the common cavity 111-3, and both are located on two sides of the magnetic circuit assembly in the vibration direction.

In this case, referring to FIG. 29, the first bracket 122-4 and the second bracket 122-5 are respectively provided with a positioning structure 120c and a through-hole structure 120d. For convenience of distinction and description, the positioning structure 120c and the through-hole structure 120d arranged in the first bracket 122-4 are respectively defined as the first positioning structure and the first through-hole structure; and the positioning structure 120c and the through-hole structure 120d arranged in the second bracket 122-5 are respectively defined as the second positioning structure and the second through-hole structure.

The first positioning structure is located in the first chamber 120a, and is primarily configured to position and limit the lead wire of the first voice coil 123-1 to the first bracket 122-4 in the first chamber 120a. The first through-hole structure is provided through a side wall of the first bracket 122-4 (e.g., a side wall in the short axis direction), allowing the lead wire of the first voice coil 123-1 to be routed out from the inside of the loudspeaker 120, thereby connecting to the circuit board 150 arranged at the periphery of the loudspeaker 120 (the circuit board 150 may realize the electrical connection between the loudspeaker 120 and the microphone assembly, and the circuit board assembly of the headphone). Similarly, the second positioning structure is located in the second chamber 120b, and is primarily configured to position and limit the lead wire of the second voice coil 123-2 to the second bracket 122-5 in the second chamber 120b, whereas the second through-hole structure is provided through the side wall of the second bracket 122-5, allowing the lead wire of the second voice coil 123-2 to be connected to the circuit board 150 after being routed out from the inside of the loudspeaker 120.

Thus, through the cooperation among the respective chambers, the brackets, the positioning structure 120c, and the through-hole structure 120d, the overall structural compactness of the loudspeaker 120 may be effectively enhanced, and the limitation on the voice coil lead wire may be formed, so as to prevent the lead wire from interfering with the vibration of the diaphragm. In a specific implementation, the positioning structure 120c may be a mechanical structure, such as a snap fastener or the like, arranged on the respective bracket, or may be a structure formed by fixing the voice coil lead wire by dispensing adhesive.

In some embodiments, referring to FIG. 37, the first bracket 122-4 and the second bracket 122-5 are separated in a vibration direction. This may form an accommodating gap distributed around the outer magnetic circuit component 122-1 (specifically, such as the first outer magnet 122-11) therebetween. Whereas the circuit board 150 may be received and fixed in the accommodating gap, for example, attached and fixed on an outer circumferential surface of the first outer magnet 122-11. Thus, the overall volume size of the loudspeaker 120 may be effectively reduced, and the structural compactness of the loudspeaker 120 may be further enhanced.

In some embodiments, as described in the preceding related descriptions, the limiting assembly 130 is arranged between the first housing 110 and the loudspeaker 120. In this case, referring to FIG. 29, the joint between the limiting assembly 130 and the loudspeaker 120 may form a sealant accommodating space configured to accommodate a sealant. For example, the peripheral side wall of the first cover 133 is arranged around an outer periphery of the first bracket 122-4, thereby forming a sealant accommodating space between the two. The peripheral side wall of the second cover 134 is arranged around an outer periphery of the second bracket 122-5, thereby forming a sealant accommodating space between the two. By filling the sealant accommodating space with the sealant, the sealed and fixed connection between the limiting assembly 130 and the loudspeaker 120 is realized.

In this way, the sealant in the sealant accommodating space may be utilized to not only enhance the stability and the sealing performance of the structural connection between the limiting assembly 130 and the loudspeaker 120, but also eliminate a structural gap between the limiting assembly 130 and the loudspeaker 120, thereby enhancing the sealing performance of the first acoustic cavity 111-1 and he second acoustic cavity 111-2, and preventing the sound output of the headphone from being affected by sound leakage occurring from the joint between the limiting assembly 130 and the loudspeaker 120.

In some embodiments, referring to FIG. 29, one or both of the first bracket 122-4 and the second bracket 122-5 are provided with an air pressure balancing channel 120e. The air pressure balancing channel 120e may extend through the corresponding bracket along a direction perpendicular to the vibration direction (e.g., the long axis direction, the short axis direction, or the like), so as to allow the air pressure balancing channel 120e to communicate the external space of the loudspeaker 120 with the common cavity 111-3 formed between the first bracket 122-4, the second bracket 122-5, the first diaphragm 121-1, the second diaphragm 121-2, and the outer magnetic circuit component 122-1.

When the first diaphragm 121-1 and the second diaphragm 121-2 vibrate synchronously and in the same direction, the air pressure balancing channel 120e may ensure that the air in the common cavity 111-3 moves back and forth with the vibration of the two diaphragms, thereby preventing the first diaphragm 121-1 and the second diaphragm 121-2 from affecting peaks and troughs of a frequency response curve due to compressing the air in the common cavity 111-3, enhancing the sound output quality of the headphone, and further enhancing the active noise reduction effect of the headphone.

Meanwhile, when the first diaphragm 121-1 and the second diaphragm 121-2 experience inconsistent vibration (e.g., opposite vibration directions, a difference in vibration amplitude, or the like), the air pressure balancing channel 120e may be utilized to balance internal and external air pressure of the common cavity 111-3, thereby preventing the air in the common cavity 111-3 from interfering with the vibration of the first diaphragm 121-1 and the second diaphragm 121-2, and ensuring the sound output.

In some embodiments, a mesh screen, a waterproof and breathable membrane, or the like may be utilized to cover the air pressure balancing channel 120e, so as to enhance the waterproof performance of the loudspeaker 120.

In some embodiments where the first diaphragm 121-1 and the second diaphragm 121-2 are connected by means of the voice coil assembly, the magnetic circuit assembly and the voice coil assembly may also adopt other structural cooperation manners, so as to ensure the consistency of synchronous and in-phase vibration of the two diaphragms, and further provide support for the movement of the peak resonance frequency of the first resonance peak towards a low-frequency band, and the movement of the peak resonance frequency of the second resonance peak towards a high-frequency band.

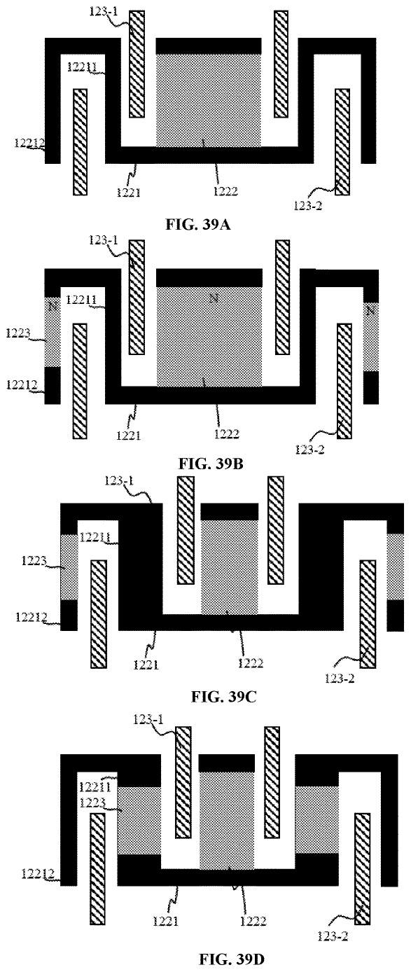

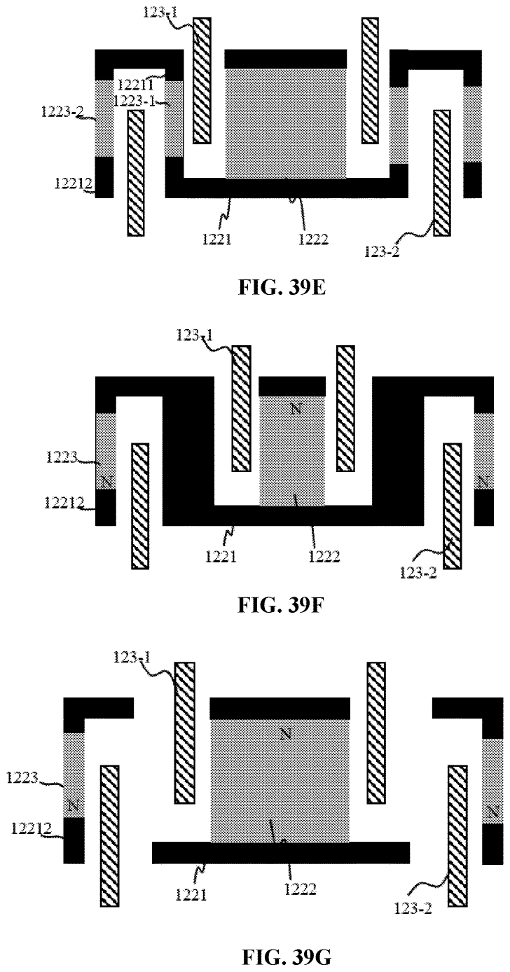

Referring to FIG. 39A, the magnetic circuit assembly may include a magnetic conductive cover 1221 and a second inner magnet 1222. The second inner magnet 1222 may be arranged in a voice coil 123. The magnetic conductive cover 1221 and the second inner magnet 1222 are spaced apart in a direction perpendicular to the vibration direction. The side wall of the magnetic conductive cover 1221 may be a folded structure. The folded structure has an opening facing a bottom of the magnetic conductive cover 1221. The folded structure includes an inside wall 12211 and an outside wall 12212 of the magnetic conductive cover 1221. A first magnetic gap is formed between the inside wall 12211 of the magnetic conductive cover 1221 and the second inner magnet 1222, and at least a portion of the first voice coil 123-1 is located in the first magnetic gap. A second magnetic gap is formed between the inside wall 12211 and the outside wall 12212 of the magnetic conductive cover 1221, and at least a portion of the second voice coil 123-2 is located in the second magnetic gap. Meanwhile, the first voice coil 123-1 is connected to the first diaphragm 121-1 to drive the first diaphragm 121-1 to vibrate to generate sounds. The second voice coil 123-2 is connected to the second diaphragm 121-2 to drive the second diaphragm 121-2 to vibrate to generate sounds.

In this way, by utilizing different voice coils to respectively drive the first diaphragm 121-1 and the second diaphragm 121-2 to vibrate, synchronous vibration of the first diaphragm 121-1 and the second diaphragm 121-2 and generation of sound are realized. For example, sounds generated and output by the two diaphragms may be superimposed on each other, so as to enhance the output performance of the headphone and enhance the active noise reduction effect of the headphone for relatively large ambient noise. Moreover, for example, the resonance frequency of the headphone may be adjusted, and distortion of the headphone output may be reduced, causing the headphone to have a relatively flat output in a relatively wide frequency band range, thereby further enhancing the active noise reduction effect.

In some embodiments, referring to FIG. 39B, a second outer magnet 1223 is arranged at the outside wall 12212 of the magnetic conductive cover 1221. The magnetization direction of the second outer magnet 1223 may be the same as or opposite to the magnetization direction of the second inner magnet 1222. For example, the N-pole of the second inner magnet 1222 may be located at an upper end, and the N-pole of the second outer magnet 1223 may be located at an upper end (as shown in FIG. 39B). Further for example, the N-pole of the second inner magnet 1222 may be located at an upper end, and the N-pole of the second outer magnet 1223 may be located at a lower end (as shown in FIG. 39G).

Since the second voice coil 123-2 is relatively far from the second inner magnet 1222, the magnetic field strength near the second voice coil 123-2 is relatively small, and the second voice coil 123-2 may have a problem of insufficient driving force. Therefore, by means of the arranged second outer magnet 1223, the magnetic field strength near the second voice coil 123-2 may be increased, thereby enhancing the driving force of the second voice coil 123-2. This is conducive to enhancing the output of the loudspeaker 120 as well as the active noise reduction effect of the headphone for a relatively large ambient noise.

In some embodiments, when the magnetization directions of the second inner magnet 1222 and the second outer magnet 1223 are the same (e.g., N-poles are both located at the upper end as shown in FIG. 39B), the inside wall 12211 of the magnetic conductive cover 1221 is subjected to the combined action of the second inner magnet 1222 and the second outer magnet 1223, and the inside wall 12211 may experience a magnetic field saturation phenomenon, which limits the enhancement of the magnetic field strength at positions of the first voice coil 123-1 and the second voice coil 123-2, thereby affecting the driving force of the first voice coil 123-1 and the second voice coil 123-2.

Therefore, to prevent the overall dimension of the magnetic circuit assembly from being excessively large, under the condition that the dimension of the magnetic circuit assembly remains unchanged (i.e., the width of the magnetic conductive cover 1221 remains unchanged), the dimension of the second inner magnet 1222 may be reduced, so as to increase the dimension of the inside wall 12211, and so as to try to prevent the inside wall 12211 from experiencing magnetic field saturation, thereby enhancing the magnetic field strength at positions of the first voice coil 123-1 and the second voice coil 123-2, and further enhancing the driving force of the loudspeaker 120. Merely by way of example, referring to FIGS. 39B and 39C, a ratio of the thickness of the inside wall 12211 to the width of the magnetic conductive cover 1221 may be 0.05 to 0.16. To further enhance the driving force of the loudspeaker 120, the ratio of the thickness of the inside wall 12211 to the width of the magnetic conductive cover 1221 may be 0.06 to 0.15.

Additionally, under the condition that the dimension of the magnetic circuit assembly remains unchanged (i.e., the width of the magnetic conductive cover 1221 remains unchanged), the thickness of the inside wall 12211 and the radius of the second inner magnet 1222 may be negatively correlated. For example, when the width of the magnetic conductive cover 1221 is 16 mm (in this case, the radius of the magnetic conductive cover 1221 is 8 mm), the thickness of the inside wall 12211 may be 0.8 mm to 2.5 mm. When the radius of the second inner magnet 1222 is greater than 2.35 mm, the thickness of the inside wall 12211 may be 2 mm to 2.5 mm. When the radius of the second inner magnet 1222 is greater than 2.85 mm, the thickness of the inside wall 12211 may be 1.5 mm to 2.5 mm. When the radius of the second inner magnet 1222 is greater than 3.35 mm, the thickness of the inside wall 12211 may be 1.25 mm to 2.5 mm. When the radius of the second inner magnet 1222 is greater than 3.85 mm, the thickness of the inside wall 12211 may be 1.1 mm to 2.5 mm. When the radius of the second inner magnet 1222 is greater than 4.35 mm, the thickness of the inside wall 12211 may be 1 mm to 2 mm. When the radius of the second inner magnet 1222 is greater than 4.85 mm, the thickness of the inside wall 12211 may be 0.8 mm to 1.6 mm. When the radius of the second inner magnet 1222 is greater than 5.35 mm, the thickness of the inside wall 12211 may be 0.8 mm to 1.3 mm.

In some embodiments, referring to FIG. 39D, the second outer magnet 1223 is arranged on the inside wall 12211, so as to prevent the inside wall 12211 from experiencing magnetic field saturation, ensure the magnetic field strength at positions of the first voice coil 123-1 and the second voice coil 123-2, and thereby further enhance the driving force of the loudspeaker 120. In this case, the magnetization direction of the second outer magnet 1223 may be the same as or opposite to the magnetization direction of the second inner magnet 1222.

In some embodiments, referring to FIG. 39E, to further enhance the magnetic field strength at positions of the first voice coil 123-1 and the second voice coil 123-2, and thereby further enhance the driving force of the loudspeaker 120, the inside wall 12211 and the outside wall 12212 of the magnetic conductive cover 1221 are both provided with the second outer magnet 1223. For convenience of distinction and description, the second outer magnet 1223 arranged on the inside wall 12211 is defined as the third outer magnet 1223-1, and the second outer magnet 1223 arranged on the outside wall 12212 is defined as the fourth outer magnet 1223-2. In this case, the magnetization directions of the second inner magnet 1222, the third outer magnet 1223-1, and the fourth outer magnet 1223-2 may be the same as or opposite to each other.

Merely by way of example, the magnetization direction of the second inner magnet 1222 may be the same as the magnetization direction of the third outer magnet 1223-1, and the magnetization direction of the second inner magnet 1222 may be the same as the magnetization direction of the fourth outer magnet 1223-2. Alternatively, the magnetization direction of the second inner magnet 1222 may be the same as the magnetization direction of the third outer magnet 1223-1, and the magnetization direction of the second inner magnet 1222 may be opposite to the magnetization direction of the fourth outer magnet 1223-2. Alternatively, the magnetization direction of the second inner magnet 1222 may be opposite to the magnetization direction of the third outer magnet 1223-1, and the magnetization direction of the second inner magnet 1222 may be the same as the magnetization direction of the fourth outer magnet 1223-2. Alternatively, the magnetization direction of the second inner magnet 1222 may be opposite to the magnetization direction of the third outer magnet 1223-1, and the magnetization direction of the second inner magnet 1222 may be opposite to the magnetization direction of the fourth outer magnet 1223-2.

Referring to FIG. 39F, in some embodiments, when the second outer magnet 1223 is disposed at the outside wall 12212 of the magnetic conductive cover 1221, and the magnetization direction of the second inner magnet 1222 is opposite to the magnetization direction of the second outer magnet 1223 (e.g., the N pole of the second inner magnet 1222 may be located at an upper end, and the N pole of the second outer magnet 1223 may be located at a lower end), a magnetic field null point appears at the inside wall 12211 of the magnetic conductive cover 1221, and the inside wall 12211 is not configured to conduct magnetism. At this time, the inside wall 12211 of the magnetic conductive cover 1221 is primarily configured to provide connection and support.

In some embodiments, as shown in FIG. 39G, the thickness of the inside wall 12211 of the magnetic conductive cover 1221 may be designed to be small, or the inside wall 12211 may be designed with perforations or cut-outs. For example, the size of the inside wall 12211 of the magnetic conductive cover 1221 may be designed to be 0, that is, the structure of the inside wall 12211 may be omitted. This may reduce the mass and the size of the loudspeaker 120.

In some embodiments, because the second outer magnet 1223 and the second inner magnet 1222 need to be mounted and connected, the annular sidewall of the magnetic conductive cover 1221 needs to retain at least a portion of the inside wall 12211 to connect the outside wall 12212 to the bottom of the magnetic conductive cover 1221. Therefore, the outside wall 12212 of the long side of the magnetic conductive cover 1221 may be connected to the bottom of the magnetic conductive cover 1221 through the inside wall 12211, and the short side of the magnetic conductive cover 1221 may not be provided with the inside wall 12211.

In some embodiments, by designing the sizes of the second inner magnet 1222 and the second outer magnet 1223, the magnetic field strength near the first voice coil 123-1 and the second voice coil 123-2 may be made similar, thereby ensuring that the driving force of the first voice coil 123-1 and the second voice coil 123-2 is close or the same, thereby improving the vibration consistency of the first diaphragm 121-1 and the second diaphragm 121-2, and further providing support for improving the output effect of the loudspeaker 120 and the active noise reduction effect of the headphone against larger ambient noise in the open-ear wearing state. Illustratively, the ratio of the volume of the second outer magnet 1223 to the volume of the second inner magnet 1222 may be 0.3 to 3.

When the volume of the second outer magnet 1223 is too small relative to the volume of the second inner magnet 1222, the driving force of the second voice coil 123-2, which is close to the second outer magnet 1223 and away from the second inner magnet 1222, is small, and the driving force of the first voice coil 123-1, which is away from the second outer magnet 1223 and close to the second inner magnet 1222, is large, thereby causing a large driving force difference between the first voice coil 123-1 and the second voice coil 123-2. Similarly, when the volume of the second outer magnet 1223 is too large relative to the volume of the second inner magnet 1222, the driving force of the second voice coil 123-2, which is close to the second outer magnet 1223 and away from the second inner magnet 1222, is large, and the driving force of the first voice coil 123-1, which is away from the second outer magnet 1223 and close to the second inner magnet 1222, is small, thereby causing a large driving force difference between the first voice coil 123-1 and the second voice coil 123-2.

That is, when the volume of the second outer magnet 1223 and the volume of the second inner magnet 1222 differ too much, it will lead to the large driving force difference between the first voice coil 123-1 and the second voice coil 123-2, thereby affecting the active noise reduction effect of the headphone. Therefore, in order to further improve the vibration consistency of the first diaphragm 121-1 and the second diaphragm 121-2 and the active noise reduction effect of the headphone, the ratio of the volume of the second outer magnet 1223 to the volume of the second inner magnet 1222 may be 0.5 to 1.5.

The following mainly describes the relevant structure of the loudspeaker 120 in a case where the first diaphragm 121-1 and the second diaphragm 121-2 are directly fixedly connected to achieve synchronous and co-directional vibration of the two diaphragms. It is to be understood that the direct connection of the first diaphragm 121-1 and the second diaphragm 121-2 can ensure the vibration consistency of the two diaphragms, thereby providing support for the peak resonance frequency of the first resonance peak to shift to a low-frequency band and the peak resonance frequency of the second resonance peak to shift to a high-frequency band, and further providing a guarantee for the headphone to achieve active noise reduction within a wider frequency band range.

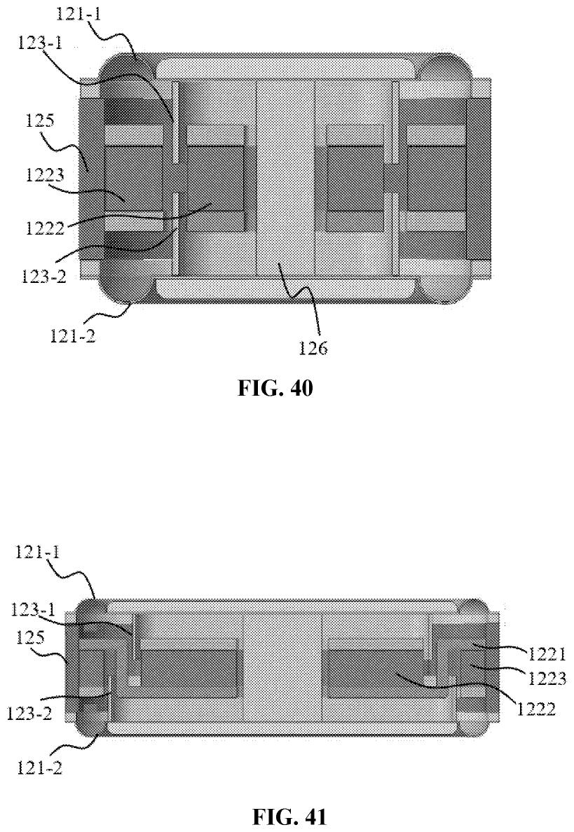

Referring to FIGS. 40 to 42, the first diaphragm 121-1 and the second diaphragm 121-2 are directly connected through a second connection component 126, to make the first diaphragm 121-1 and the second diaphragm 121-2 vibrate synchronously and co-directionally. For example, the magnetic circuit assembly may be provided with a through-hole, wherein the through-hole extends through the second inner magnet 1222, a magnetic conductive plate at an upper end of the second inner magnet 1222, and the bottom of the magnetic conductive cover 1221 at a lower end of the second inner magnet 1222. The second connection component 126 is disposed in the through-hole, thereby connecting the first diaphragm 121-1 and the second diaphragm 121-2. The provision of the through-hole can further ensure that when the first diaphragm 121-1 and the second diaphragm 121-2 vibrate, the air in the common cavity 111-3 between the first diaphragm 121-1 and the second diaphragm 121-2 can move back and forth as an accompanying mass with the vibration of the two diaphragms, thereby avoiding, as much as possible, the two diaphragms from compressing the common cavity 111-3 and affecting peaks and valleys of resonance peaks of a frequency response curve, improving the output quality of the headphone, and further improving the active noise reduction effect of the headphone.

In some embodiments where the magnetic circuit assembly is formed by a combination of the outer magnetic circuit component and the inner magnetic circuit component, the through-hole may be configured to extend through the first magnetic conductive plate, the inner magnet, and the second magnetic conductive plate, to enable the second connection component 126 to pass through the inner magnetic circuit component and connect between the first diaphragm 121-1 and the second diaphragm 121-2. Further descriptions thereof are omitted here.

In some embodiments, the second connection component 126 needs to have a high deformation resistance capability to ensure the connection of the first diaphragm 121-1 and the second diaphragm 121-2, while minimizing the deformation of the second connection component 126 itself, thereby improving the vibration consistency of the first diaphragm 121-1 and the second diaphragm 121-2. Illustratively, the Young's modulus of the material of the second connection component 126 may be 100 MPa to 150 MPa. In order to further improve the vibration consistency of the first diaphragm 121-1 and the second diaphragm 121-2, the Young's modulus of the material of the second connection component 126 may be 110 MPa to 140 MPa, for example, the Young's modulus of the material of the second connection component 126 may be 120 MPa.

In some embodiments, considering that to improve the vibration consistency of the first diaphragm 121-1 and the second diaphragm 121-2, the contact region of the two ends of the second connection component 126 with the first diaphragm 121-1 and the second diaphragm 121-2 should not be too small, so as to be able to better transmit the deformation and the power between the first diaphragm 121-1 and the second diaphragm 121-2. However, when the size of the second connection component 126 is too large, it will lead to an excessively large size of the through-hole of the magnetic circuit assembly, thereby affecting the driving force coefficient of the loudspeaker 120 and the output of the loudspeaker 120.

Therefore, in order to ensure that the loudspeaker 120 has a large driving force coefficient while improving the vibration consistency of the first diaphragm 121-1 and the second diaphragm 121-2, the size of the second connection component 126 may be 3.4 mm*1.4 mm*4.7 mm.

In some embodiments, in order to prevent the second connection component 126 from adding an excessive load to the first diaphragm 121-1 and the second diaphragm 121-2, and to ensure the driving force coefficient of the loudspeaker 120, the mass of the second connection component 126 should be small. That is, when the size of the second connection component 126 is fixed, the density of the second connection component 126 should not be too large. Therefore, in order to reduce the load on the first diaphragm 121-1 and the second diaphragm 121-2, the density of the second connection component 126 may be 100 kg/m³ to 140 kg/m³. In order to further reduce the load on the first diaphragm 121-1 and the second diaphragm 121-2, the density of the second connection component 126 may be 105 kg/m³ to 120 kg/m³, for example, the density of the second connection component 126 may be 110 kg/m³.

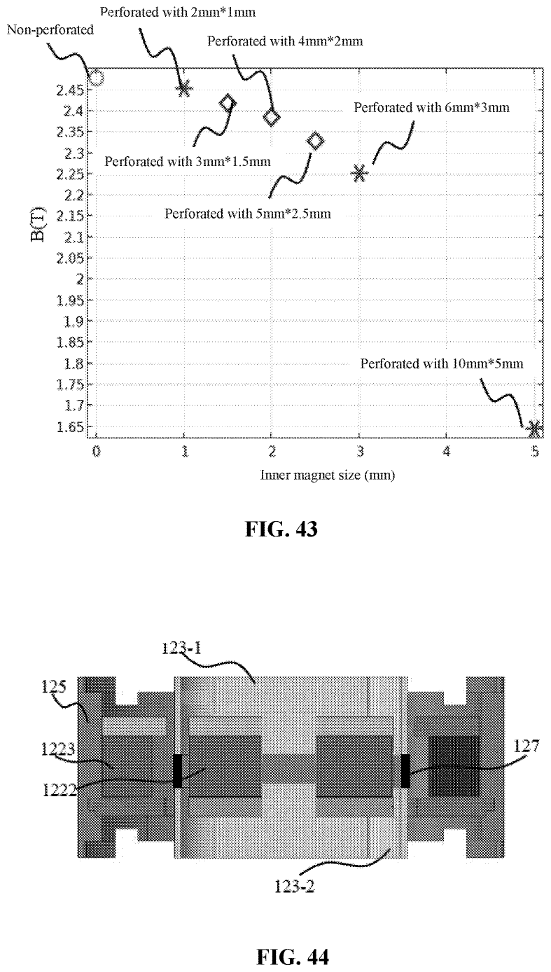

FIG. 43 is a schematic diagram illustrating driving force coefficients of the loudspeaker 120 corresponding to through-holes of different sizes according to some embodiments of the present disclosure. For example, taking the second connection component 126 as a prism of 3.4 mm*1.4 mm*4.7 mm, the measured driving force coefficients of the loudspeaker 120 for through-hole sizes of 0 mm*0 mm, 2 mm*1 mm, 4 mm*2 mm, 5 mm*2.5 mm, 6 mm*3 mm, and 10 mm*5 mm, respectively, are shown in FIG. 43.

A through-hole size (also referred to as the size of the through-hole) of 0 mm*0 mm means that no through-hole is provided; at this time, it may be considered that the first diaphragm 121-1 and the second diaphragm 121-2 are not directly connected through the second connection component 126, but rather the first voice coil 123-1 and the second voice coil 123-2 are connected, thereby making the first diaphragm 121-1 and the second diaphragm 121-2 indirectly connected (e.g., as shown in FIG. 44).

As shown in FIG. 43, the larger the size of the through-hole, the smaller the corresponding driving force coefficient of the loudspeaker 120. Taking the driving force coefficient of the loudspeaker 120 when the through-hole size is 0 mm*0 mm as a benchmark, when the through-hole size is 2 mm*1 mm, the influence on the driving force coefficient of the loudspeaker 120 can be substantially negligible. When the through-hole size is 4 mm*2 mm, the driving force coefficient of the loudspeaker 120 decreases by 0.1, and the decrease is relatively small. When the through-hole size is 6 mm*3 mm, the driving force coefficient of the loudspeaker 120 decreases by 0.15.

Since the second connection component 126 is disposed through the through-hole, the size of the through-hole will also affect the size of the second connection component 126. If the size of the through-hole is too small, it may cause the size of the second connection component 126 to be too small, the connection strength of the second connection component 126 may be insufficient, and the second connection component 126 may easily break or be damaged.

Taking all factors into consideration, in some embodiments, in order to enable the loudspeaker 120 to have a large driving force coefficient and the second connection component 126 to have a suitable size, the length of the through-hole may be 2 mm to 10 mm, and the width may be 1 mm to 5 mm.

In some embodiments, while the first diaphragm 121-1 and the second diaphragm 121-2 are directly connected through the second connection component 126, the first voice coil 123-1 and the second voice coil 123-2 may also be connected through the first connection component 127. The first connection component 127 may prevent the first voice coil 123-1 and the second voice coil 123-2 from generating relative displacement, thereby further improving the vibration consistency of the first diaphragm 121-1 and the second diaphragm 121-2.

In this way, through the configuration of the direct connection of the first diaphragm 121-1 and the second diaphragm 121-2, and the direct connection of the first voice coil 123-1 and the second voice coil 123-2, the probability of separation of the first diaphragm 121-1 and the second diaphragm 121-2 can be further reduced, thereby improving the vibration consistency of the first diaphragm 121-1 and the second diaphragm 121-2. At the same time, the configuration in which the first diaphragm 121-1 and the second diaphragm 121-2 are directly connected through the second connection component 126 can also reduce the difficulty of precision requirements for alignment when the first voice coil 123-1 and the second voice coil 123-2 are connected, thereby reducing the operation difficulty.

In other embodiments, referring to FIG. 44, when the magnetic circuit assembly is provided with a through-hole, the first diaphragm 121-1 and the second diaphragm 121-2 may also not be directly connected through the second connection component 126, but rather the first voice coil 123-1 and the second voice coil 123-2 are connected through the first connection component 127, to make the first diaphragm 121-1 and the second diaphragm 121-2 indirectly connected. At this time, the through-hole can further ensure that the air in the common cavity 111-3 between the first diaphragm 121-1 and the second diaphragm 121-2 can move back and forth as an accompanying mass with the vibration of the two diaphragms, thereby avoiding, as much as possible, the two diaphragms from compressing the common cavity 111-3 and causing peaks and valleys in the frequency response, improving the output quality of the headphone, and improving the active noise reduction effect of the headphone.

As described in some preceding embodiments, the second outer magnet 1223 is disposed in the magnetic conductive cover 1221. At this time, when the long side portion and the short side portion of the second outer magnet 1223 are separated structures, in order to fix the second outer magnet 1223 and prevent the second outer magnet 1223 from falling off, the magnetic circuit assembly may include the frame 125, wherein the frame 125 is disposed around the second outer magnet 1223, and the frame 125 cooperates with the magnetic conductive cover 1221 to fix the second outer magnet 1223.

As described in some preceding embodiments, the magnetic circuit assembly may include the magnetic conductive cover 1221, the second inner magnet 1222, the second outer magnet 1223, or the like. By making an improved design of the magnetic circuit structure, it may help to further enhance the driving force of the loudspeaker 120.

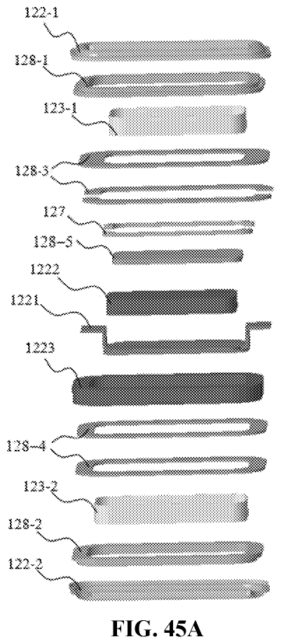

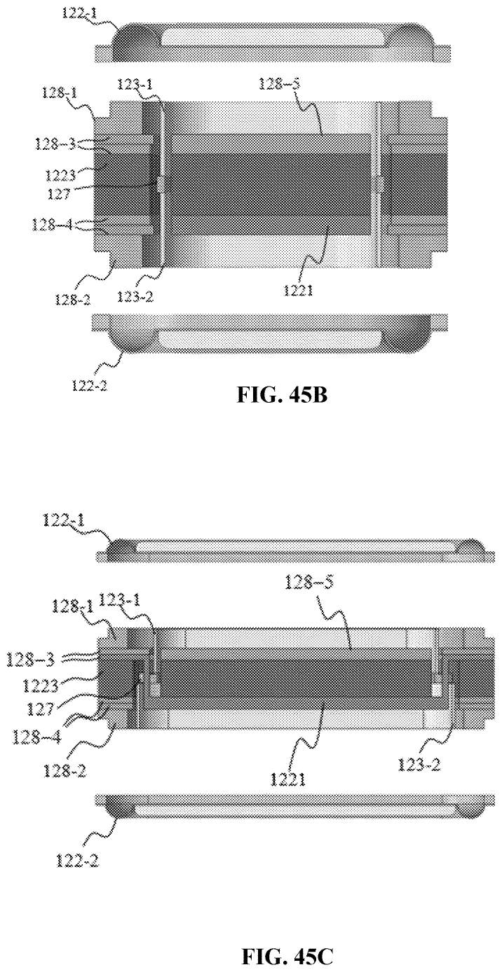

For example, referring to FIGS. 45A to 45C, the second outer magnet 1223 may be an annular structure, and the second outer magnet 1223 is disposed around the magnetic conductive cover 1221. The annular structure of the second outer magnet 1223 can enable the second outer magnet 1223 to have a large volume, to enhance magnetic flux, thereby enhancing the driving force of the loudspeaker 120. The annular structure of the second outer magnet 1223 can also reduce the assembly difficulty and improve the assembly efficiency.

In some embodiments where the second outer magnet 1223 is an annular structure and the second outer magnet 1223 is disposed in the magnetic conductive cover 1221, the magnetic circuit assembly may also not be provided with the frame 125, but rather the second outer magnet 1223 is installed and fixed by the upper fixing bracket 128-1 and the lower fixing bracket 128-2.

Specifically, referring to FIGS. 45A to 45C, the first diaphragm 121-1 may be fixed to an upper fixing bracket 128-1, and the upper side surface of the second outer magnet 1223 is connected to the upper fixing bracket 128-1 through an upper outer magnetic conductive plate 128-3. The second diaphragm 121-2 may be fixed to a lower fixing bracket 128-2, and the lower side surface of the second outer magnet 1223 is connected to the lower fixing bracket 128-2 through a lower outer magnetic conductive plate 128-4. At this time, the lower side surface of the second inner magnet 1222 is connected to the bottom of the magnetic conductive cover 1221, and the upper side surface of the second inner magnet 1222 is connected to an inner magnetic conductive plate 128-5. Through the design of the upper fixing bracket 128-1 and the lower fixing bracket 128-2, the frame 125 may be omitted, thereby allowing the magnetic circuit assembly to have a larger design size, which in turn will further increase the volume of the magnets (e.g., the second inner magnet 1222, the second outer magnet 1223, or the like), to further increase the driving force of the loudspeaker 120.

In some embodiments, the material of the upper fixing bracket 128-1 and the lower fixing bracket 128-2 may be a plastic material; and the upper fixing bracket 128-1 and the lower fixing bracket 128-2 may be connected to a corresponding magnetic conductive plate through forms such as injection molding, adhesive bonding, bolts, snap fits, or the like. Certainly, a material of the upper fixing bracket 128-1 and the lower fixing bracket 128-2 may also be a metal material, and the upper fixing bracket 128-1 and the lower fixing bracket 128-2 may be connected to the corresponding magnetic conductive plates by means of adhesive bonding, welding, bolts, buckles, or the like.

In some embodiments, an outer magnetic conductive plate corresponding to the second outer magnet 1223 (e.g., the upper outer magnetic conductive plate 128-3, the lower outer magnetic conductive plate 128-4, or the like) may include two interconnected components, one of which is configured to be connected to the corresponding fixing bracket, and the other of which is configured to be connected to the second outer magnet 1223. The two aforementioned components may be separately connected or may be integrally formed.

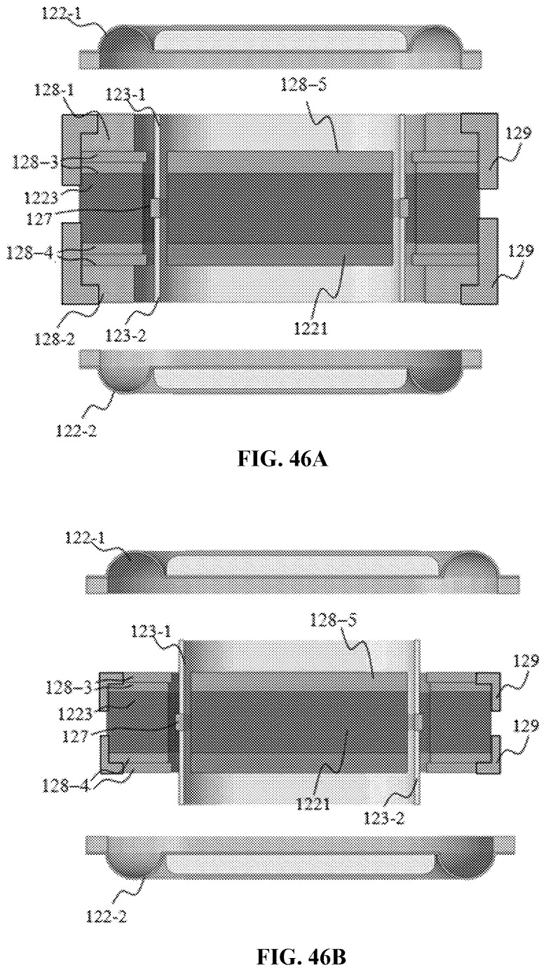

In some embodiments, referring to FIG. 46A, the magnetic circuit assembly may also include a magnetic circuit fixing ring 129. The magnetic circuit fixing ring 129 is sleeved on the outside of the upper fixing bracket 128-1 and the lower fixing bracket 128-2. By means of the magnetic circuit fixing ring 129, the fixing brackets, the corresponding outer magnetic conductive plates, and the second outer magnet 1223 are connected as an integral whole, thereby further improving an installation stability of the magnetic circuit assembly and improving a vibration stability of the loudspeaker 120. The magnetic circuit fixing ring 129 and the corresponding fixing brackets may be separately connected or may be integrally provided.

In some embodiments, referring to FIG. 46B, the magnetic circuit assembly may not be provided with the upper fixing bracket 128-1 and the lower fixing bracket 128-2. Instead, the magnetic circuit fixing ring 129 replaces the upper fixing bracket 128-1 and the lower fixing bracket 128-2, and the magnetic circuit assembly is directly assembled and fixed by means of the magnetic circuit fixing ring 129, thereby reducing assembly difficulty.

In some embodiments, a material of the magnetic circuit fixing ring 129 may be the same as a material of the upper fixing bracket 128-1 and the lower fixing bracket 128-2, and a connection manner between the magnetic circuit fixing ring 129 and the corresponding fixing brackets or the corresponding outer magnetic conductive plates may be the same as a connection manner between the corresponding fixing brackets and the corresponding outer magnetic conductive plates.

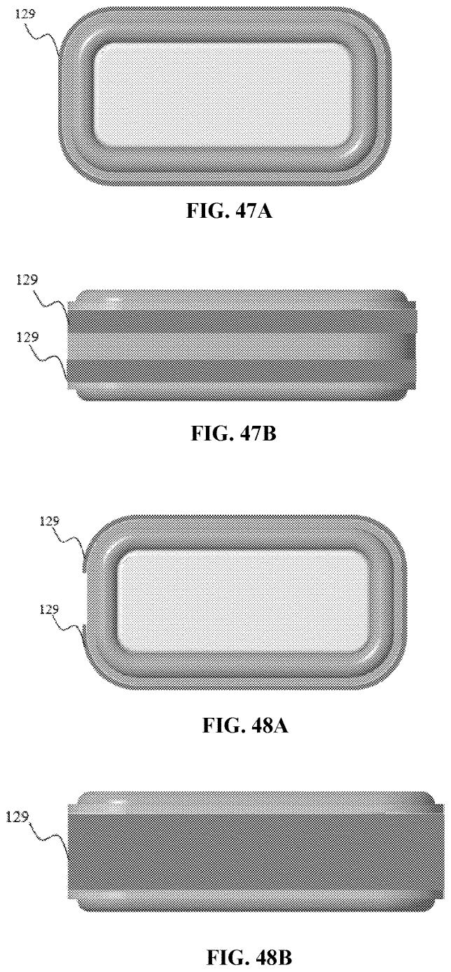

In some embodiments, referring to FIGS. 47A and 47B, the magnetic circuit fixing ring 129 may include two ring-shaped sub-rings. The two sub-rings are respectively provided on upper and lower sides of the second outer magnet 1223, to respectively assemble and fix upper and lower sides of the second outer magnet 1223 and the corresponding outer magnetic conductive plates, fixing brackets, or the like.

In some embodiments, referring to FIGS. 48A and 48B, the magnetic circuit fixing ring 129 may include two semi-ring-shaped sub-rings. An interval position of the two sub-rings may be provided in the short axis direction of the loudspeaker 120. In this case, the sub-rings may assemble and fix a long side portion of the outer magnetic conductive plate, a corresponding long side portion of the second outer magnet 1223, and a corresponding long side portion of the fixing bracket.

In other embodiments, an interval position of the two sub-rings may also be provided in the long axis direction of the loudspeaker 120. In this case, the sub-rings may assemble and fix a short side portion and a partial long side portion of the outer magnetic conductive plate, a corresponding short side portion and a partial corresponding long side portion of the second outer magnet 1223, and a corresponding short side portion and a partial corresponding long side portion of the fixing bracket.

As described above, by designing a diaphragm, support may also be provided for active noise reduction of the headphone in a wider frequency band range. However, for a dual-diaphragm loudspeaker, it is necessary to collaboratively design structures of the two diaphragms to ensure that the peak resonance frequency of the first resonance peak of the loudspeaker 120 is low, while avoiding unnecessary distortion of resonance, and further avoiding affecting the active noise reduction effect of the headphone, thereby enabling active noise reduction to be supported in a wider frequency band range. Therefore, the present disclosure will mainly introduce the diaphragm and related structures thereof.

In some embodiments, referring to FIG. 28, the loudspeaker 120 includes the first diaphragm 121-1, the second diaphragm 121-2, the bracket assembly, the voice coil assembly, and the magnetic circuit assembly, or the like. The first diaphragm 121-1 and the second diaphragm 121-2 are spaced apart from each other in the vibration direction. The bracket assembly surrounds a periphery of the voice coil assembly, and the bracket assembly and the voice coil assembly are spaced apart in a radial direction perpendicular to the vibration direction (for the sound generating unit 100, the radial direction may include long axis direction and short axis direction). The first diaphragm 121-1 and the second diaphragm 121-2 have a same structure and are symmetrically provided along a reference plane perpendicular to a vibration direction. Such a configuration may ensure a consistency of the vibration of the first diaphragm 121-1 and the second diaphragm 121-2 in a same direction, to improve a stability of the output of the loudspeaker 120.

In some embodiments, by designing a diaphragm (e.g., the first diaphragm 121-1 or the second diaphragm 121-2), the first resonance peak of the loudspeaker 120 in a low frequency range (e.g., below 200 Hz) may be adjusted, thereby improving a low-frequency output of the loudspeaker 120, and further improving the active noise reduction effect of the headphone on the low-frequency ambient noise.

FIG. 63 is a schematic diagram illustrating frequency response curves for a headphone with different diaphragms according to some embodiments of the present disclosure. The curve L401 represents a frequency response of the headphone when the diaphragm is made of a PU (polyurethane) material and has a thickness of 0.35 mm. The curve L402 represents a frequency response of the headphone when the diaphragm is made of a PU material and has a thickness of 0.45 mm. The curve L403 represents a frequency response of the headphone when the diaphragm is made of a PU material and has a thickness of 0.55 mm. As shown in FIG. 63, a low-frequency resonance peak of The curve L401 is near 145 Hz, a low-frequency resonance peak of The curve L402 is near 185 Hz, and a low-frequency resonance peak of The curve L403 is near 230 Hz. By comparing the curve L401, the curve L402, and the curve L403, a resonance frequency corresponding to the low-frequency resonance peaks of the three gradually decreases as a diaphragm thickness decreases. Therefore, in some embodiments, in order to enable the loudspeaker 120 to have a flatter output in a wider frequency band range, to improve a low-frequency output of the loudspeaker 120, and to further improve the active noise reduction effect of the headphone on the low-frequency ambient noise, the low-frequency resonance frequency of the loudspeaker 120 may be between 100 Hz and 300 Hz, a material of the diaphragm may include a PU material, and a thickness of the diaphragm may be 0.2 mm to 0.07 mm. In some embodiments, in order to further reduce the low-frequency resonance frequency of the loudspeaker 120, when the material of the diaphragm is PU, the thickness of the diaphragm may be 0.35 mm to 0.55 mm.

Further, in some embodiments, in order to reduce a resonance frequency of the loudspeaker 120 in a low frequency range (e.g., below 300 Hz), to enable the loudspeaker 120 to have a flatter output in a wider frequency band range, to improve a low-frequency output of the loudspeaker 120, and to further improve the active noise reduction effect of the headphone on the low-frequency ambient noise, the material of the diaphragm may include liquid silicone, and the thickness of the diaphragm may be 0.055 mm to 0.1 mm.

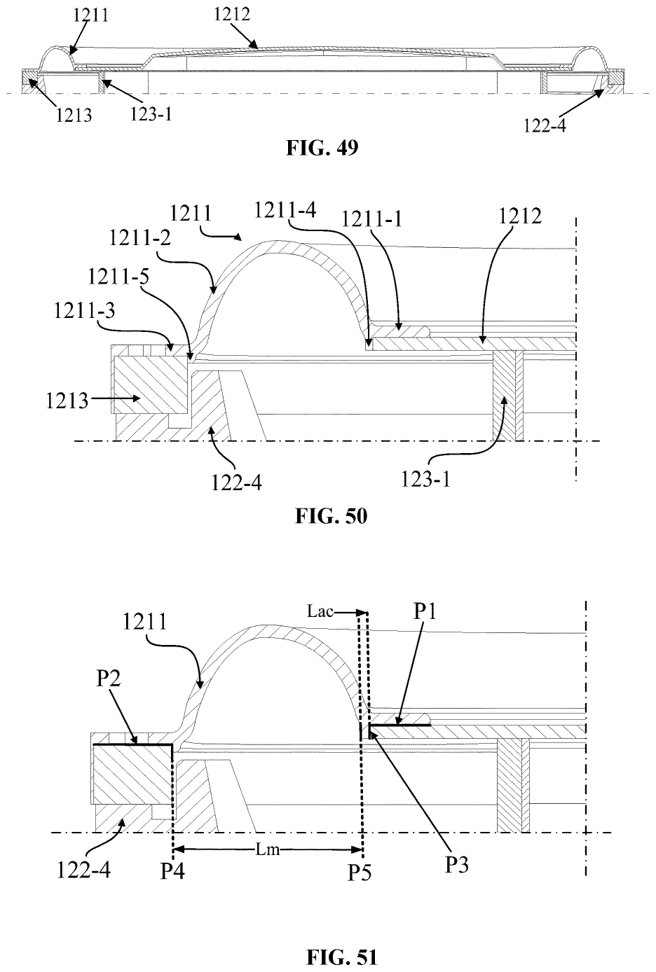

In some embodiments, for a dual-diaphragm loudspeaker, in order to reduce distortion caused by unstable vibration of the first diaphragm 121-1 or the second diaphragm 121-2, a component structure may be adopted to optimize stability of structural connection between the first diaphragm 121-1 or the second diaphragm 121-2 and related components. Referring to FIG. 49, taking the first diaphragm 121-1 as an example, the first diaphragm 121-1 includes a diaphragm 1211, a center patch 1212, and a fixing ring 1213. The diaphragm 1211 is connected around an outer periphery of the center patch 1212. The center patch 1212 is connected to the voice coil assembly (e.g., the center patch 1212 of the first diaphragm 121-1 is bonded or welded and fixed to the first voice coil 123-1). A portion of the diaphragm 1211 that is radially away from the center patch 1212 is connected to the fixing ring 1213. The bracket assembly is fixedly connected to the fixing ring 1213 (e.g., the fixing ring 1213 of the first diaphragm 121-1 is bonded or welded and fixed to the first bracket 122-4).

It should be noted that the first diaphragm 121-1 and the second diaphragm 121-2, which are formed by a combination of the diaphragm 1211, the center patch 1212, and the fixing ring 1213, or the like, may be understood as a component structure. That is, the first diaphragm 121-1 may be referred to as a first diaphragm assembly, and the second diaphragm 121-2 may be referred to as a second diaphragm assembly. Taking the first diaphragm assembly as an example, a region occupied by the center patch 1212 on the first diaphragm 121-1 or the center patch 1212 itself may be regarded as a main body region of the first diaphragm 121-1, and a region occupied by the diaphragm 1211 on the first diaphragm 121-1 or the diaphragm 1211 itself may be regarded as a surround region of the first diaphragm 121-1.

In some embodiments, the diaphragm 1211 may be made of the silicone material. In some embodiments, the center patch 1212 may be made of one or more of magnesium-aluminum alloy, carbon fiber, polymethacrylimide (PMI, also known as a rigid foam plastic) with an aluminum-coated surface, or Polyethylene naphthalate (PEN) with an aluminum-coated surface.

Such a configuration, based on a silicone material with high temperature stability as the diaphragm 1211 or the surround region of the diaphragm assembly, may effectively improve temperature stability of the diaphragm assembly, and provide a guarantee for ensuring a sound output effect of the loudspeaker 120 and the active noise reduction effect, or the like. At the same time, by utilizing the center patch 1212 with strong adhesion and high mechanical strength to establish a structural connection relationship between the voice coil assembly and the diaphragm 1211, and by utilizing the fixing ring 1213 to establish a structural connection relationship between the bracket assembly and the diaphragm 1211, structural stability between the diaphragm assembly, the voice coil assembly, or the like, may be effectively enhanced, overcoming a problem of poor adhesion performance of silicone material, while ensuring stable vibration of the diaphragm assembly and the voice coil assembly to generate sound, and avoiding mutual separation of the voice coil assembly and the diaphragm assembly during vibration.

Due to the poor adhesion performance of the silicone material, it is difficult to bond and fix the diaphragm 1211 to the center patch 1212 and the fixing ring 1213 using an adhesive. In some embodiments, the diaphragm assembly (namely, the first diaphragm 121-1 and the second diaphragm 121-2) may be an integral structure. For example, the diaphragm 1211, the center patch 1212, and the fixing ring 1213 may be integrally injection molded, which may effectively enhance stability of structural connection among components of the diaphragm assembly itself.

Referring to FIGS. 50 and 51, in some embodiments, the diaphragm 1211 may include a first connection portion 1211-1, a surround portion 1211-2, and a second connection portion 1211-3. The first connection portion 1211-1, the surround portion 1211-2, and the second connection portion 1211-3 are sequentially connected from inside to outside in the radial direction. That is, the surround portion 1211-2 is connected around an outer periphery of the first connection portion 1211-1, and the second connection portion 1211-3 is connected around an outer periphery of the surround portion 1211-2.

Further, in some embodiments, the diaphragm 1211 also includes a third connection portion 1211-4 and a fourth connection portion 1211-5. The third connection portion 1211-4 is connected at one end in the vibration direction to a connection point between the surround portion 1211-2 and the first connection portion 1211-1. It may also be understood that the third connection portion 1211-4 is formed by the surround portion 1211-2 extending a certain length along the vibration direction towards a side of the magnetic circuit assembly, at an end radially close to the first connection portion 1211-1 or the center patch 1212. The fourth connection portion 1211-5 is connected at one end in the vibration direction to a connection point between the surround portion 1211-2 and the second connection portion 1211-3. It may also be understood that the fourth connection portion 1211-5 is formed by the surround portion 1211-2 extending a certain length along the vibration direction towards a side of the magnetic circuit assembly, at an end radially close to the second connection portion 1211-3 or the fixing ring 1213.

In the vibration direction, the inside surface of the first connection portion 1211-1 is fitted and connected to the outside surface of the center patch 1212, and the inside surface of the second connection portion 1211-1 is fitted and connected to the outside surface of the fixing ring 1213. In the radial direction, the inner circumferential surface of the third connection portion 1211-4, which is close to a side of the voice coil assembly, is fitted and connected to a circumferential side surface of the center patch 1212, and the outer circumferential surface of the fourth connection portion 1211-5, which is away from a side of the voice coil assembly, is fitted and connected to the inner circumferential surface of the fixing ring 1213.

For convenience of distinction and description, in the present disclosure, the inside surface refers to a surface close to the side of the magnetic circuit assembly in the vibration direction; the outside surface refers to a surface away from the side of the magnetic circuit assembly in the vibration direction; the inner circumferential surface refers to a surface close to the center point of the diaphragm 1211 in the radial direction; and the outer circumferential surface refers to a surface away from the center point of the diaphragm 1211 in the radial direction. Illustratively, the inside surface of the first connection portion 1211-1 refers to a first surface P1; the inside surface of the second connection portion 1211-3 refers to a second surface P2; the inner circumferential surface of the third connection portion 1211-4 refers to a third surface P3; the outer circumferential surface of the fourth connection portion 1211-5 refers to a fourth surface P4; and the outer circumferential surface of the third connection portion 1211-4 refers to a fifth surface P5.

Such a configuration, based on the first surface P1 and the third surface P3, enables the diaphragm 1211 to cover and fit the outside surface and the outer circumferential side surface of the center patch 1212. This may not only effectively increase a connection area between the diaphragm 1211 and the center patch 1212 and enhance a connection strength between the diaphragm 1211 and the center patch 1212, but also provide support for a structural connection between the inside surface of the center patch 1212 and the voice coil assembly.

In some embodiments, when the first surface P1 is fitted and connected to the outside surface of the center patch 1212, the outside surface of the center patch 1212 may be entirely covered and fitted by the first connection portion 1211-1 or the first surface P1, or the first connection portion 1211-1 or the first surface P1 may also circularly cover and fit a part of the outside surface of the center patch 1212. In other embodiments, one or both of the third connection portion 1211-4 and the fourth connection portion 1211-5 may also be omitted.

In some embodiments, when the outside surface and the outer circumferential side surface of the center patch 1212 are covered and fitted by the diaphragm 1211, a lower surface of the center patch 1212 may also be covered and fitted by the diaphragm 1211, to further enhance stability of connection between the diaphragm 1211 and the center patch 1212.

Specifically, the diaphragm 1211 also has a fifth connection portion. The fifth connection portion is spaced apart from the first connection portion 1211-1 in the vibration direction, and the third connection portion 1211-4 is connected in the vibration direction between the fifth connection portion and the surround portion 1211-2. In the vibration direction, the outside surface of the fifth connection portion is fitted and connected to an edge region of the inside surface of the center patch 1212, and the voice coil assembly is connected to a region of the inside surface of the center patch 1212 not covered by the fifth connection portion. Thus, the fifth connection portion may further enhance stability of structural connection between the diaphragm 1211 and the center patch 1212. In this case, in order to avoid the diaphragm from having a negative impact on a connection between the voice coil assembly and the center patch 1212, a minimum distance between the fifth connection portion and the voice coil assembly in the radial direction may be set to be more than or equal to 0.5 mm.

In some embodiments, referring to FIG. 50, the surround portion 1211-2 adopts an arched structure that protrudes relative to the outside surface of the center patch 1212 or the outside surface of the fixing ring 1213. For example, the surround portion 1211-2 bends and arches along the vibration direction relative to the first connection portion 1211-1 towards a side away from the voice coil assembly. Thus, for the loudspeaker 120 as a whole, it is equivalent to the surround portion 1211-2 being arched towards an outside of the loudspeaker 120. This may not only provide ample space for the magnetic circuit assembly, or the like, inside the loudspeaker 120, allowing the magnetic circuit assembly to have a larger design size, thereby facilitating the enhancement of a driving force of the magnetic circuit assembly and the voice coil assembly on the diaphragm assembly, but also avoid the diaphragm 1211 from interfering with sound generating structures (e.g., the magnetic circuit assembly, or the like) due to deformation during a vibration process, and ensure a quality of sound output.

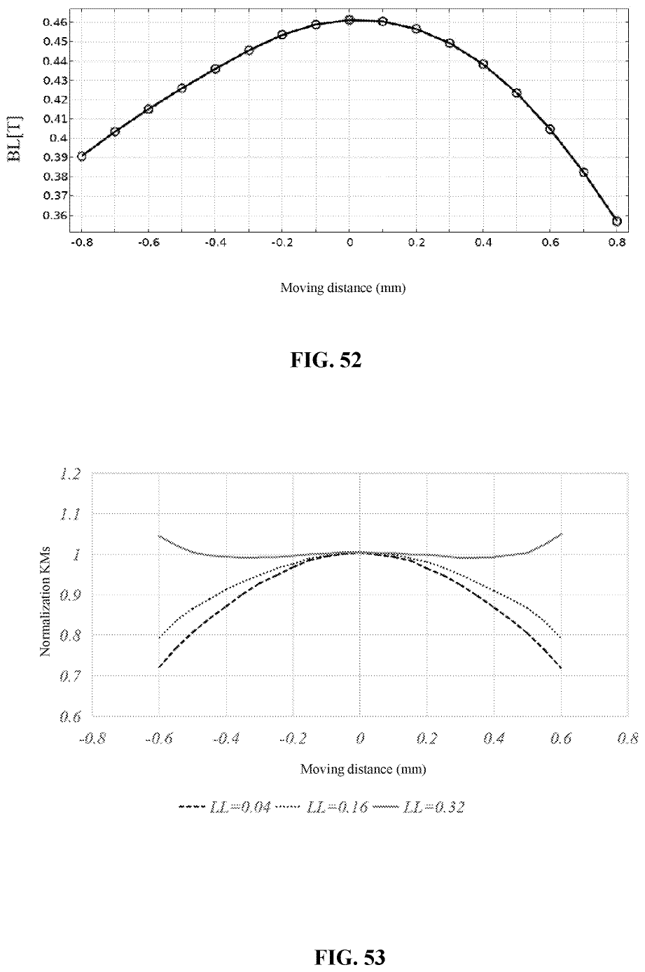

FIG. 52 is a schematic diagram illustrating a BLx curve that represents a product (BL) of magnetic flux density (B) and voice coil length (L) of the loudspeaker 120 as a function of a moving distance (x) of the voice coil assembly. Referring to FIG. 52, when the voice coil assembly moves to ±0.6 mm, the change in the BLx curve is approximately 17%; and when the voice coil assembly moves to ±0.8 mm, the change in the BLx curve is approximately 25%. Considering that the KMs curve of the diaphragm assembly is one of the key parameters affecting the distortion degree of the loudspeaker 120, when a corresponding ratio of change in the KMs curve is in a similar range within a moving distance range of the voice coil assembly, it may lead to a better matching property between the BLx curve of the loudspeaker 120 and the KMs curve of the diaphragm assembly, which is beneficial for providing the loudspeaker 120 with a low distortion degree. For example, when a curve shape of the KMs curve of the diaphragm assembly and the BLx curve are a matching n-shape, the distortion degree of the loudspeaker 120 is low. Therefore, by designing a structure and a dimensional relationship of the diaphragm assembly, the KMs curve of the diaphragm assembly may be adjusted to match with the BLx curve of the loudspeaker 120, to obtain the loudspeaker 120 with a low distortion degree, thereby providing support for enhancing the active noise reduction of the headphone. The present disclosure will describe in detail below.

In some embodiments, referring to FIG. 51, a minimum radial distance between the fifth surface P5 and the third surface P3 is defined as a first width Ldc. A minimum radial distance between the fifth surface P5 and the fourth surface P4 is defined as a second width Lm. A ratio of the first width Ldc to the second width Lm is defined as a first ratio LL. The first ratio LL may be between 0.04 and 0.32, which may enable the KMs curve of the diaphragm assembly to match the BLx curve of the loudspeaker 120, thereby providing the loudspeaker 120 with a low distortion degree.

Specifically, as the second width Lm changes, different first widths Lac may cause a significant change in a curve shape of the Mechanical stiffness (KMs) curve of the diaphragm assembly, and further affect the final distortion degree of the loudspeaker 120. FIG. 53 illustrates Mechanical stiffness (KMs) curves at different first ratios LL. Referring to FIG. 53, when the first ratio LL is relatively small (i.e., when the connection region of the surround portion 1211-2 and the center patch 1212 is closer to an arc end point of an inner surface of the surround portion 1211-2), the Mechanical stiffness (KMs) curve of the diaphragm assembly is U-shaped. As the first ratio LL increases, the Mechanical stiffness (KMs) curve of the diaphragm assembly gradually transitions from U-shaped to n-shaped, thereby allowing the Mechanical stiffness (KMs) curve to match the BLx curve. When the first ratio LL is 0.04, although the KMs curve is U-shaped, the curve is relatively flat, indicating that the distortion of the loudspeaker 120 is still small at this time. Whereas when the first ratio LL is 0.32, an n-shaped configuration presented by the KMs curve matches the BLx curve of the loudspeaker 120 better, indicating that the distortion of the loudspeaker 120 is smaller at this time.

Therefore, setting the first ratio LL of the diaphragm 1211 to be between 0.04 and 0.32 may effectively reduce the distortion of the loudspeaker 120 and ensure that the loudspeaker 120, when in use, may provide support for the active noise cancellation of the headphone.

Furthermore, in some embodiments, the first ratio LL may be set to 0.16 to enhance the matching degree of the KMs curve of the first diaphragm 121-1 and the KMs curve of the second diaphragm 121-2 with the BLx curve of the loudspeaker 120, thereby obtaining a dual-diaphragm loudspeaker with smaller distortion, and further providing support for improving the active noise cancellation effect of the headphone.

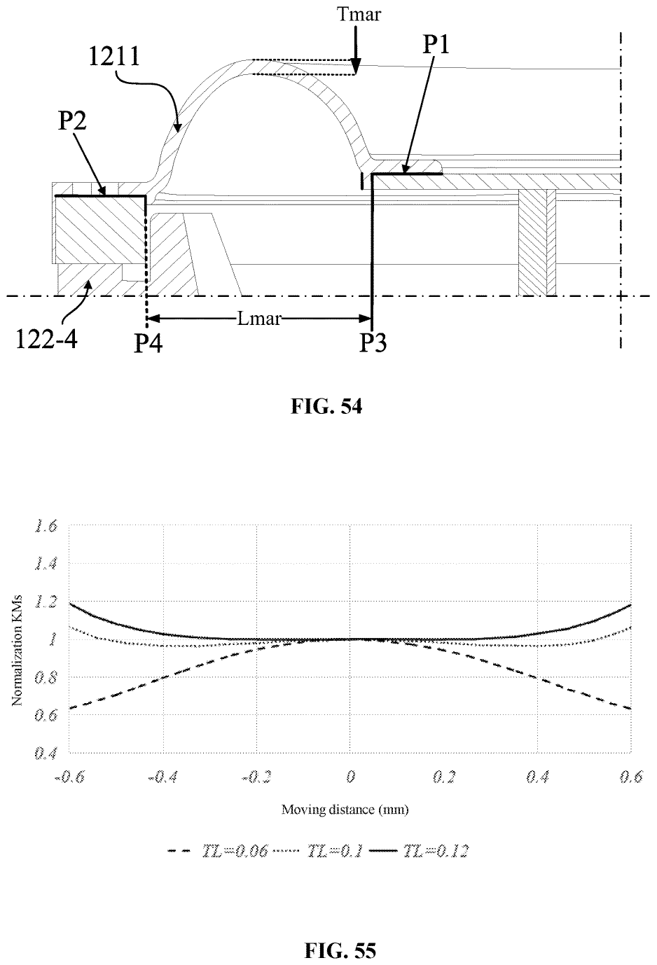

In some embodiments, referring to FIG. 54, a minimum distance between the third surface P3 and the fourth surface P4 in the radial direction (i.e., which is equivalent to the width or span of the surround portion 1211-2 in the radial direction) is defined as a third width Lmar, and a ratio of an average wall thickness Tmar of the surround portion 1211-2 to the third width Lmar is defined as a second ratio TL. Considering that a relationship between the width of the surround portion 1211-2 and the wall thickness of the surround portion 1211-2 not only affects a compliance(S) of the diaphragm assembly, and further affects an f0 (i.e., a resonance frequency) of the loudspeaker 120, but also affects the KMs curve; therefore, the second ratio TL may be no more than 0.12.

Specifically, FIG. 55 illustrates KMs curves at different second ratios TL. Referring to FIG. 55, the smaller the second ratio TL (i.e., the thinner the average wall thickness of the surround portion 1211-2), the flatter the corresponding KMs curve. When the second ratio TL changes from 0.12 to 0.06, the corresponding KMs curve configuration also changes from U-shaped to n-shaped. For example, when the voice coil assembly moves to ±0.6 mm and the second ratio TL is 0.12, the KMs curve changes by about 12%, which is an acceptable state. Therefore, setting the second ratio TL of the diaphragm 1211 to be no more than 0.12 may enable the KMs curve to match the BLx curve, which is beneficial for providing the loudspeaker 120 with lower distortion. Illustratively, the second ratio TL may be set to 0.1, may also be set to 0.06, or may be set to other values less than 0.12.

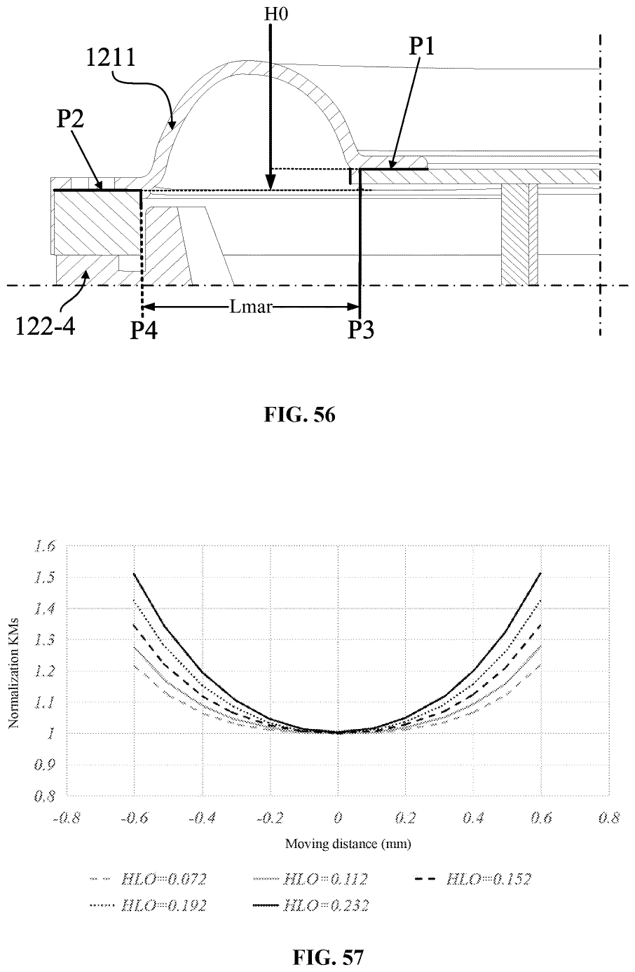

In some embodiments, referring to FIG. 56, a distance from a first surface P1 to a plane where a second surface P2 is located (or a height difference between the first surface P1 and the second surface P2 in the vibration direction) is defined as a first height H0. A ratio of the first height H0 to the third width Lmar is defined as a third ratio HLO. Considering that a relationship between the width of the surround portion 1211-2 and a height difference between the inner and outer ends of the surround portion 1211-2 in the radial direction affects the KMs curve, thereby affecting the distortion of the loudspeaker 120; therefore, the third ratio HLO may be no more than 0.232.

Specifically, FIG. 57 illustrates KMs curves at different third ratios HLO. Referring to FIG. 57, the smaller the third ratio HLO, the flatter the corresponding KMs curve. When the third ratio HLO changes from 0.232 to 0.072, the corresponding KMs curve configuration gradually flattens. For example, when the voice coil assembly moves to ±0.6 mm and the third ratio HLO is 0.232, the KMs curve changes by about 15%, which is an acceptable state. Therefore, setting the third ratio HLO of the diaphragm 1211 to be no more than 0.232 may enable the KMs curve to match the BLx curve, thereby obtaining the loudspeaker 120 with lower distortion.

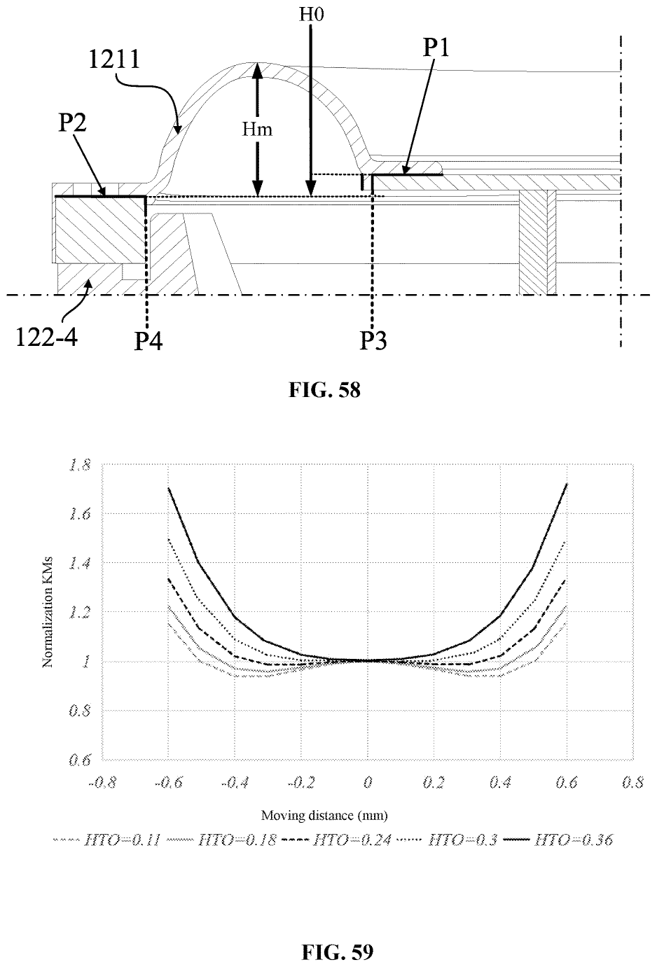

In some embodiments, referring to FIG. 58, a distance from the vertex of the surround portion 1211-2 to the plane where the second surface P2 is located (which may also be understood as an arch height of the surround portion 1211-2) is defined as a second height Hm. A ratio of the first height H0 to the second height Hm is defined as a fourth ratio HTO. Considering that a relationship between an arch height of the surround portion 1211-2 and a height difference between the inner and outer ends of the surround portion 1211-2 also affects the KMs curve, thereby affecting the distortion of the loudspeaker 120; therefore, the fourth ratio HTO may be no more than 0.36.

Specifically, FIG. 59 illustrates KMs curves at different fourth ratios HTO. Referring to FIG. 59, the smaller the fourth ratio HTO, the flatter the corresponding KMs curve. When the fourth ratio HTO changes from 0.36 to 0.11, the corresponding KMs curve configuration gradually flattens. For example, when the voice coil assembly moves to ±0.6 mm and the fourth ratio HTO is 0.36, the KMs curve changes by about 17%, which is an acceptable state. Therefore, by setting the fourth ratio HTO of the diaphragm 1211 to be no more than 0.36, the KMs curve may be enabled to match the BLx curve, thereby obtaining the loudspeaker 120 with lower distortion.

Furthermore, in some embodiments, the fourth ratio HTO may be set within a range from 0.36 to 0.11. For example, the fourth ratio HTO may be 0.18, 0.24, 0.3, or the like. In this case, the KMs curve is flatter, and the distortion of the loudspeaker 120 is lower, thereby providing support for the headphone to perform active noise cancellation within a wider frequency band range.

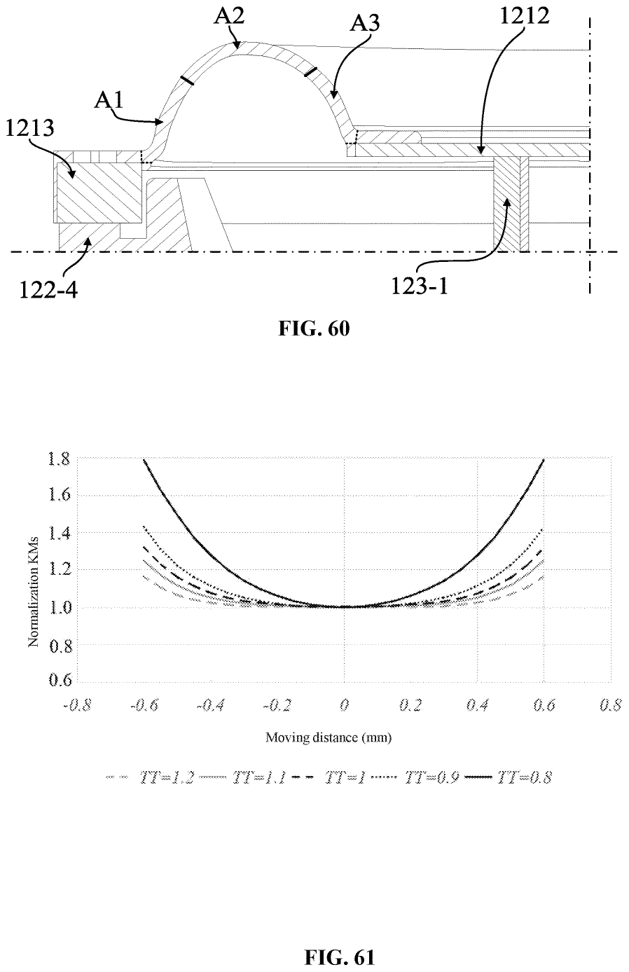

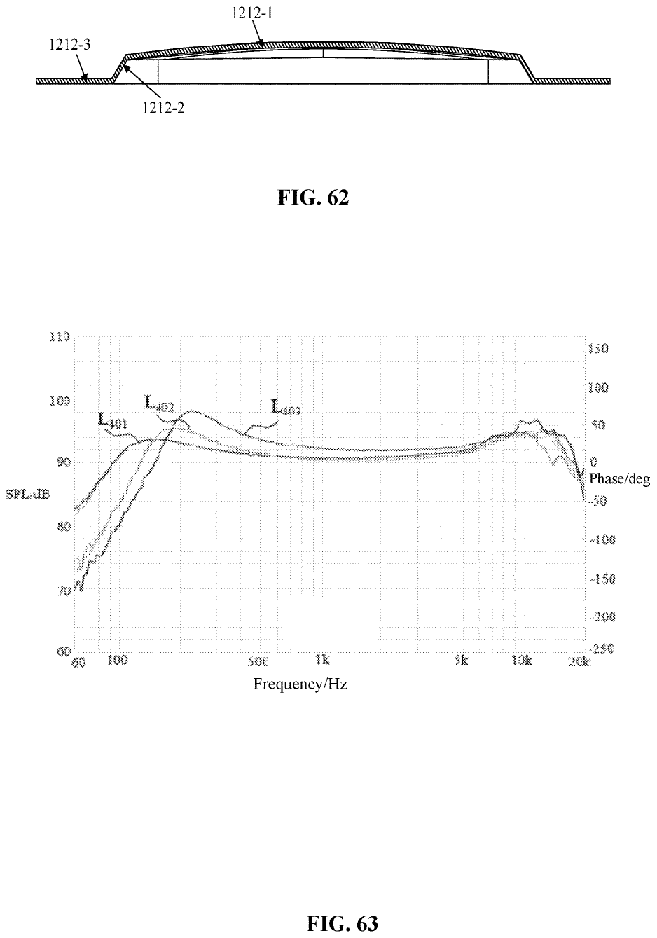

In some embodiments, referring to FIG. 60, the surround portion 1211-2 is sequentially equally divided into a first arc-shaped region A1, a second arc-shaped region A2, and a third arc-shaped region A3 along the radial direction according to its length, that is, an arc length of each arc-shaped region is one third of the arc length of the surround portion 1211-2. The first arc-shaped region A1 is a region of the surround portion 1211-2 adjacent to the fixing ring 1213 or connected to the second connection portion 1211-3, and the third arc-shaped region A3 is a region of the surround portion 1211-2 adjacent to the center patch 1212 or connected to the second connection portion 1211-3. The fifth ratio TT refers to a ratio of an average wall thickness of the first arc-shaped region A1 to an average wall thickness of the second arc-shaped region A2, and a ratio of an average wall thickness of the third arc-shaped region A3 to the average wall thickness of the second arc-shaped region A2. Considering that a wall thickness relationship between different regions of the surround portion 1211-2 has a significant impact on the KMs curve configuration; therefore, the fifth ratio TT may be no more than 1.2.

Specifically, FIG. 61 illustrates KMs curves at different fifth ratios TT. Referring to FIG. 61, when the fifth ratio TT changes from 1.2 to 0.8, the corresponding KMs curve configuration gradually flattens. For example, when the voice coil assembly moves to ±0.6 mm and the fifth ratio TT is 1.2, the KMs curve changes by about 18%, which is an acceptable state. Therefore, by setting the fifth ratio TT of the diaphragm 1211 to be no more than 1.2 (e.g., 1.1, 1.0, 0.9, 0.8, or the like), the KMs curve may be enabled to match the BLx curve, thereby obtaining the loudspeaker 120 with lower distortion. When the loudspeaker 120 is applied to an open-ear headphone, it may provide support for the headphone to perform active noise cancellation within a wider frequency band range.

In some embodiments, the fifth ratio TT may be set to be no more than 1.0, that is, a wall thickness of the first arc-shaped region A1 and a wall thickness of the third arc-shaped region A3 are smaller than a wall thickness of the second arc-shaped region A2. In this way, the corresponding KMs curve is flatter, and the KMs curve also matches the BLx curve better.

In some embodiments, referring to FIG. 49, the center patch 1212 may employ an arched structure protruding away from the voice coil assembly side along the vibration direction. Specifically, the center patch 1212 has a center region 1212-1, a connecting region 1212-2, and an edge region 1212-3 sequentially connected from inside to outside along the radial direction. Alternatively, the connecting region 1212-2 is connected around an outer periphery of the center region 1212-1, and the edge region 1212-3 is connected around an outer periphery of the connecting region 1212-2. The connecting region 1212-2 is tiltedly arranged relative to the edge region 1212-3 and the center region 1212-1 in the vibration direction, allowing a height difference between a geometric center of the center region 1212-1 and the plane where the edge region 1212-3 is located in the vibration direction, thereby forming the center patch 1212 with an arch structure. The edge region 1212-3 is connected to the diaphragm 1211 and the voice coil assembly. For example, the first connection portion 1211-1 is adherently connected to an outer surface of the edge region 1212-3 in the vibration direction, and the voice coil assembly is connected to an inner surface of the edge region 1212-3 in the vibration direction. Illustratively, the center patch 1212 may be made of carbon fiber material.

Further, in some embodiments, the edge region 1212-3 may be a planar structure perpendicular to the vibration direction, the center region 1212-1 may be a curved surface structure protruding away from the voice coil assembly side in the vibration direction, and the connecting region 1212-2 is adaptively connected between the edge region 1212-3 and the center region 1212-1.

Due to the arched center patch 1212 having a higher strength and height, it is beneficial for improving a high-frequency vibration characteristics of the loudspeaker 120, thereby assisting the headphone to perform active noise cancellation within a wider frequency band range. Meanwhile, the arched center patch 1212 may also prevent the diaphragm 1211 from shaking during large-amplitude vibration, thereby ensuring that the voice coil assembly and a magnetic circuit assembly will not collide. In addition, by utilizing the edge region 1212-3, ample connection area may be provided for the voice coil assembly and the diaphragm 1211, ensuring that the voice coil assembly and the diaphragm 1211 may be stably connected to the center patch 1212.

In other embodiments, the center patch 1212 may also employ other suitable arched structures. For example, the connecting region 1212-2 may be omitted, the center region 1212-1 may employ a curved surface structure protruding away from the voice coil assembly side in the vibration direction, and the edge region 1212-3 is connected around the edge of the center region 1212-1. And so on, which will not be elaborated herein. It should be noted that the diaphragm of a component structure in the above embodiments may be applied to the loudspeaker 120 of any embodiment provided in the present disclosure as needed.

The present disclosure has been described with specific examples, which are merely for helping to understand the present disclosure and are not intended to limit the present disclosure. For those skilled in the art to which the present disclosure pertains, a number of simple derivations, modifications, or substitutions may also be made based on the concept of the present disclosure.

1. An open-ear headphone, comprising an sound generating unit and an ear hook, the ear hook configured to position the sound generating unit near an ear without blocking an ear canal in a wearing state, the sound generating unit including a first housing and a sound generating assembly disposed inside the first housing, wherein a housing wall of the first housing facing toward the ear canal in the wearing state is an inside wall, a housing wall opposite the inside wall and facing away from the ear canal is an outside wall, the inside wall is provided with a first sound outlet, and the outside wall is provided with a second sound outlet; wherein the sound generating assembly includes:
a loudspeaker, including a first diaphragm and a second diaphragm disposed opposite each other in a vibration direction; and
a limiting assembly, wherein a sound guiding hole is provided in a center of the limiting assembly and the limiting assembly is disposed between the loudspeaker and the first housing; the limiting assembly positions the first diaphragm and the inside wall opposite each other in the vibration direction, and cooperates with the first diaphragm and the inside wall to form a first acoustic cavity communicating with the first sound outlet; the limiting assembly further positions the second diaphragm and the outside wall opposite each other in the vibration direction, and cooperates with the second diaphragm and the outside wall to form a second acoustic cavity communicating with the second sound outlet.

2. The open-ear headphone of claim 1, wherein on a reference plane perpendicular to the vibration direction, a projection of the sound guiding hole, a projection of the first sound outlet, a projection of the second sound outlet, a projection of the first diaphragm, and a projection of the second diaphragm at least partially overlap.

3. The open-ear headphone of claim 2, wherein on the reference plane, the projection of the first sound outlet falls within the projection of the sound guiding hole.

4. The open-ear headphone of claim 2, wherein on the reference plane, a projected area of an overlapping region of the projection of the first sound outlet and the projection of the sound guiding hole is not less than 80% of a projected area of the projection of the sound guiding hole.

5. The open-ear headphone of claim 1, wherein an acoustic resistance mesh is disposed in each of the first acoustic cavity and the second acoustic cavity; the acoustic resistance mesh is fixedly connected to the limiting assembly and covers the sound guiding hole; wherein a specific acoustic impedance of the acoustic resistance mesh in the first acoustic cavity is less than a specific acoustic impedance of the acoustic resistance mesh in the second acoustic cavity.

6. The open-ear headphone of claim 5, wherein a rib structure is disposed in the sound guiding hole, and the rib structure is configured to support and fix the acoustic resistance meshes.

7. The open-ear headphone of claim 5, wherein the acoustic resistance mesh in the first acoustic cavity is defined as a first acoustic resistance mesh, the acoustic resistance mesh in the second acoustic cavity is defined as a second acoustic resistance mesh, and a ratio of a specific acoustic impedance of the second acoustic resistance mesh to a specific acoustic impedance of the first acoustic resistance mesh is not less than 10.

8. The open-ear headphone of claim 1, wherein the limiting assembly is connected to the loudspeaker; in the vibration direction, an end of the limiting assembly proximate to the inside wall elastically abuts against the inside wall, and an end of the limiting assembly proximate to the outside wall elastically abuts against the outside wall.

9. The open-ear headphone of claim 1, wherein the limiting assembly includes a second housing, the second housing is disposed inside the first housing; the loudspeaker is disposed inside the second housing and fixedly connected to the second housing.

10. The open-ear headphone of claim 9, wherein the limiting assembly further includes a sealing ring; the sealing ring is connected between the second housing and the first housing.

11. The open-ear headphone of claim 10, wherein the sound guiding hole is provided in at least one of the first housing or the sealing ring.

12. (canceled)

13. The open-ear headphone of claim 9, wherein the second housing has a transverse sidewall and a longitudinal sidewall, the transverse sidewall is spaced from and opposite to the first diaphragm or the second diaphragm in the vibration direction, the longitudinal sidewall surrounds in the vibration direction and is fixedly connected to the loudspeaker; wherein the transverse sidewall includes a central portion and an arc portion surrounding and connecting the central portion, at least a portion of the sound guiding hole penetrates the central portion, and an end of the arc portion away from the central portion is connected to the longitudinal sidewall.

14. The open-ear headphone of claim 13, wherein the second housing includes a first cover and a second cover, each of the first cover and the second cover has the transverse sidewall and the longitudinal sidewall; wherein one end of the loudspeaker in the vibration direction extends into the first cover and is fixedly connected to the longitudinal sidewall of the first cover; the other end of the loudspeaker in the vibration direction extends into the second cover and is fixedly connected to the longitudinal sidewall of the second cover.

15. The open-ear headphone of claim 1, wherein in the wearing state, a housing wall of the first housing facing toward a top of the head is an upside wall, and a housing wall away from the top of the head is a downside wall; the upside wall, the inside wall, the downside wall, and the outside wall are sequentially connected to jointly enclose an accommodating cavity for accommodating the sound generating assembly and form a mounting opening communicating with the accommodating cavity, the mounting opening configured to guide the sound generating assembly in and out of the accommodating cavity.

16. The open-ear headphone of claim 15, wherein a positioning structure is disposed in the accommodating cavity; the positioning structure is configured to abut against the limiting assembly to limit a position of the sound generating assembly inside the accommodating cavity; and/or the upside wall, the inside wall, the downside wall, and the outside wall are an integrated structure made of a metal material.

17. The open-ear headphone of claim 1, wherein the loudspeaker further includes a magnetic circuit assembly and a voice coil assembly, the magnetic circuit assembly and the voice coil assembly are located between the first diaphragm and the second diaphragm, and the voice coil assembly at least partially extends into a magnetic gap of the magnetic circuit assembly; the magnetic circuit assembly cooperates with the voice coil assembly to drive the voice coil assembly to cause the first diaphragm and the second diaphragm to vibrate synchronously and in the same direction.

18. The open-ear headphone of claim 17, wherein the loudspeaker further includes a bracket assembly, the bracket assembly surrounds and is connected to an outer periphery of the magnetic circuit assembly, an outer peripheral edge of the first diaphragm and an outer peripheral edge of the second diaphragm are fixed to the bracket assembly; at least a portion of the limiting assembly surrounds the bracket assembly and is connected between the bracket assembly and the first housing.

19. The open-ear headphone of claim 18, wherein the bracket assembly, the magnetic circuit assembly, the first diaphragm, and the second diaphragm jointly enclose and form a common cavity accommodating the voice coil assembly, and the bracket assembly is provided with an air pressure balancing channel communicating the common cavity with an exterior of the loudspeaker.

20. The open-ear headphone of claim 18, wherein an adhesive receiving gap receiving a sealing adhesive is formed at a junction of the bracket assembly and the limiting assembly.

21. The open-ear headphone of claim 17, wherein the voice coil assembly includes a first voice coil and a second voice coil arranged and connected in the vibration direction, an end of the first voice coil away from the second voice coil in the vibration direction is connected to the first diaphragm, and an end of the second voice coil away from the first voice coil in the vibration direction is connected to the second diaphragm.
